(19) United States
(12) Patent Application Publication
(10) Pub. No.: US 2026/0333401 A1
(43) Pub. Date: Oct. 22, 2026

(54) Scheduling Request for Sidelink Transmission

(71) Applicant: Ofinno, LLC, Reston, VA (US)

(72) Inventors: Nazanin Rastegardoost, Arlington, VA (US); Hyoungsuk Jeon, Centreville, VA (US); Esmael Hejazi Dinan, McLean, VA (US); Ali Cagatay Cirik, Chantilly, VA (US); Hsin-Hsi Tsai, Chantilly, VA (US); Gautham Prasad, Herndon, VA (US); Mohammad Ghadir Khoshkholgh Dashtaki, Reston, VA (US); Ryan Keating, Chicago, IL (US)

(73) Assignee: Ofinno, LLC, Reston, VA (US)

(21) Appl. No.: 19/701,454

(22) Filed: Jun. 8, 2026

Related U.S. Application Data
(63) Continuation of application No. PCT/US2024/059156, filed on Dec. 9, 2024.
(60) Provisional application No. 63/607,397, filed on Dec. 7, 2023.

(51) Int. Cl. H04W 72/40; H04W 72/1263; H04W 72/23

(52) U.S. Cl. CPC H04W 72/40; H04W 72/1263; H04W 72/23

(57) ABSTRACT

A wireless device triggers, based on a sidelink (SL) transmission comprising an SL reference signal (RS), a scheduling request (SR) using a first SR configuration. The wireless device transmits, to a base station, the SR via a physical uplink control channel (PUCCH) resource indicated by the first SR configuration. The wireless device receives, from the base station and after transmitting the SR, downlink control information (DCI) indicating an SL resource in a first slot of a SL resource pool. The wireless device transmits to a second wireless device and via the SL resource: SL data; SL control information (SCI) indicating an SL RS resource, of SL RS resources, in the first slot; and the SL RS, wherein the transmitting the SL RS is via one or more first symbols, of the first slot, indicated by the SL RS resource.

### CROSS-REFERENCE TO RELATED APPLICATIONS

This application is a continuation of International Application No. PCT/US2024/059156, filed Dec. 9, 2024, which claims the benefit of U.S. Provisional Application No. 63/607,397, filed Dec. 7, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 illustrates examples of device-to-device (D2D) communication, in which there is a direct communication between wireless devices as per an aspect of an embodiment of the present disclosure.

FIG. 18 illustrates an example of a resource pool for sidelink operations as per an aspect of an embodiment of the present disclosure.

FIG. 19 illustrates an example of sidelink symbols in a slot as per an aspect of an embodiment of the present disclosure.

FIG. 20 illustrates an example of resource indication for a first TB (e.g, a first data packet) and resource reservation for a second TB (e.g., a second data packet) as per an aspect of an embodiment of the present disclosure.

FIG. 21 and FIG. 22 illustrate examples of configuration information for sidelink communication as per an aspect of an embodiment of the present disclosure.

FIG. 23 illustrates an example format of a MAC subheader for sidelink shared channel (SL-SCH) as per an aspect of an embodiment of the present disclosure.

FIG. 24 illustrates an example time of a resource selection procedure as per an aspect of an embodiment of the present disclosure.

FIG. 25 illustrates an example timing of a resource selection procedure as per an aspect of an embodiment of the present disclosure.

FIG. 26 illustrates an example flowchart of a resource selection procedure by a wireless device for transmitting a TB (e.g., a data packet) via sidelink as per an aspect of an embodiment of the present disclosure.

FIG. 27 illustrates an example diagram of the resource selection procedure among layers of the wireless device as per an aspect of an embodiment of the present disclosure.

FIG. 28 shows an example of PC5 unicast links as per an aspect of an embodiment of the present disclosure.

FIG. 29 illustrates an example of sidelink CSI-RS transmission and a sidelink CSI reporting procedure as per an aspect of an example embodiment of the present disclosure.

FIG. 30 illustrates an example of resource allocation of SL CSI-RS.

FIG. 31 illustrates an example of SL CSI report as per an aspect of an example embodiment of the present disclosure.

FIG. 32A and FIG. 32B illustrate examples of SL RSs as per an aspect of an example embodiment of the present disclosure.

FIG. 33A illustrates an example for SL RS transmission as per an aspect of an embodiment of the present disclosure.

FIG. 33B illustrates an example for SL RS transmission as per an aspect of an embodiment of the present disclosure.

FIG. 34 shows an example of beam management comprising a beam sweeping procedure, e.g., for beam pairing, initial beam pairing, beam training, beam refinement/maintenance, beam failure recovery, and/or beam establishment purposes (these terms may be used interchangeably) as per an aspect of an embodiment of the present disclosure.

FIG. 35 shows an example of beam indication in Uu and sidelink as per an aspect of an embodiment of the present disclosure.

FIG. 36 illustrates an example of scheduling request configuration for sidelink operations.

FIG. 37 illustrates an example of beam-specific scheduling request configuration for sidelink operations as per an aspect of an embodiment of the present disclosure.

FIG. 38 illustrates an example of scheduling request configuration parameters for beam-formed sidelink transmissions as per an aspect of an embodiment of the present disclosure.

FIG. 39 illustrates an example of beam-specific scheduling request for sidelink operations as per an aspect of an embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, MATLAB or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

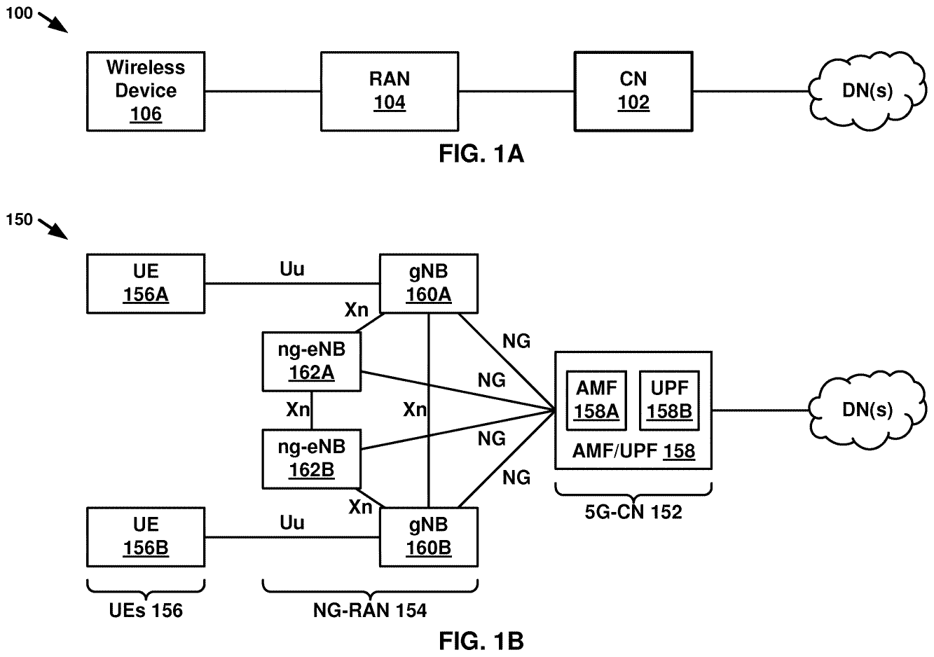

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNS (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, WiFi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNS (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

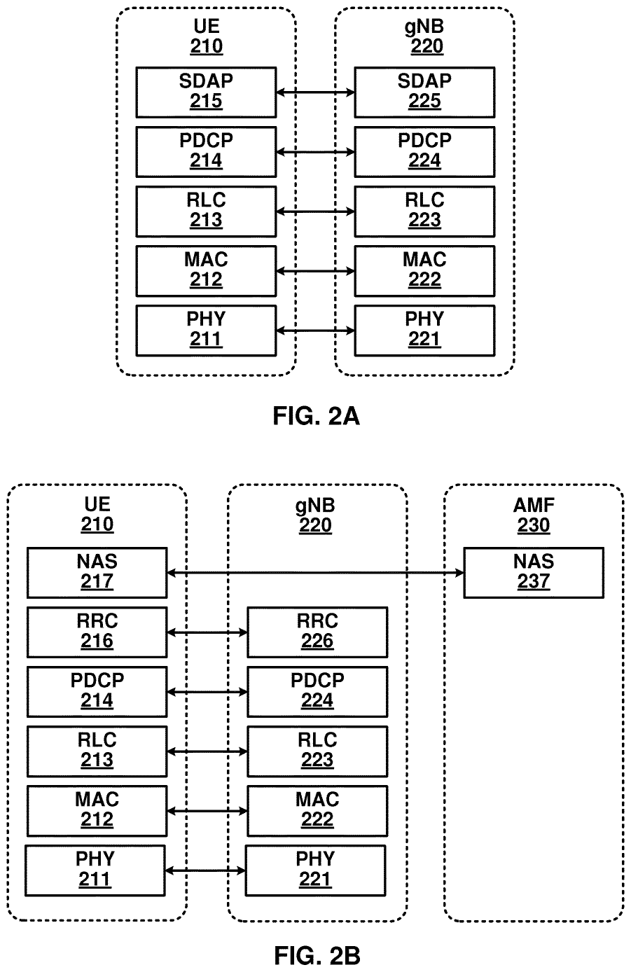

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

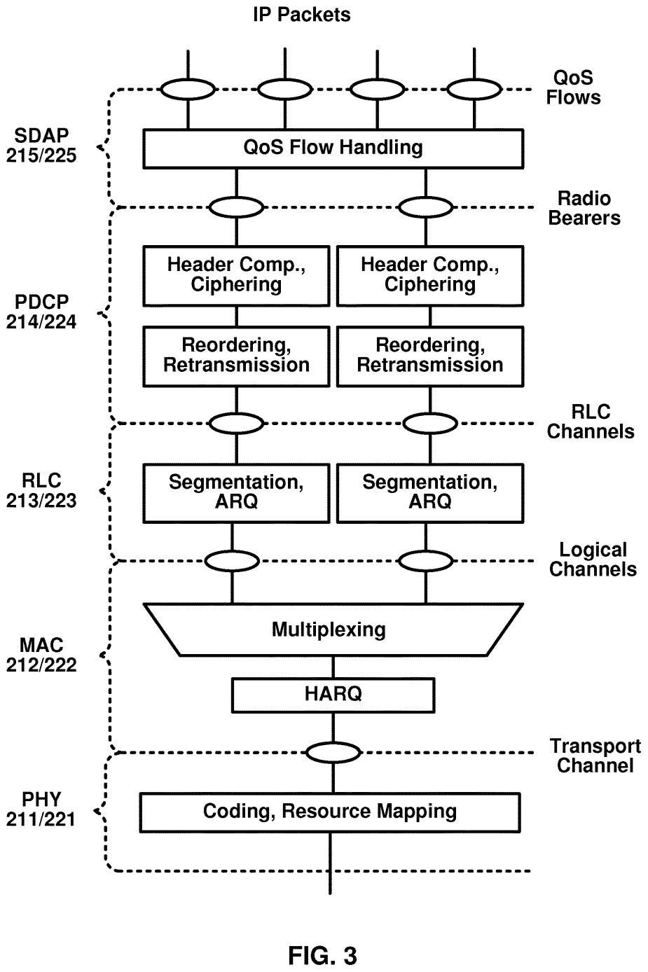

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

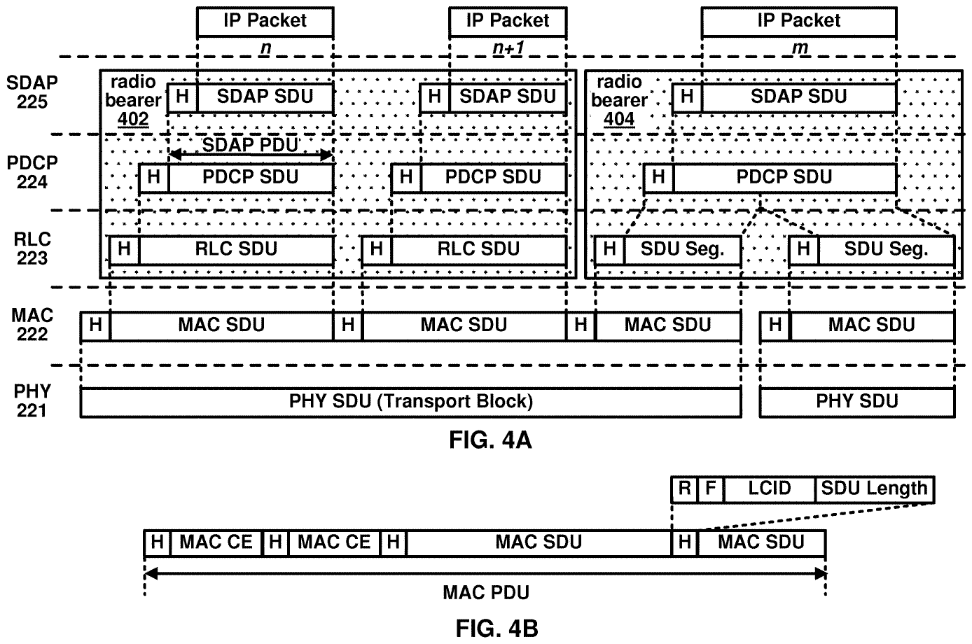

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 212 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

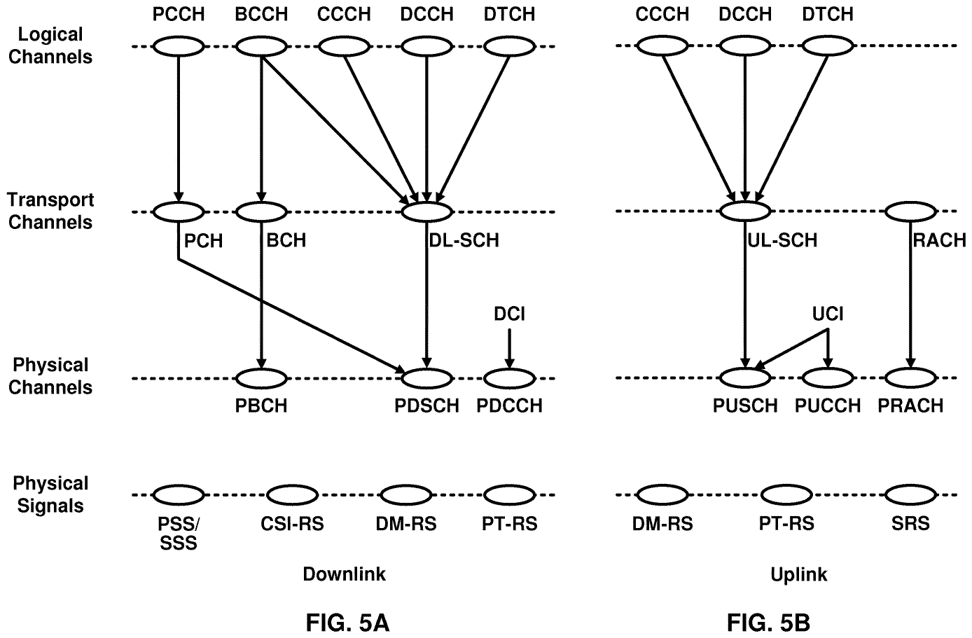

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.
Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

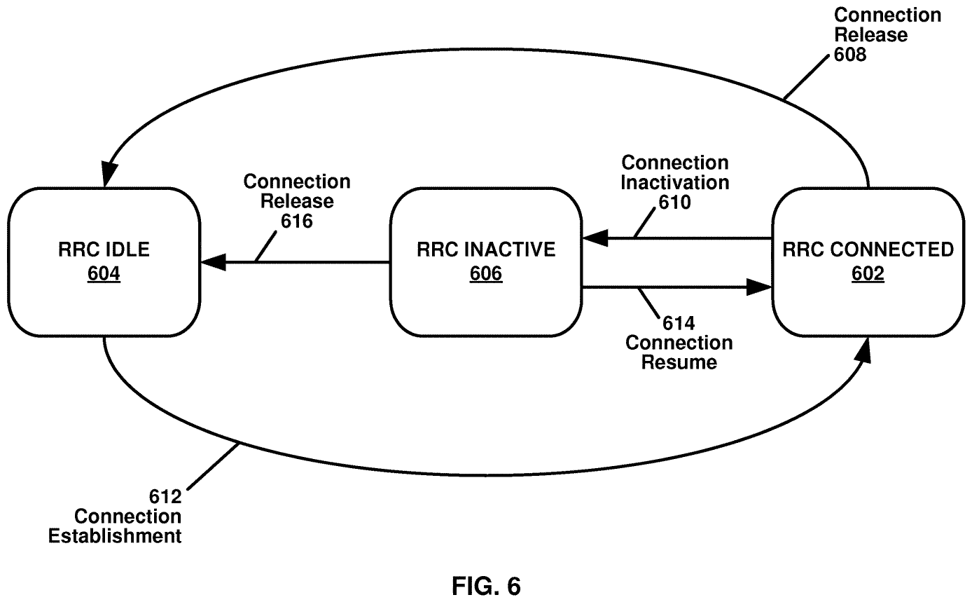

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split in two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

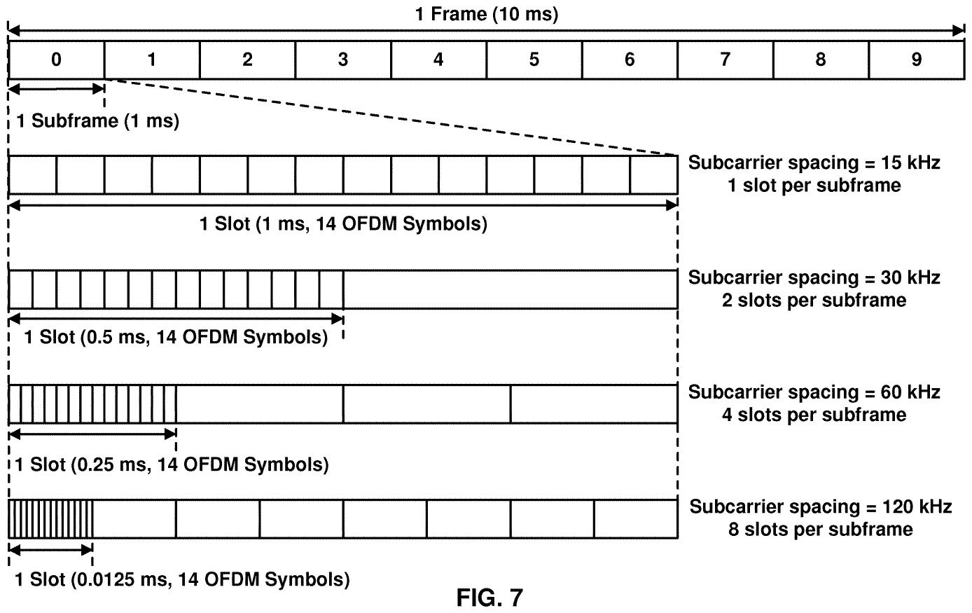

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 kHz/2.3 μs; 60 KHz/1.2 μs; 120 KHz/0.59 μs; and 240 KHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 KHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

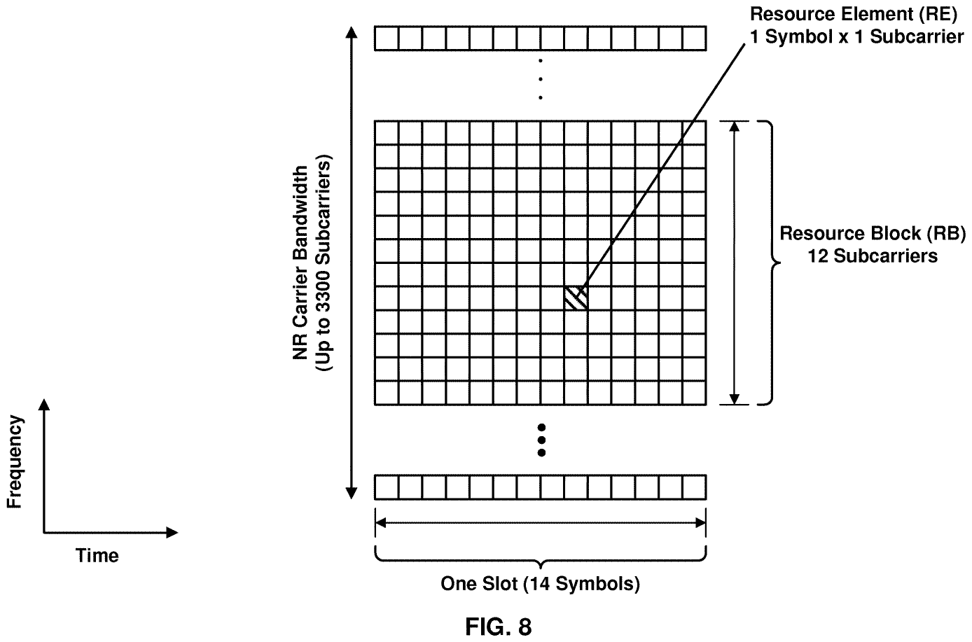

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 KHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 KHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

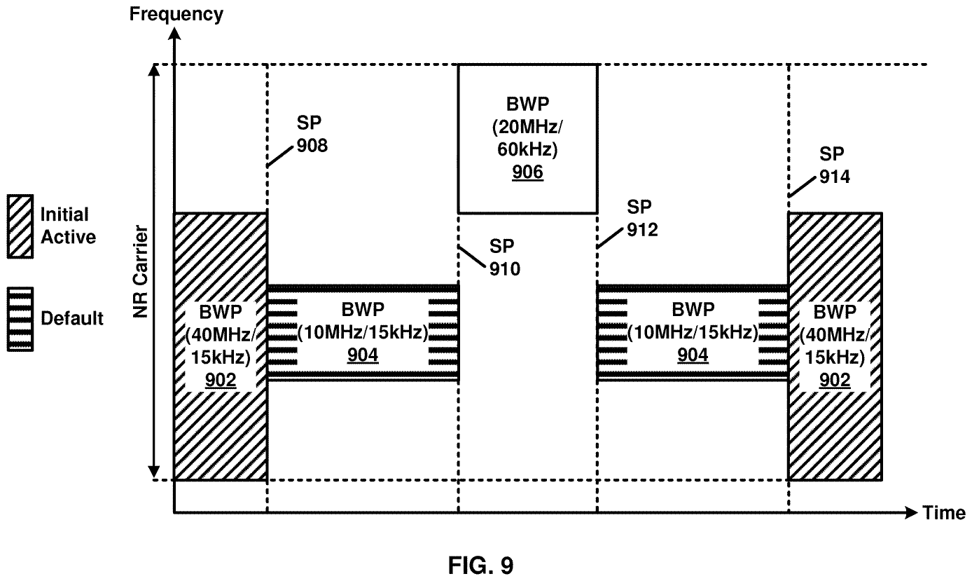

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 KHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response receiving a DCI indicating BWP 906 as the active BWP. The UE may switch at a switching point 912 from active BWP 906 to BWP 904 in response to an expiry of a BWP inactivity timer and/or in response receiving a DCI indicating BWP 904 as the active BWP. The UE may switch at a switching point 914 from active BWP 904 to BWP 902 in response receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

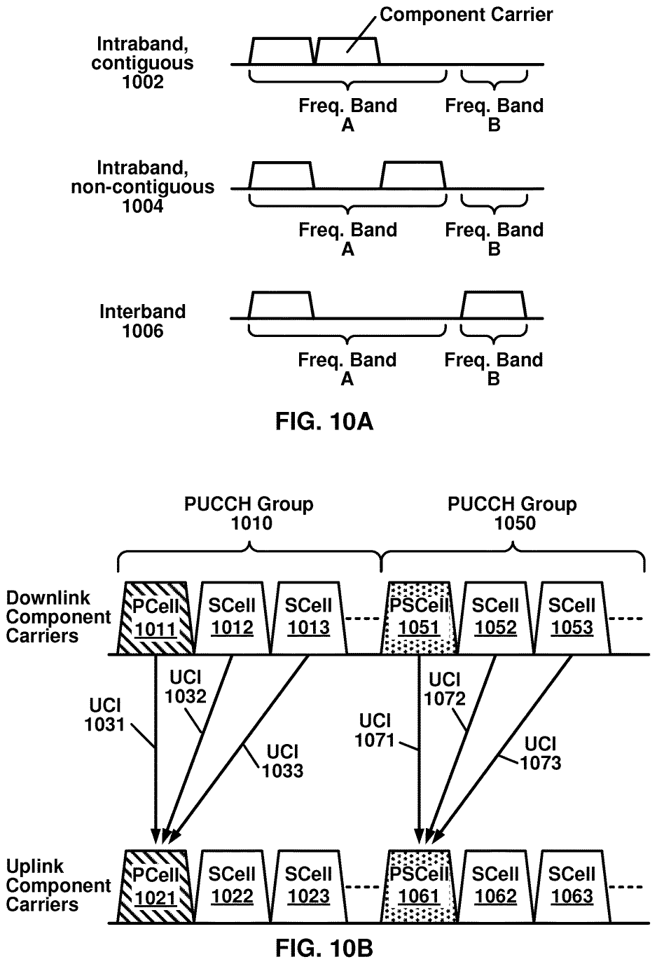

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary SCell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

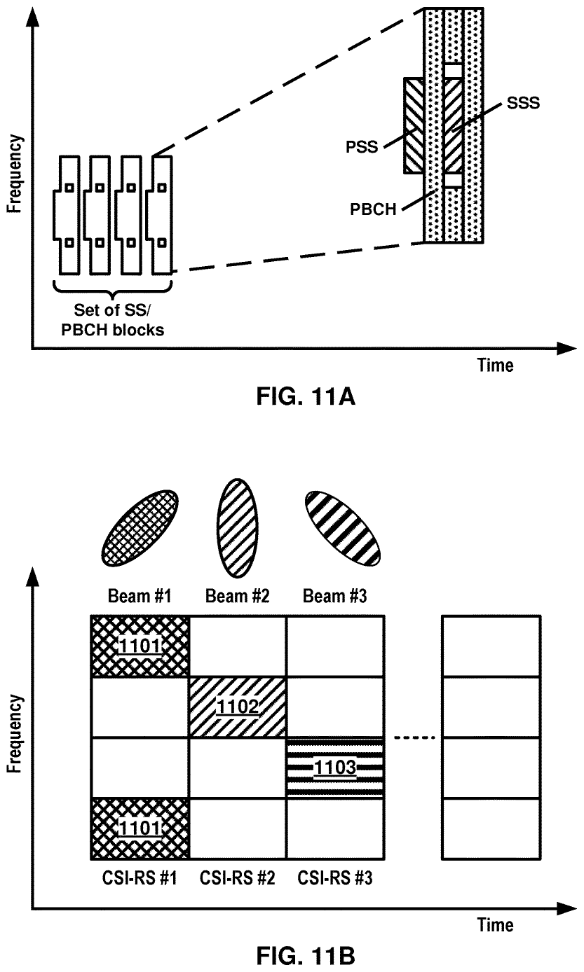

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM)) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in a SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

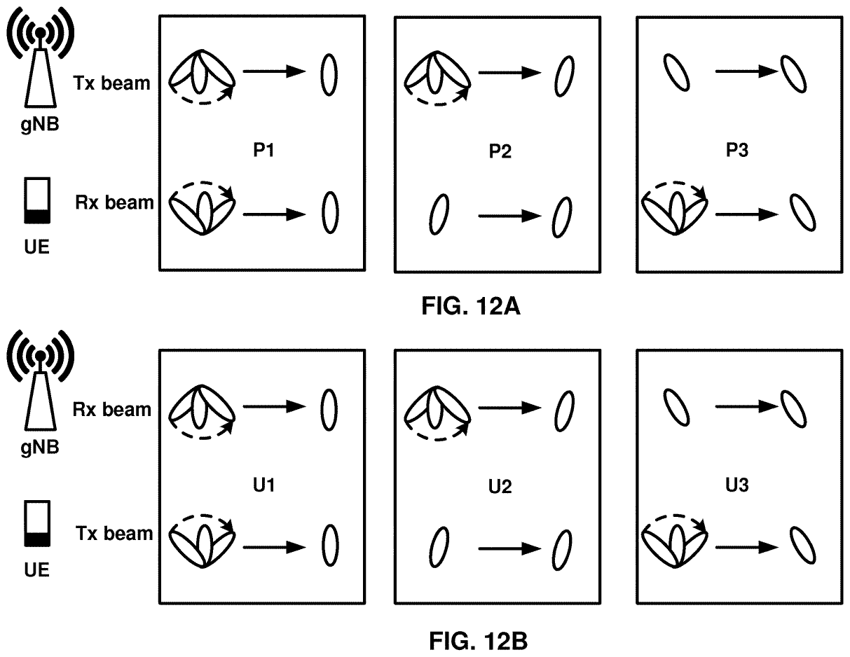

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counter-clockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counter-clockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counter-clockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

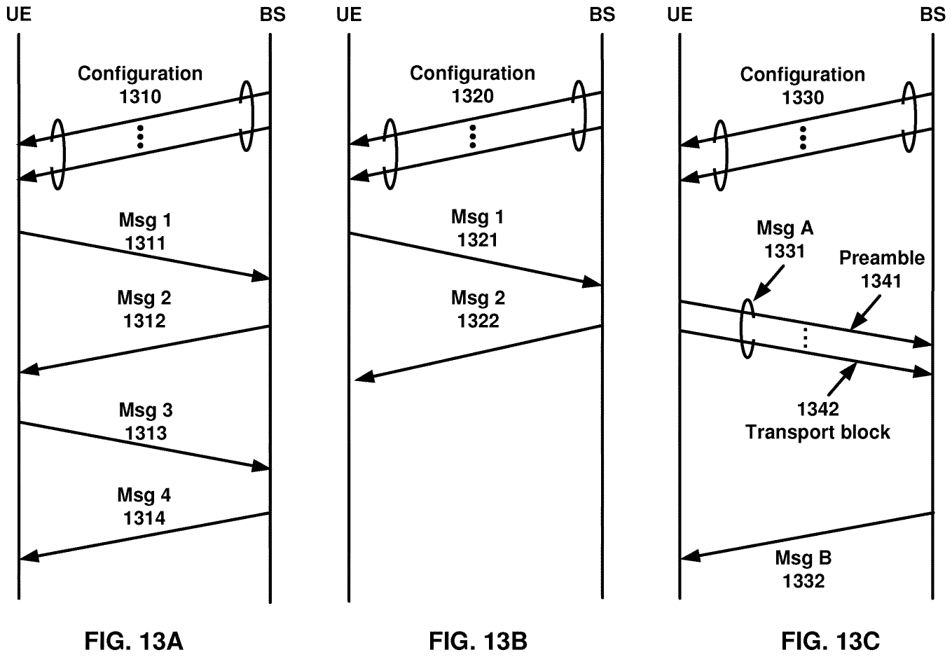

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preamble TransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id, where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

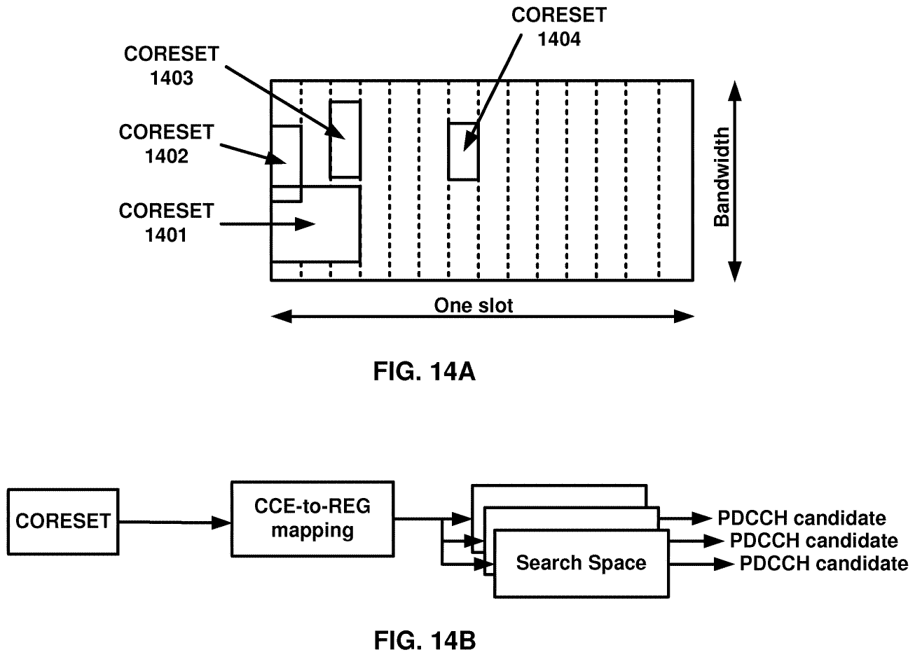

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

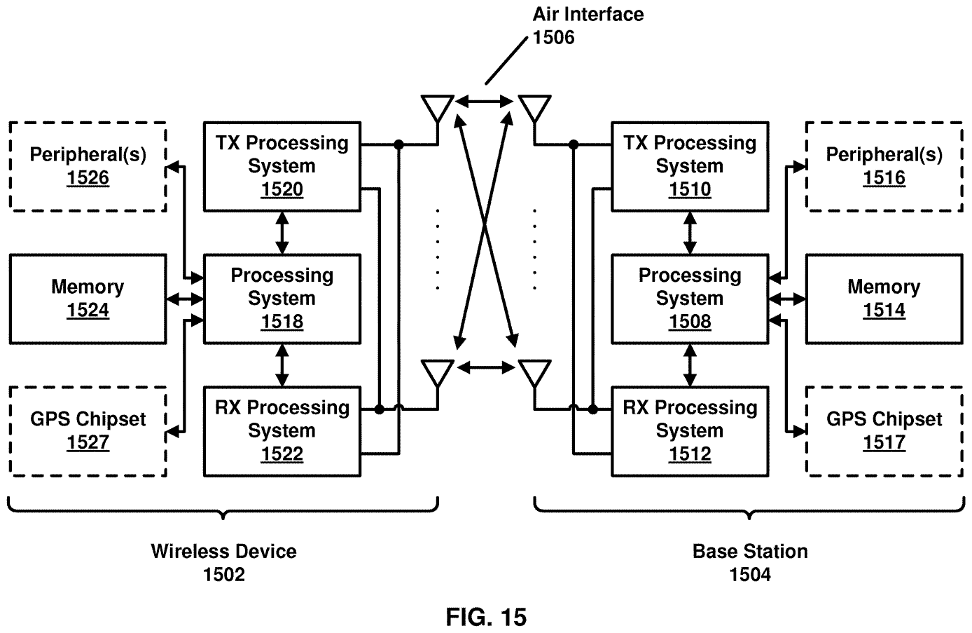

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 maybe associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

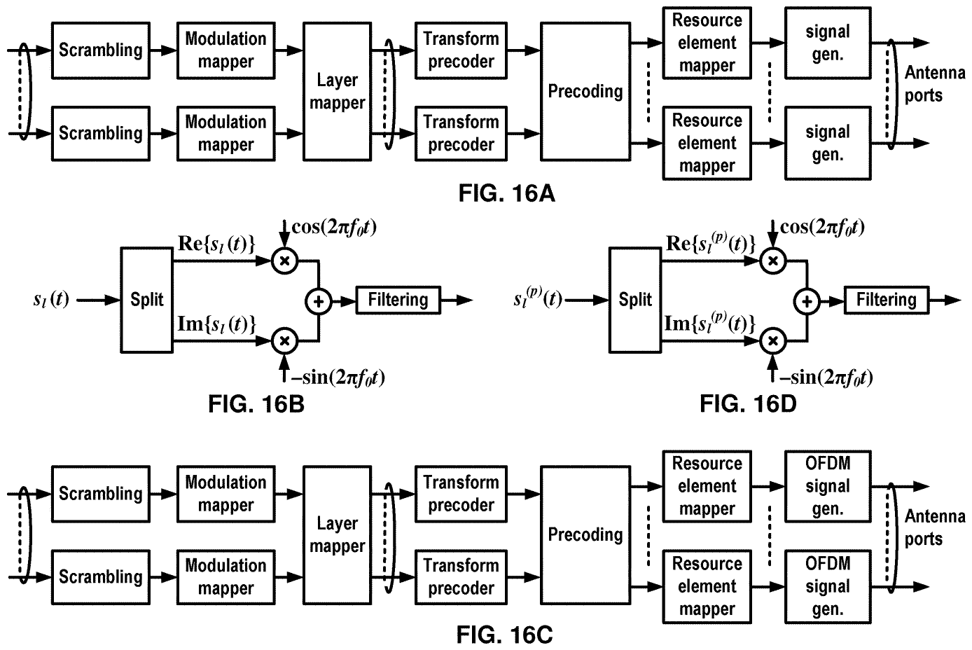

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, an CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual-connectivity) via the plurality of cells. The one or more messages (e.g. as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry of a random access response window timer, the time difference between two time stamps may be used. When a timer is restarted, a process for measurement of time window may be restarted. Other example implementations may be provided to restart a measurement of a time window.

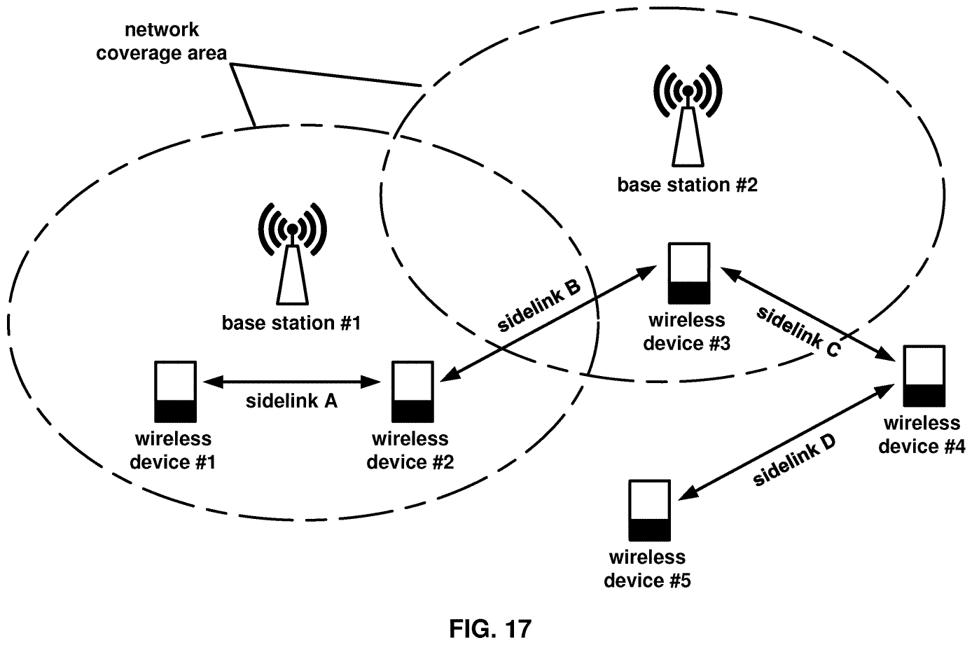

FIG. 17 illustrates examples of device-to-device (D2D) communication, in which there is a direct communication between wireless devices as per an aspect of an embodiment of the present disclosure. In an example, D2D communication may be performed via a sidelink (SL). The wireless devices may exchange sidelink communications via a sidelink interface (e.g., a PC5 interface). Sidelink differs from uplink (in which a wireless device communicates to a base station) and downlink (in which a base station communicates to a wireless device). A wireless device and a base station may exchange uplink and/or downlink communications via a user plane interface (e.g., a Uu interface).

As shown in FIG. 17, wireless device #1 and wireless device #2 may be in a coverage area of base station #1. For example, both wireless device #1 and wireless device #2 may communicate with the base station #1 via a Uu interface. Wireless device #3 may be in a coverage area of base station #2. Base station #1 and base station #2 may share a network and may jointly provide a network coverage area. Wireless device #4 and wireless device #5 may be outside of the network coverage area.

In-coverage D2D communication may be performed when two wireless devices share a network coverage area. Wireless device #1 and wireless device #2 are both in the coverage area of base station #1. Accordingly, they may perform an in coverage intra-cell D2D communication, labeled as sidelink A. Wireless device #2 and wireless device #3 are in the coverage areas of different base stations, but share the same network coverage area. Accordingly, they may perform an in coverage inter-cell D2D communication, labeled as sidelink B. Partial-coverage D2D communications may be performed when one wireless device is within the network coverage area and the other wireless device is outside the network coverage area. Wireless device #3 and wireless device #4 may perform a partial coverage D2D communication, labeled as sidelink C. Out-of-coverage D2D communications may be performed when both wireless devices are outside of the network coverage area. Wireless device #4 and wireless device #5 may perform an out-of coverage D2D communication, labeled as sidelink D.

Sidelink communications may be configured using physical channels, for example, a physical sidelink broadcast channel (PSBCH), a physical sidelink feedback channel (PSFCH), a physical sidelink discovery channel (PSDCH), a physical sidelink control channel (PSCCH), and/or a physical sidelink shared channel (PSSCH). PSBCH may be used by a first wireless device to send broadcast information to a second wireless device. PSBCH may be similar in some respects to PBCH. The broadcast information may comprise, for example, a slot format indication, resource pool information, a sidelink system frame number, or any other suitable broadcast information. PSFCH may be used by a first wireless device to send feedback information to a second wireless device. The feedback information may comprise, for example, HARQ feedback information. PSDCH may be used by a first wireless device to send discovery information to a second wireless device. The discovery information may be used by a wireless device to signal its presence and/or the availability of services to other wireless devices in the area. PSCCH may be used by a first wireless device to send sidelink control information (SCI) to a second wireless device. PSCCH may be similar in some respects to PDCCH and/or PUCCH. The control information may comprise, for example, time/frequency resource allocation information (RB size, a number of retransmissions, etc.), demodulation related information (DMRS, MCS, RV, etc.), identifying information for a transmitting wireless device and/or a receiving wireless device, a process identifier (HARQ, etc.), or any other suitable control information. The PSCCH may be used to allocate, prioritize, and/or reserve sidelink resources for sidelink transmissions. PSSCH may be used by a first wireless device to send and/or relay data and/or network information to a second wireless device. PSSCH may be similar in some respects to PDSCH and/or PUSCH. Each of the sidelink channels may be associated with one or more demodulation reference signals. Sidelink operations may utilize sidelink synchronization signals to establish a timing of sidelink operations. Wireless devices configured for sidelink operations may send sidelink synchronization signals, for example, with the PSBCH. The sidelink synchronization signals may include primary sidelink synchronization signals (PSSS) and secondary sidelink synchronization signals (SSSS).

Sidelink resources may be configured to a wireless device in any suitable manner. A wireless device may be pre-configured for sidelink, for example, pre-configured with sidelink resource information. Additionally or alternatively, a network may broadcast system information relating to a resource pool for sidelink. Additionally or alternatively, a network may configure a particular wireless device with a dedicated sidelink configuration. The configuration may identify sidelink resources to be used for sidelink operation (e.g., configure a sidelink band combination).

The wireless device may operate in different modes, for example, an assisted mode (which may be referred to as mode 1) or an autonomous mode (which may be referred to as mode 2). Mode selection may be based on a coverage status of the wireless device, a radio resource control status of the wireless device, information and/or instructions from the network, and/or any other suitable factors. For example, if the wireless device is idle or inactive, or if the wireless device is outside of network coverage, the wireless device may select to operate in autonomous mode. For example, if the wireless device is in a connected mode (e.g., connected to a base station), the wireless device may select to operate (or be instructed by the base station to operate) in assisted mode. For example, the network (e.g., a base station) may instruct a connected wireless device to operate in a particular mode.

In an assisted mode, the wireless device may request scheduling from the network. For example, the wireless device may send a scheduling request to the network and the network may allocate sidelink resources to the wireless device. Assisted mode may be referred to as network-assisted mode, gNB-assisted mode, or base station-assisted mode. In an autonomous mode, the wireless device may select sidelink resources based on measurements within one or more resource pools (for example, pre-configure or network-assigned resource pools), sidelink resource selections made by other wireless devices, and/or sidelink resource usage of other wireless devices.

To select sidelink resources, a wireless device may observe a sensing window and a selection window. During the sensing window, the wireless device may observe SCI transmitted by other wireless devices using the sidelink resource pool. The SCIs may identify resources that may be used and/or reserved for sidelink transmissions. Based on the resources identified in the SCIs, the wireless device may select resources within the selection window (for example, resource that are different from the resources identified in the SCIs). The wireless device may transmit using the selected sidelink resources.

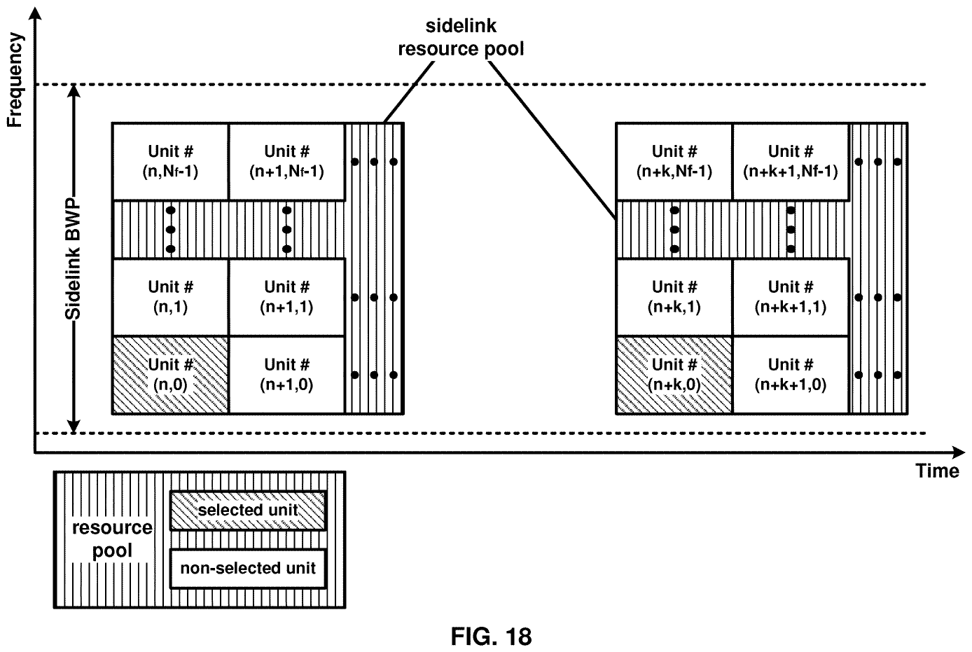

FIG. 18 illustrates an example of a resource pool for sidelink operations. A wireless device may operate using one or more sidelink cells. A sidelink cell may include one or more resource pools. Each resource pool may be configured to operate in accordance with a particular mode (for example, assisted or autonomous). The resource pool may be divided into resource units. In the frequency domain, each resource unit may comprise, for example, one or more resource blocks which may be referred to as a sub-channel. In the time domain, each resource unit may comprise, for example, one or more slots, one or more subframes, and/or one or more OFDM symbols. The resource pool may be continuous or non-continuous in the frequency domain and/or the time domain (for example, comprising contiguous resource units or non-contiguous resource units). The resource pool may be divided into repeating resource pool portions. The resource pool may be shared among one or more wireless devices. Each wireless device may attempt to transmit using different resource units, for example, to avoid collisions.

Sidelink resource pools may be arranged in any suitable manner. In the figure, the example resource pool is non-contiguous in the time domain and confined to a single sidelink BWP. In the example resource pool, frequency resources are divided into a Nf resource units per unit of time, numbered from zero to Nf 1. The example resource pool may comprise a plurality of portions (non-contiguous in this example) that repeat every k units of time. In the figure, time resources are numbered as n, n+1 . . . n+k, n+k+1 . . . , etc.

A wireless device may select for transmission one or more resource units from the resource pool. In the example resource pool, the wireless device selects resource unit (n,0) for sidelink transmission. The wireless device may further select periodic resource units in later portions of the resource pool, for example, resource unit (n+k,0), resource unit (n+2 k,0), resource unit (n+3 k,0), etc. The selection may be based on, for example, a determination that a transmission using resource unit (n,0) will not (or is not likely) to collide with a sidelink transmission of a wireless device that shares the sidelink resource pool. The determination may be based on, for example, behavior of other wireless devices that share the resource pool. For example, if no sidelink transmissions are detected in resource unit (n−k,0), then the wireless device may select resource unit (n,0), resource (n+k,0), etc. For example, if a sidelink transmission from another wireless device is detected in resource unit (n−k,1), then the wireless device may avoid selection of resource unit (n, 1), resource (n+k, 1), etc.

Different sidelink physical channels may use different resource pools. For example, PSCCH may use a first resource pool and PSSCH may use a second resource pool. Different resource priorities may be associated with different resource pools. For example, data associated with a first QoS, service, priority, and/or other characteristic may use a first resource pool and data associated with a second QoS, service, priority, and/or other characteristic may use a second resource pool. For example, a network (e.g., a base station) may configure a priority level for each resource pool, a service to be supported for each resource pool, etc. For example, a network (e.g., a base station) may configure a first resource pool for use by unicast UEs, a second resource pool for use by groupcast UEs, etc. For example, a network (e.g., a base station) may configure a first resource pool for transmission of sidelink data, a second resource pool for transmission of discovery messages, etc.

In an example of vehicle-to-everything (V2X) communications via a Uu interface and/or a PC5 interface, the V2X communications may be vehicle-to-vehicle (V2V) communications. A wireless device in the V2V communications may be a vehicle. In an example, the V2X communications may be vehicle-to-pedestrian (V2P) communications. A wireless device in the V2P communications may be a pedestrian equipped with a mobile phone/handset. In an example, the V2X communications may be vehicle-to-infrastructure (V2I) communications. The infrastructure in the V2I communications may be a base station/access point/node/road side unit. A wireless device in the V2X communications may be a transmitting wireless device performing one or more sidelink transmissions to a receiving wireless device. The wireless device in the V2X communications may be a receiving wireless device receiving one or more sidelink transmissions from a transmitting wireless device.

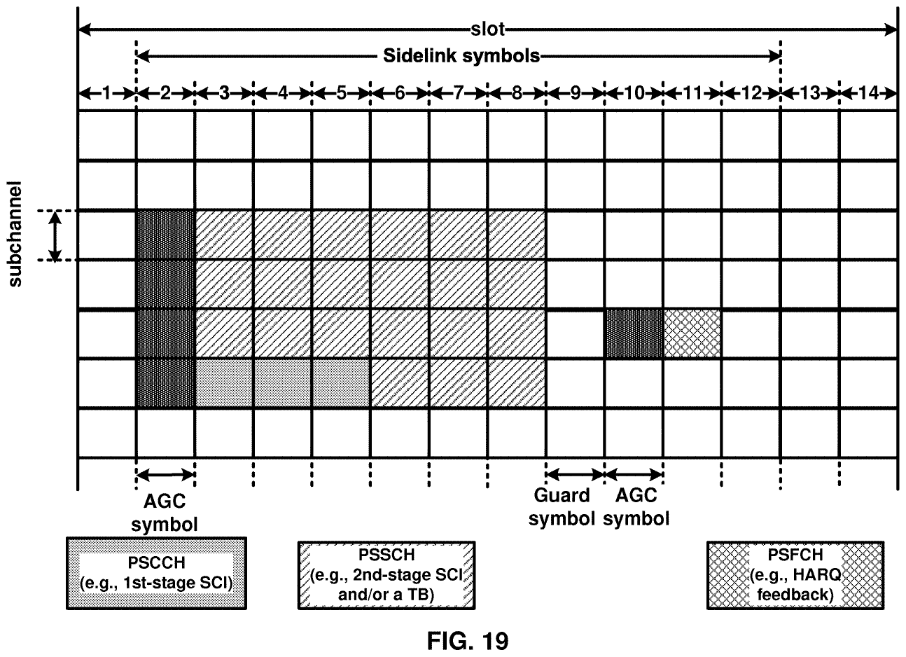

FIG. 19 illustrates an example of sidelink symbols in a slot. In an example, a sidelink transmission may be transmitted in a slot in the time domain. In an example, a wireless device may have data to transmit via sidelink. The wireless device may segment the data into one or more transport blocks (TBs). The one or more TBs may comprise different pieces of the data. A TB of the one or more TBs may be a data packet of the data. The wireless device may transmit a TB of the one or more TBs (e.g., a data packet) via one or more sidelink transmissions (e.g., via PSCCH/PSSCH in one or more slots). In an example, a sidelink transmission (e.g., in a slot) may comprise SCI. The sidelink transmission may further comprise a TB. The SCI may comprise a 1st-stage SCI and a 2nd-stage SCI. A PSCCH of the sidelink transmission may comprise the 1st-stage SCI for scheduling a PSSCH (e.g., the TB). The PSSCH of the sidelink transmission may comprise the 2nd-stage SCI. The PSSCH of the sidelink transmission may further comprise the TB. In an example, sidelink symbols in a slot may or may not start from the first symbol of the slot. The sidelink symbols in the slot may or may not end at the last symbol of the slot. In an example of FIG. 19, sidelink symbols in a slot start from the second symbol of the slot. In an example of FIG. 19, the sidelink symbols in the slot end at the twelfth symbol of the slot. A first sidelink transmission may comprise a first automatic gain control (AGC) symbol (e.g., the second symbol in the slot), a PSCCH (e.g., in the third, fourth and the fifth symbols in a sub-channel in the slot), a PSSCH (e.g., from the third symbol to the eighth symbol in the slot), and/or a first guard symbol (e.g., the ninth symbol in the slot). A second sidelink transmission may comprise a second AGC symbol (e.g., the tenth symbol in the slot), a PSFCH (e.g., the eleventh symbol in the slot), and/or a second guard symbol for the second sidelink transmission (e.g., the twelfth symbol in the slot). In an example, one or more HARQ feedbacks (e.g., positive acknowledgement or ACK and/or negative acknowledgement or NACK) may be transmitted via the PSFCH. In an example, the PSCCH, the PSSCH, and the PSFCH may have different number of sub-channels (e.g., a different number of frequency resources) in the frequency domain.

The 1st-stage SCI may be a SCI format 1-A. The SCI format 1-A may comprise a plurality of fields used for scheduling of the first TB on the PSSCH and the 2nd-stage SCI on the PSSCH. The following information may be transmitted by means of the SCI format 1-A.
A priority of the sidelink transmission. For example, the priority may be a physical layer (e.g., layer 1) priority of the sidelink transmission. For example, the priority may be determined based on logical channel priorities of the sidelink transmission;
Frequency resource assignment of the PSSCH;
Time resource assignment of the PSSCH;
Resource reservation period/interval for a second TB;
Demodulation reference signal (DMRS) pattern;
A format of the 2nd-stage SCI;
Beta_offset indicator;
Number of DMRS port;
Modulation and coding scheme of the PSSCH;
Additional MCS table indicator;
PSFCH overhead indication;
Reserved bits.

The 2nd-stage SCI may be a SCI format 2-A. The SCI format 2-A may be used for the decoding of the PSSCH, with HARQ operation when HARQ-ACK information includes ACK or NACK, or when there is no feedback of HARQ-ACK information. The SCI format 2-A may comprise a plurality of fields indicating the following information.
HARQ process number;
New data indicator;
Redundancy version;
Source ID of a transmitter (e.g., a transmitting wireless device) of the sidelink transmission;
1 Destination ID of a receiver (e.g., a receiving wireless device) of the sidelink transmission;
HARQ feedback enabled/disabled indicator;
Cast type indicator indicating that the sidelink transmission is a broadcast, a groupcast and/or a unicast;
CSI request.

The 2nd-stage SCI may be a SCI format 2-B. The SCI format 2-B may be used for the decoding of the PSSCH, with HARQ operation when HARQ-ACK information includes only NACK, or when there is no feedback of HARQ-ACK information. The SCI format 2-B may comprise a plurality of fields indicating the following information.
HARQ process number;
New data indicator;
Redundancy version;
Source ID of a transmitter (e.g., a transmitting wireless device) of the sidelink transmission;
Destination ID of a receiver (e.g., a receiving wireless device) of the sidelink transmission;
HARQ feedback enabled/disabled indicator;
Zone ID indicating a zone in which a transmitter (e.g., a transmitting wireless device) of the sidelink transmission is geographic located;
Communication range requirement indicating a communication range of the sidelink transmission.

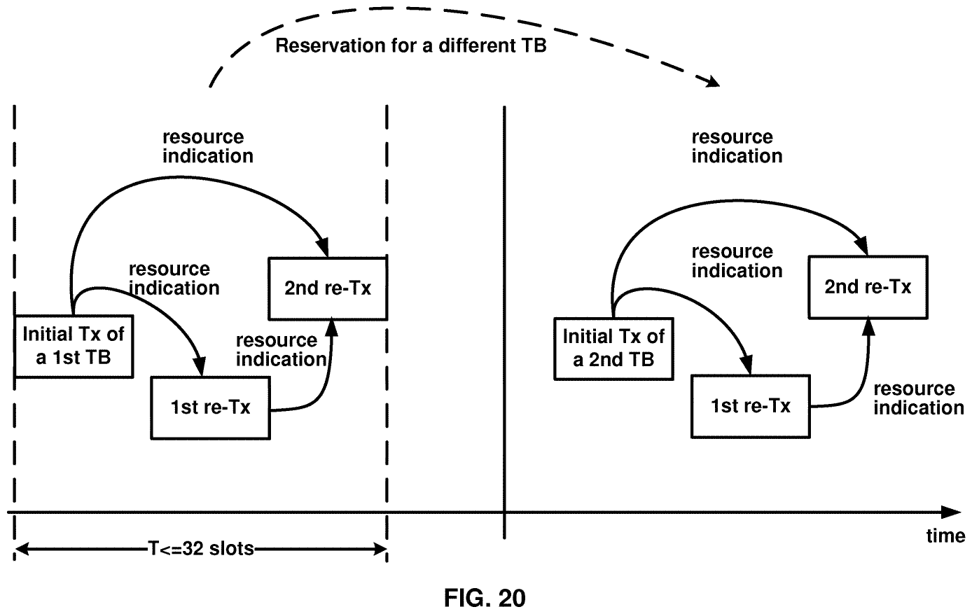

FIG. 20 illustrates an example of resource indication for a first TB (e.g, a first data packet) and resource reservation for a second TB (e.g., a second data packet). SCI of an initial transmission (e.g., a first transmission) and/or retransmission of the first TB may comprise one or more first parameters (e.g., Frequency resource assignment and Time resource assignment) indicating one or more first time and frequency (T/F) resources for transmission and/or retransmission of the first TB. The SCI may further comprise one or more second parameters (e.g., Resource reservation period) indicating a reservation period/interval of one or more second T/F resources for initial transmission and/or retransmission of the second TB.

In an example, in response to triggering a resource selection procedure, a wireless device may select one or more first T/F resources for initial transmission and/or retransmission of a first TB. As shown in FIG. 20, the wireless device may select three resources for transmitting the first TB. The wireless device may transmit an initial transmission (initial Tx of a first TB in FIG. 20) of the first TB via a first resource of the three resources. The wireless device may transmit a first retransmission (1st re-Tx in FIG. 20) of the first TB via a second resource of the three resources. The wireless device may transmit a second retransmission (2nd re-Tx in FIG. 20) of the first TB via a third resource of the three resources. A time duration between a starting time of the initial transmission of the first TB and the second retransmission of the first TB may be smaller than or equal to 32 sidelink slots (e.g., T≤32 slots in FIG. 20). A first SCI may associate with the initial transmission of the first TB. The first SCI may indicate a first T/F resource indication for the initial transmission of the first TB, the first retransmission of the first TB and the second retransmission of the first TB. The first SCI may further indicate a reservation period/interval of resource reservation for a second TB. A second SCI may associate with the first retransmission of the first TB. The second SCI may indicate a second T/F resource indication for the first retransmission of the first TB and the second retransmission of the first TB. The second SCI may further indicate the reservation period/interval of resource reservation for the second TB. A third SCI may associate with the second retransmission of the first TB. The third SCI may indicate a third T/F resource indication for the second retransmission of the first TB. The third SCI may further indicate the reservation period/interval of resource reservation for the second TB.

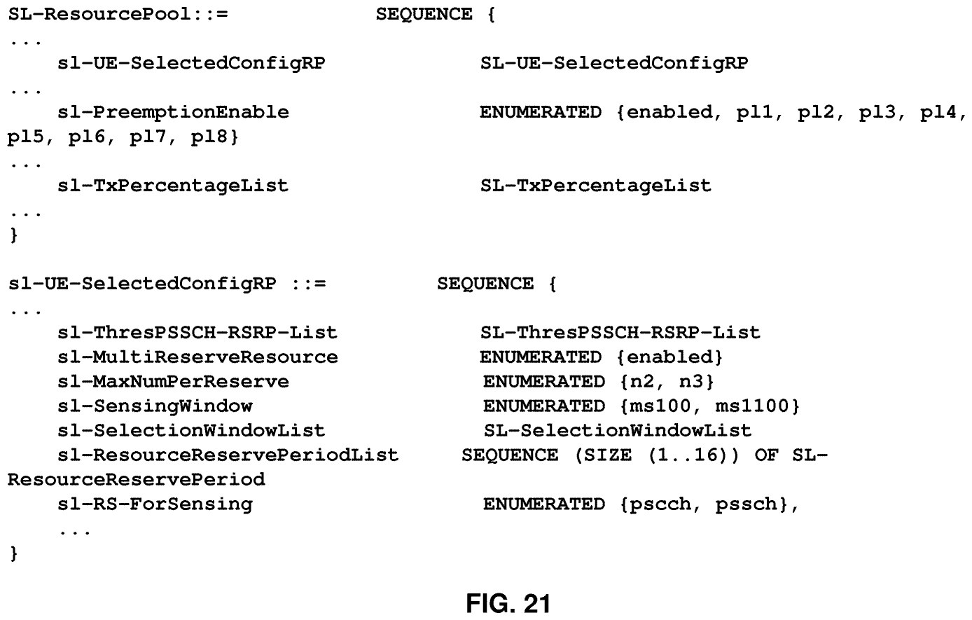

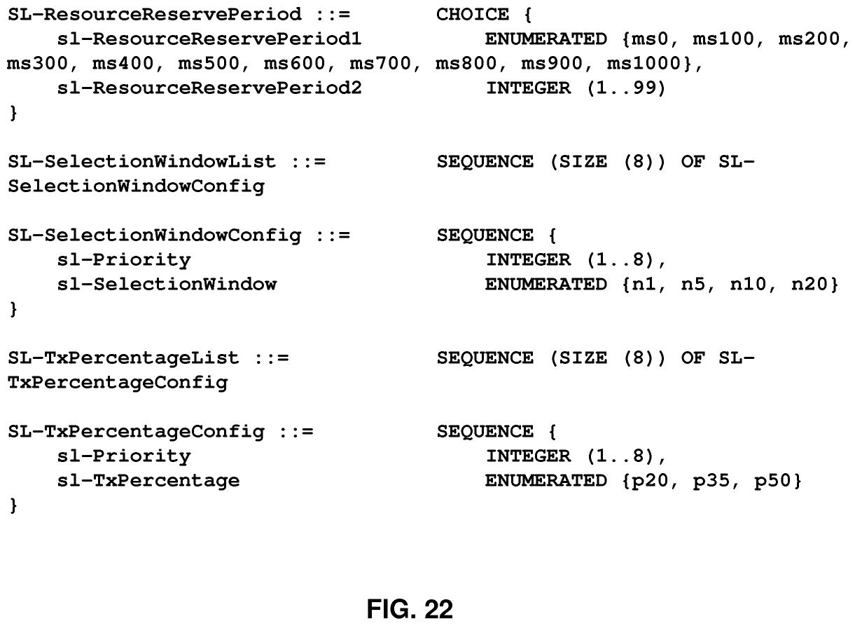

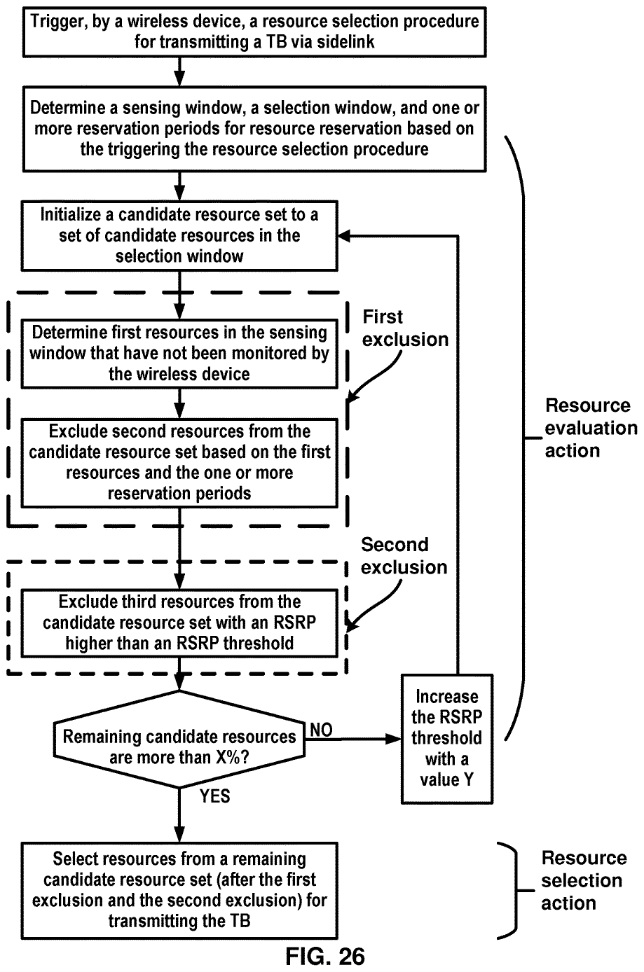

FIG. 21 and FIG. 22 illustrate examples of configuration information for sidelink communication. In an example, a base station may transmit one or more radio resource control (RRC) messages to a wireless device for delivering the configuration information for the sidelink communication. The configuration information may comprise a field of sl-UE-SelectedConfigRP. A parameter sl-ThresPSSCH-RSRP-List in the field may indicate a list of 64 thresholds. In an example, a wireless device may receive first sidelink control information (SCI) indicating a first priority. The wireless device may have second SCI to be transmitted. The second SCI may indicate a second priority. The wireless device may select a threshold from the list based on the first priority in the first SCI and the second priority in the second SCI. Referring to second exclusion in FIG. 26, the wireless device may exclude resources from candidate resource set based on the threshold. A parameter sl-MaxNumPerReserve in the field may indicate a maximum number of reserved PSCCH/PSSCH resources indicated in an SCI. A parameter sl-MultiReserveResource in the field may indicate if it is allowed to reserve a sidelink resource for an initial transmission of a TB by an SCI associated with a different TB, based on sensing and resource selection procedure. A parameter sl-ResourceReservePeriodList may indicate a set of possible resource reservation periods/intervals (e.g., SL-ResourceReservedPeriod) allowed in a resource pool. Up to 16 values may be configured per resource pool. A parameter sl-RS-ForSensing may indicate whether DMRS of PSCCH or PSSCH is used for layer 1 (e.g., physical layer) RSRP measurement in sensing operation. A parameter sl-SensingWindow may indicate a start of a sensing window. A parameter sl-SelectionWindowList may indicate an end of a selection window in resource selection procedure for a TB with respect to priority indicated in SCI. Value n1 may correspond to 1*2μ, value n5 corresponds to 5*2μ, and so on, where μ=0, 1, 2, 3 for subcarrier spacing (SCS) of 15, 30, 60, and 120 KHz respectively. A parameter SL-SelectionWindowConfig may indicate a mapping between a sidelink priority (e.g., sl-Priority) and the end of the selection window (e.g., sl-SelectionWindow).

The configuration information may comprise a parameter sl-PreemptionEnable indicating whether sidelink pre-emption is disabled or enabled in a resource pool. For example, a priority level p_preemption may be configured if the sidelink pre-emption is enabled. For example, if the sidelink pre-emption is enabled but the p_preemption is not configured, the sidelink pre-emption may be applicable to all priority levels.

The configuration information may comprise a parameter sl-TxPercentageList indicating a portion of candidate single-slot PSSCH resources over total resources. For example, value p20 may correspond to 20%, and so on. A parameter SL-TxPercentageConfig may indicate a mapping between a sidelink priority (e.g., sl-Priority) and the portion of candidate single-slot PSSCH resources over total resources (e.g., sl-TxPercentage).

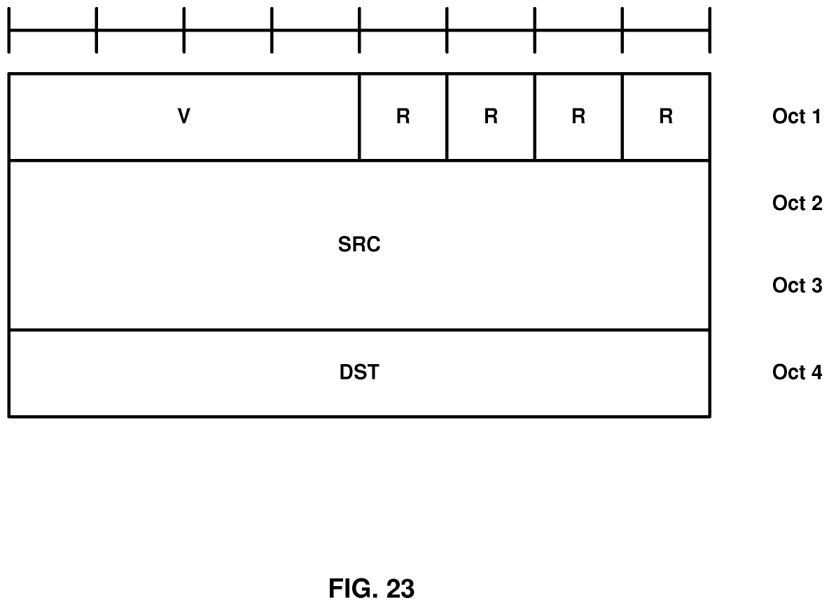

FIG. 23 illustrates an example format of a MAC subheader for sidelink shared channel (SL-SCH). The MAC subheader for SL-SCH may comprise seven header fields V/R/R/R/R/SCR/DST. The MAC subheader is octet aligned. For example, the V field may be a MAC protocol date units (PDU) format version number field indicating which version of the SL-SCH subheader is used. For example, the SRC field may carry 16 bits of a Source Layer-2 identifier (ID) field set to a first identifier provided by upper layers. For example, the DST field may carry 8 bits of the Destination Layer-2 ID set to a second identifier provided by upper layers. In an example, if the V field is set to “1”, the second identifier may be a unicast identifier. In an example, if the V field is set to “2”, the second identifier may be a groupcast identifier. In an example, if the V field is set to “3”, the second identifier may be a broadcast identifier. For example, the R field may indicate reserved bit.

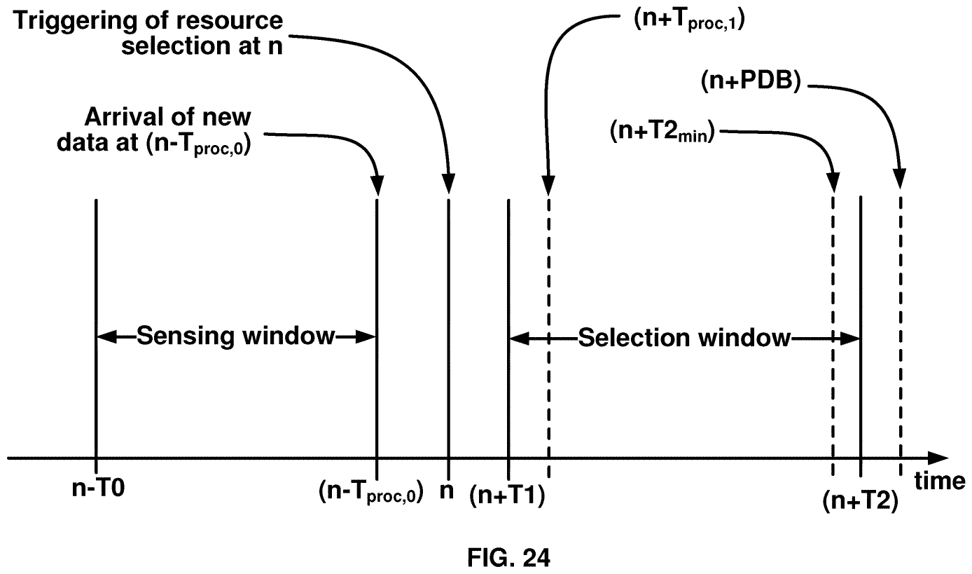

FIG. 24 illustrates an example time of a resource selection procedure. A wireless device may perform the resource selection procedure to select resources for one or more sidelink transmissions. As shown in FIG. 24, a sensing window of the resource selection procedure may start at time (n−T0) (e.g., parameter sl-SensingWindow). The sensing window may end at time (n−T_(proc,0)). New data of the one or more sidelink transmissions may arrive at the wireless device at time (n−T_(proc,0). The time period T_(proc,0) may be a processing delay of the wireless device to determine to trigger the resource selection procedure. The wireless device may determine to trigger the resource selection procedure at time n to select the resources for the new data arrived at time (n−T_(proc,0)). The wireless device may complete the resource selection procedure at time (n+T1). The wireless device may determine the parameter T1 based on a capability of the wireless device. The capability of the wireless device may be a processing delay of a processor of the wireless device. A selection window of the resource selection procedure may start at time (n+T1). The selection window may end at time (n+T2) indicating the ending of the selection window. The wireless device may determine the parameter T2 based on a parameter T2 min (e.g., sl-SelectionWindow). In an example, the wireless device may determine the parameter T2 subject to T2min≤T2≤PDB, where the PDB (packet delay budget) may be the maximum allowable delay (e.g., a delay budget) for successfully transmitting the new data via the one or more sidelink transmissions. The wireless device may determine the parameter T2 min to a corresponding value for a priority of the one or more sidelink transmissions (e.g., based on a parameter SL-SelectionWindowConfig indicating a mapping between a sidelink priority sl-Priority and the end of the selection window sl-SelectionWindow). In an example, the wireless device may set the parameter T2=PDB if the parameter T2 min>PDB.

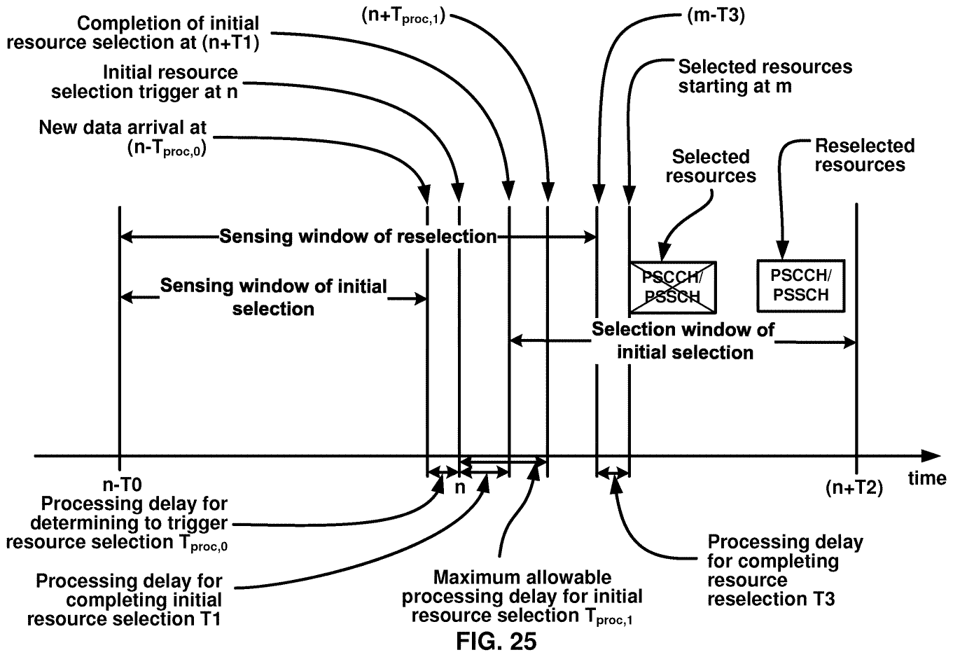

FIG. 25 illustrates an example timing of a resource selection procedure. A wireless device may perform the resource selection procedure for selecting resources for one or more sidelink transmissions. Referring to FIG. 24, a sensing window of initial selection may start at time (n-TO). The sensing window of initial selection may end at time (n−T_(proc,0)). New data of the one or more sidelink transmissions may arrive at the wireless device at the time (n−T_(proc,0)). The time period T_(proc,0) may be a processing delay for the wireless device to determine to trigger the initial selection of the resources. The wireless device may determine to trigger the initial selection at time n for selecting the resources for the new data arrived at the time (n−T_(proc,0)). The wireless device may complete the resource selection procedure at time (n+T1). The time (n+T_(proc, 1)) may be the maximum allowable processing latency for completing the resource selection procedure being triggered at the time n, where 0<T1ST_(proc, 1). A selection window of initial selection may start at time (n+T1). The selection window of initial selection may end at time (n+T2). The parameter T2 may be configured, preconfigured, or determined at the wireless device.

The wireless device may determine first resources (e.g., selected resources in FIG. 25) for the one or more sidelink transmissions based on the completion of the resource selection procedure at the time (n+T1). The wireless device may select the first resources from candidate resources in the selection window of initial selection based on measurements in the sensing window for initial selection. The wireless device may determine a resource collision between the first resources and other resources reserved by another wireless device. The wireless device may determine to drop the first resources for avoiding interference. The wireless device may trigger a resource reselection procedure (e.g., a second resource selection procedure) at time (m-T3) and/or before time (m-T3). The time period T3 may be a processing delay for the wireless device to complete the resource reselection procedure (e.g., a second resource selection procedure). The wireless device may determine second resources (e.g., reselected resource in FIG. 25) via the resource reselection procedure (e.g., a second resource selection procedure). The start time of the first resources may be time m (e.g., the first resources may be in slot m).

In an example, at least one of time parameters T0, T_(proc,0), T_(proc, 1), T2, and PDB may be configured by a base station to the wireless device. In an example, the at least one of the time parameters T0, T_(proc,0), T_(proc, 1), T2, and PDB may be preconfigured to the wireless device. The at least one of the time parameters T0, T_(proc,0), T_(proc, 1), T2, and PDB may be stored in a memory of the wireless device. In an example, the memory may be a Subscriber Identity Module (SIM) card. In an example of FIG. 24 and FIG. 25, the time n, m, T0, T1, T_(proc,0), T_(proc, 1), T2, T2 min, T3, and PDB may be in terms of slots and/or slot index.

FIG. 26 illustrates an example flowchart of a resource selection procedure by a wireless device for transmitting a TB (e.g., a data packet) via sidelink.

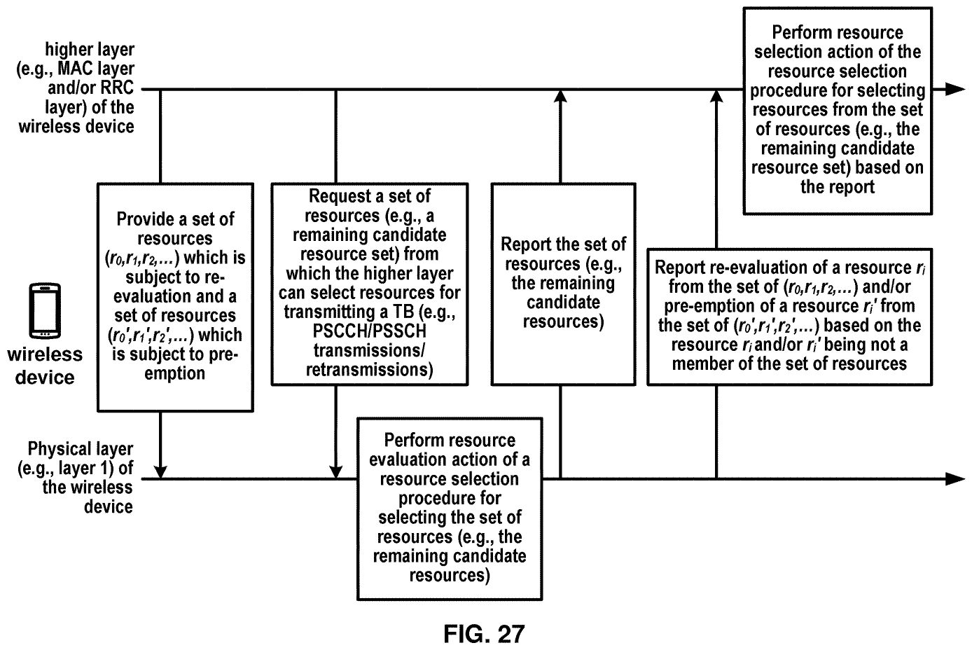

FIG. 27 illustrates an example diagram of the resource selection procedure among layers of the wireless device.

Referring to FIG. 26 and FIG. 27, the wireless device may transmit one or more sidelink transmissions (e.g., a first transmission of the TB and one or more retransmissions of the TB) for the transmitting of the TB. Referring to FIG. 19, a sidelink transmission of the one or more sidelink transmission may comprise a PSCCH. The sidelink transmission may comprise a PSSCH. The sidelink transmission may comprise a PSFCH. The wireless device may trigger the resource selection procedure for the transmitting of the TB. The resource selection procedure may comprise two actions. The first action of the two actions may be a resource evaluation action. Physical layer (e.g., layer 1) of the wireless device may perform the first action. The physical layer may determine a subset of resources based on the first action and report the subset of resources to higher layer (e.g., RRC layer and/or MAC layer) of the wireless device. The second action of the two actions may be a resource selection action. The higher layer (e.g., RRC layer and/or MAC layer) of the wireless device may perform the second action based on the reported the subset of resources from the physical layer.

In an example, higher layer (e.g., RRC layer and/or MAC layer) of a wireless device may trigger a resource selection procedure for requesting the wireless device to determine a subset of resources. The higher layer may select resources from the subset of resources for PSSCH and/or PSCCH transmission. To trigger the resource selection procedure, e.g., in slot n, the higher layer may provide the following parameters for the PSSCH and/or PSCCH transmission:
a resource pool, from which the wireless device may determine the subset of resources;
layer 1 priority, prio_TX (e.g., sl-Priority referring to FIG. 21 and FIG. 22), of the PSSCH/PSCCH transmission;
remaining packet delay budget (PDB) of the PSSCH and/or PSCCH transmission;
a number of sub-channels, L_“subCH”, for the PSSCH and/or PSCCH transmission in a slot;
a resource reservation period/interval, P_“rsvp_TX”, in units of millisecond (ms).

In an example, if the higher layer requests the wireless device to determine a subset of resources from which the higher layer will select the resources for the PSSCH and/or PSCCH transmission for re-evaluation and/or pre-emption, the higher layer may provide a set of resources (r_0, r_1, r_2, . . . ) which may be subject to the re-evaluation and a set of resources (r_0\hat{ }′,r_1\hat{ }′,r_2\hat{ }′, . . . ) which may be subject to the pre-emption.

In an example, a base station (e.g., network) may transmit a message comprising one or more parameters to the wireless device for performing the resource selection procedure. The message may be an RRC/SIB message, a MAC CE, and/or a DCI. In an example, a second wireless device may transmit a message comprising one or more parameters to the wireless device for performing the resource selection procedure. The message may be an RRC message, a MAC CE, and/or a SCI. The one or more parameters may indicate following information.
sl-SelectionWindowList (e.g., sl-SelectionWindow referring to FIG. 21 and FIG. 22): an internal parameter T2 min (e.g., T2 min referring to FIG. 24) may be set to a corresponding value from the parameter sl-SelectionWindowList for a given value of prio_TX (e.g., based on SL-SelectionWindowConfig referring to FIG. 21 and FIG. 22).
sl-ThresPSSCH-RSRP-List (e.g., sl-ThresPSSCH-RSRP-List referring to FIG. 21 and FIG. 22): a parameter may indicate an RSRP threshold for each combination (p_i, p_j), where p_i is a value of a priority field in a received SCI format 1-A and p_j is a priority of a sidelink transmission (e.g., the PSSCH/PSCCH transmission) of the wireless device; In an example of the resource selection procedure, an invocation of p_j may be p_j=prio_TX.
sl-RS-ForSensing (e.g., sl-RS-ForSensing referring to FIG. 21 and FIG. 22): a parameter may indicate whether DMRS of a PSCCH or a PSSCH is used, by the wireless device, for layer 1 (e.g., physical layer) RSRP measurement in sensing operation.
sl-ResourceReservePeriodList (e.g., sl-ResourceReservePeriodList referring to FIG. 21 and FIG. 22)
sl-SensingWindow (e.g., sl-SensingWindow referring to FIG. 21 and FIG. 22): an internal parameter T_0 may be defined as a number of slots corresponding to t0_SensingWindow ms.
sl-TxPercentageList (e.g., based on SL-TxPercentageConfig referring to FIG. 21 and FIG. 22): an internal parameter X (e.g., sl-TxPercentage referring to FIG. 21 and FIG. 22) for a given prio_TX (e.g., sl-Priority referring to FIG. 21 and FIG. 22) may be defined as sl-xPercentage (prio_TX) converted from percentage to ratio.
sl-PreemptionEnable (e.g., p_preemption referring to FIG. 21 and FIG. 22): an internal parameter prio_pre may be set to a higher layer provided parameter sl-PreemptionEnable.

The resource reservation period/interval, P_“rsvp_TX”, if provided, may be converted from units of ms to units of logical slots, resulting in P_“rsvp\_TX”\hat{ }′.

Notation: (t_0\hat{ }SL, t_1\hat{ }SL, t_2\hat{ }SL, . . . ) may denote a set of slots of a sidelink resource pool.

In the resource evaluation action (e.g., the first action in FIG. 26), the wireless device may determine a sensing window (e.g., the sensing window shown in FIG. 24 and FIG. 25 based on sl-SensingWindow) based on the triggering the resource selection procedure. The wireless device may determine a selection window (e.g., the selection window shown in FIG. 24 and FIG. 25 based on sl-SelectionWindowList) based on the triggering the resource selection procedure. The wireless device may determine one or more reservation periods/intervals (e.g., parameter sl-ResourceReservePeriodList) for resource reservation. In an example, a candidate single-slot resource for transmission R_“x,y” may be defined as a set of L_“subCH” contiguous sub-channels with sub-channel x+j in slot t_y\hat{ }SL where j=0, . . . , L_“subCH”−1. The wireless device may assume that a set of L_“subCH” contiguous sub-channels in the resource pool within a time interval [n+T_1,n+T_2] correspond to one candidate single-slot resource (e.g., referring to FIG. 24 and FIG. 25). A total number of candidate single-slot resources may be denoted by M_“total”. In an example, referring to FIG. 24 and FIG. 25, the sensing window may be defined by a number of slots in a time duration of [n−T_0,n−T_(proc,0)\hat{ }). The wireless device may monitor a first subset of the slots, of a sidelink resource pool, within the sensing window. The wireless device may not monitor a second subset of the slots than the first subset of the slots due to half duplex. The wireless device may perform the following actions based on PSCCH decoded and RSRP measured in the first subset of the slots. In an example, an internal parameter Th(p_i,p_j) may be set to the corresponding value of RSRP threshold indicated by the i-th field in sl-ThresPSSCH-RSRP-List, where i=p_i+(p_j−1)*8.

Referring to FIG. 26 and FIG. 27, in the resource evaluation action (e.g., the first action in FIG. 26), the wireless device may initialize a candidate resource set (e.g., a set S_A) to be a set of candidate resources. In an example, the candidate resource set may be the union of candidate resources within the selection window. In an example, a candidate resource may be a candidate single-subframe resource. In an example, a candidate resource may be a candidate single-slot resource. In an example, the set S_A may be initialized to a set of all candidate single-slot resources.

Referring to FIG. 26 and FIG. 27, in the resource evaluation action (e.g., the first action in FIG. 26), the wireless device may perform a first exclusion for excluding second resources from the candidate resource set based on first resources and one or more reservation periods/intervals. In an example, the wireless device may not monitor the first resources within a sensing window. In an example, the one or more reservation periods/intervals may be configured/associated with a resource pool of the second resources. In an example, the wireless device may determine the second resources within a selection window which might be reserved by a transmission transmitted via the first resources based on the one or more reservation periods/intervals. In an example, the wireless device may exclude a candidate single-slot resource R_“x,y” from the set S_A based on following conditions:
the wireless device has not monitored slot t_m\hat{ }SL in the sensing window.
for any periodicity value allowed by the parameter sl-ResourceReservePeriodList and a hypothetical SCI format 1-A received in the slot t_m\hat{ }SL with “Resource reservation period” field set to that periodicity value and indicating all sub-channels of the resource pool in this slot, condition c of a second exclusion would be met.

Referring to FIG. 26 and FIG. 27, in the resource evaluation action (e.g., the first action in FIG. 26), the wireless device may perform a second exclusion for excluding third resources from the candidate resource set. In an example, a SCI may indicate a resource reservation of the third resources. The SCI may further indicate a priority value (e.g., indicated by a higher layer parameter sl-Priority). The wireless device may exclude the third resources from the candidate resource set based on a reference signal received power (RSRP) of the third resources being higher than an RSRP threshold (e.g., indicated by a higher layer parameter sl-ThresPSSCH-RSRP-List). The RSRP threshold may be related to the priority value based on a mapping list of RSRP thresholds to priority values configured and/or pre-configured to the wireless device. In an example, a base station may transmit a message to the wireless device for configuring the mapping list. The message may be a radio resource control (RRC) message. In an example, the mapping list may be pre-configured to the wireless device. A memory of the wireless device may store the mapping list. In an example, a priority indicated by the priority value may be a layer 1 priority (e.g., physical layer priority). In an example, a bigger priority value may indicate a higher priority of a sidelink transmission. A smaller priority value may indicate a lower priority of the sidelink transmission. In another example, a bigger priority value may indicate a lower priority of a sidelink transmission. A smaller priority value may indicate a higher priority of the sidelink transmission. In an example, the wireless device may exclude a candidate single-slot resource R_“x,y” from the set S_A based on following conditions:
a) the wireless device receives an SCI format 1-A in slot t_m\hat{ }SL, and “Resource reservation period” field, if present, and “Priority” field in the received SCI format 1-A indicate the values P_“rsvp_RX” and prio_RX;
b) the RSRP measurement performed, for the received SCI format 1-A, is higher than Th(prio_RX,prio_TX);
c) the SCI format received in slot t_m\hat{ }SLor the same SCI format which, if and only if the “Resource reservation period” field is present in the received SCI format 1-A, is assumed to be received in slot(s) t_(m+q×P_(rsvp\_RX)\hat{ }′)\hat{ }SL determines the set of resource blocks and slots which overlaps with R_(x,y+j×P_(rsvp_TX)\hat{ }′) for q=1, 2, . . . , Q and j=0, 1, . . . , C_resel−1. Here, P_(rsvp\_RX)\hat{ }′ is P_“rsvp_RX” converted to units of logical slots, Q=┘T_scal/P_(rsvp\_RX)└ if P_(rsvp_RX)<T_scal and n\hat{ }′-m≤P_(rsvp\_RX)\hat{ }′, where t_(n\hat{ }′)\hat{ }SL=n if slot n belongs to the set (t_0\hat{ }SL,t_1\hat{ }SL, . . . , t_(T_max)\hat{ }SL), otherwise slot t_(n\hat{ }′)\hat{ }SL is the first slot after slot n belonging to the set (t_0\hat{ }SL,t_1\hat{ }SL, . . . , t_(T_max)\hat{ }SL); otherwise Q=1. T_scal is set to selection window size T2 converted to units of ms.

Referring to FIG. 26 and FIG. 27, in the resource evaluation action (e.g., the first action in FIG. 26), the wireless device may determine whether remaining candidate resources in the candidate resource set are sufficient for selecting resources for the one or more sidelink transmissions of the TB based on a condition, after performing the first exclusion and the second exclusion. In an example, the condition may be the total amount of the remaining candidate resources in the candidate resource set being more than X percent (e.g., indicated by a higher layer parameter sl-TxPercentageList) of the candidate resources in the candidate resource set before performing the first exclusion and the second exclusion. If the condition is not met, the wireless device may increase the RSRP threshold used to exclude the third resources with a value Y and iteratively re-perform the initialization, first exclusion, and second exclusion until the condition being met. In an example, if the number of remaining candidate single-slot resources in the set S_A is smaller than X·M_“total”, then Th(p_i,p_j) may be increased by 3 dB and the procedure continues with re-performing of the initialization, first exclusion, and second exclusion until the condition being met. In an example, the wireless device may report the set S_A (e.g., the remaining candidate resources of the candidate resource set) to the higher layer of the wireless device. In an example, the wireless device may report the set S_A (e.g., the remaining candidate resources of the candidate resource set when the condition is met) to the higher layer of the wireless device, based on that the number of remaining candidate single-slot resources in the set S_A being greater than or equal to X·M_“total”.

Referring to FIG. 26 and FIG. 27, in the resource selection action (e.g., the second action in FIG. 26), the wireless device (e.g., the higher layer of the wireless device) may select fourth resources from the remaining candidate resources of the candidate resource set (e.g., the set S_A reported by the physical layer) for the one or more sidelink transmissions of the TB. In an example, the wireless device may randomly select the fourth resources from the remaining candidate resources of the candidate resource set.

Referring to FIG. 26 and FIG. 27, in an example, if a resource r_i from the set (r_0,r_1,r_2, . . . ) is not a member of S_A (e.g., the remaining candidate resources of the candidate resource set when the condition is met), the wireless device may report re-evaluation of the resource r_i to the higher layers.

Referring to FIG. 26 and FIG. 27, in an example, if a resource r_i \hat{ }′ from the set (r_0\hat{ }′,r_1\hat{ }′,r_2\hat{ }′, . . . ) meets the conditions below, then the wireless device may report pre-emption of the resource r_i \hat{ }′ to the higher layers.
r_i \hat{ }′ is not a member of S_A, and
r_i \hat{ }′ meets the conditions for the second exclusion, with Th(prio_RX,prio_TX) set to a final threshold for reaching X·M_total, and
the associated priority prio_RX, satisfies one of the following conditions:
sl-PreemptionEnable is provided and is equal to ‘enabled’ and prio_TX>prio_RX
sl-PreemptionEnable is provided and is not equal to ‘enabled’, and prio_RX<prio_pre and prio_TX>prio_RX

In an example, if the resource r_i is indicated for re-evaluation by the wireless device (e.g., the physical layer of the wireless device), the higher layer of the wireless device may remove the resource r_i from the set (r_0,r_1,r_2, . . . ). In an example, if the resource r_i′ is indicated for pre-emption by the wireless device (e.g., the physical layer of the wireless device), the higher layer of the wireless device may remove the resource r_i′ from the set (r_0\hat{ }′,r_1\hat{ }′,r_2\hat{ }′, . . . ). The higher layer of the wireless device may randomly select new time and frequency resources from the remaining candidate resources of the candidate resource set (e.g., the set S_A reported by the physical layer) for the removed resources r_i and/or r_i′. The higher layer of the wireless device may replace the removed resources r_i and/or r_i′ by the new time and frequency resources. For example, the wireless device may remove the resources r_i and/or r_i′ from the set (r_0,r_1,r_2, . . . ) and/or the set (r_0\hat{ }′,r_1\hat{ }′,r_2\hat{ }′, . . . ) and add the new time and frequency resources to the set (r_0,r_1,r_2, . . . ) and/or the set (r_0\hat{ }′,r_1\hat{ }′,r_2\hat{ }′, . . . ) based on the removing of the resources r_i and/or r_i′.

Sidelink pre-emption may happen between a first wireless device and a second wireless device. The first wireless device may select first resources for a first sidelink transmission. The first sidelink transmission may have a first priority. The second wireless device may select second resources for a second sidelink transmission. The second sidelink transmission may have a second priority. The first resources may partially and/or fully overlap with the second resources. The first wireless device may determine a resource collision between the first resources and the second resources based on that the first resources and the second resources being partially and/or fully overlapped. The resource collision may imply fully and/or partially overlapping between the first resources and the second resources in time, frequency, code, power, and/or spatial domain. Referring to an example of FIG. 18, the first resources may comprise one or more first sidelink resource units in a sidelink resource pool. The second resources may comprise one or more second sidelink resource units in the sidelink resource pool. A partial resource collision between the first resources and the second resources may indicate that the at least one sidelink resource unit of the one or more first sidelink resource units belongs to the one or more second sidelink resource units. A full resource collision between the first resources and the second resources may indicate that the one or more first sidelink resource units may be the same as or a subset of the one or more second sidelink resource units. In an example, a bigger priority value may indicate a lower priority of a sidelink transmission. A smaller priority value may indicate a higher priority of the sidelink transmission. In an example, the first wireless device may determine the sidelink pre-emption based on the resource collision and the second priority being higher than the first priority. That is, the first wireless device may determine the sidelink pre-emption based on the resource collision and a value of the second priority being smaller than a value of the first priority. In another example, the first wireless device may determine the sidelink pre-emption based on the resource collision, the value of the second priority being smaller than a priority threshold, and the value of the second priority being smaller than the value of the first priority.

Referring to FIG. 25, a first wireless device may trigger a first resource selection procedure for selecting first resources (e.g., selected resources after resource selection with collision in FIG. 25) for a first sidelink transmission. A second wireless device may transmit an SCI indicating resource reservation of the first resource for a second sidelink transmission. The first wireless device may determine a resource collision on the first resources between the first sidelink transmission and the second sidelink transmission. The first wireless device may trigger a resource re-evaluation (e.g., a resource evaluation action of a second resource selection procedure) at and/or before time (m-T3) based on the resource collision. The first wireless device may trigger a resource reselection (e.g., a resource selection action of the second resource selection procedure) for selecting second resources (e.g., reselected resources after resource reselection in FIG. 25) based on the resource re-evaluation. The start time of the second resources may be time m.

A UE may receive one or more messages (e.g., RRC messages and/or SIB messages) comprising configuration parameters of a sidelink BWP. The configuration parameters may comprise a first parameter (e.g., sl-StartSymbol) indicating a sidelink starting symbol. The first parameter may indicate a starting symbol (e.g., symbol #0, symbol #1, symbol #2, symbol #3, symbol #4, symbol #5, symbol #6, symbol #7, etc.) used for sidelink in a slot. For example, the slot may not comprise a SL-SSB (S-SSB). In an example, the UE may be (pre-) configured with one or more values of the sidelink starting symbol per sidelink BWP. The configuration parameters may comprise a second parameter (e.g., sl-LengthSymbols) indicating number of symbols (e.g., 7 symbols, 8 symbols, 9 symbols, 10 symbols, 11 symbols, 12 symbols, 13 symbols, 14 symbols, etc.) used sidelink in a slot. For example, the slot may not comprise a SL-SSB (S-SSB). In an example, the UE may be (pre-) configured with one or more values of the sidelink number of symbols (symbol length) per sidelink BWP.

The configuration parameters of the sidelink BWP may indicate one or more sidelink (communication) resource pools of the sidelink BWP (e.g., via SL-BWP-PoolConfig and/or SL-BWP-PoolConfigCommon). A resource pool may be a sidelink receiving resource pool (e.g., indicated by sl-RxPool) on the configured sidelink BWP. For example, the receiving resource pool may be used for PSFCH transmission/reception, if configured. A resource pool may be a sidelink transmission resource pool (e.g., indicated by sl-TxPool, and/or sl-ResourcePool) on the configured sidelink BWP. For example, the transmission resource pool may comprise resources by which the UE is allowed to tranmsit NR sidelink communication (e.g., in exceptional conditions and/or based on network scheduling) on the configured BWP. For example, the transmission resource pool may be used for PSFCH transmission/reception, if configured.

Configuration parameters of a resource pool may indicate a size of a sub-channel of the resource pool (e.g., via sl-SubchannelSize) in unit of PRB. For example, the sub-channel size may indicate a minimum granularity in frequency domain for sensing and/or for PSSCH resource selection. Configuration parameters of a resource pool may indicate a lowest/starting RB index of a sub-channel with a lowest index in the resource pool with respect to lowest RB index RB index of the sidelink BWP (e.g., via sl-StartRB-Subchannel). Configuration parameters of a resource pool may indicate a number of sub-channels in the corresponding resource pool (e.g., via sl-NumSubchannel). For example, the sub-channels and/or the resource pool may consist of contiguous PRBs.

Configuration parameters of a resource pool may indicate configuration of one or more sidelink channels on/in the resource pool. For example, the configuration parameters may indicate that the resource pool is configured with PSSCH and/or PSCCH and/or PSFCH.

Configuration parameters of PSCCH may indicate a time resource for a PSCCH transmission in a slot. Configuration parameters of PSCCH (e.g., SL-PSCCH-Config) may indicate a number of symbols of PSCCH (e.g., 2 or 3) in the resource pool (e.g., via sl-TimeResourcePSCCH). Configuration parameters of PSCCH (e.g., SL-PSCCH-Config) may indicate a frequency resource for a PSCCH transmission in a corresponding resource pool (e.g., via sl-FreqResourcePSCCH). For example, the configuration parameters may indicate a number of PRBs for PSCCH in a resource pool, which may not be greater than a number of PRBs of a sub-channel of the resource pool (sub-channel size).

Configuration parameters of PSSCH may indicate one or more DMRS time domain patterns (e.g., PSSCH DMRS symbols in a slot) for the PSSCH that may be used in the resource pool.

A resource pool may or may not be configured with PSFCH. Configuration parameters of PSFCH may indicate a period for the PSFCH in unit/number of slots within the resource pool (e.g., via sl-PSFCH-Period). For example, a value 0 of the period may indicate that no resource for PSFCH is configured in the resource pool and/or HARQ feedback for (all) transmissions in the resource pool is disabled. For example, the period may be 1 slot or 2 slots or 4 slots, etc. Configuration parameters of PSFCH may indicate a set of PRBs that are (actually) used for PSFCH transmission and reception (e.g., via sl-PSFCH-RB-Set). For example, a bitmap may indicate the set of PRBs, wherein a leftmost bit of the bitmap may refer to a lowest RB index in the resource pool, and so on. Configuration parameters of PSFCH may indicate a minimum time gap between PSFCH and the associated PSSCH in unit of slots (e.g., via sl-MinTimeGapPSFCH). Configuration parameters of PSFCH may indicate a number of PSFCH resources available for multiplexing HARQ-ACK information in a PSFCH transmission (e.g., via sl-PSFCH-CandidateResourceType).

A UE may be configured by higher layers (e.g., by RRC configuration parameters) with one or more sidelink resource pools. A sidelink resource pool may be for transmission of PSSCH and/or for reception of PSSCH. A sidelink resource pool may be associated with sidelink resource allocation mode 1 and/or sidelink resource allocation mode 2. In the frequency domain, a sidelink resource pool consists of one or more (e.g., sl-NumSubchannel) contiguous sub-channels. A sub-channel consists of one or more (e.g., sl-SubchannelSize) contiguous PRBs. For example, higher layer parameters (e.g., RRC configuration parameters) may indicate a number of sub-channels in a sidelink resource pool (e.g., sl-NumSubchannel) and/or a number of PRBs per sub-channel (e.g., sl-SubchannelSize).

A set of slots that may belong to a sidelink resource pool. The set of slots may be denoted by (t_0\hat{ }SL,t_1 \hat{ }SL, . . . , t_(T_max−1)\hat{ }SL) where [symbol] 0≤t [symbol] _i\hat{ }SL<10240×2\hat{ }μ,0≤i<T_max. The slot index may be relative to slot #0 of the radio frame corresponding to SFN 0 of the serving cell or DFN 0. The set includes all the slots except N_(S_SSB) slots in which S-SS/PSBCH block (S-SSB) is configured. The set includes all the slots except N_nonSL slots in each of which at least one of Y-th, (Y+1)-th, . . . , (Y+X−1)-th OFDM symbols are not semi-statically configured as UL as per the higher layer parameter (e.g., tdd-UL-DL-ConfigurationCommon-r16 of the serving cell if provided and/or sl-TDD-Configuration-r16 if provided and/or sl-TDD-Config-r16 of the received PSBCH if provided). For example, a higher layer (e.g., MAC or RRC) parameter may indicate a value of Y as the sidelink starting symbol of a slot (e.g., sl-StartSymbol). For example, a higher layer (e.g., MAC or RRC) parameter may indicate a value of X as the number of sidelink symbols in a slot (e.g., sl-LengthSymbols). The set includes all the slots except one or more reserved slots. The slots in the set may be arranged in increasing order of slot index. The UE may determine the set of slot assigned to a sidelink resource pool based on a bitmap (b_0,b_1, . . . , b_(L_bitmap−1)) associated with the resource pool where L_bitmap the length of the bitmap is configured by higher layers. A slot t_k\hat{ }SL (0≤k<10240×2\hat{ }μ−N_(S_SSB)−N_nonSL-N_reserved) may belong to the set of slots if b_(k \hat{ }′)=1 where k\hat{ }′=k mod L_bitmap. The slots in the set are re-indexed such that the subscripts i of the remaining slots [symbol] t [symbol] _i\hat{ }SL are successive {0, 1, . . . , [symbol] T [symbol] ]_max−1} where [symbol] T′ [symbol] _max is the number of the slots remaining in the set.

The UE may determine the set of resource blocks assigned to a sidelink resource pool, wherein the resource pool consists of N_PRB PRBs. The sub-channel m for m=0, 1, . . . , numSubchannel−1 consists of a set of n_subCHsize contiguous resource blocks with the physical resource block number n_PRB=n_subCHRBstart+m·n_subCHsize+j for j=0, 1, . . . , n_subCHsize−1, where n_subCHRBstart and n_subCHsize are given by higher layer parameters sl-StartRB-Subchannel and sl-SubchannelSize, respectively. A UE may not be expected to use the last N_PRB “mod” n_subCHsize PRBs in the resource pool.

A UE may be provided/configured with a number of symbols in a resource pool for PSCCH (e.g., by sl-TimeResourcePSCCH). The PSCCH symbols may start from a second symbol that is available for sidelink transmissions in a slot. The UE may be provided/configured with a number of PRBs in the resource pool for PSCCH (e.g., by sl-FreqResourcePSCCH). The PSCCH PRBs may start from the lowest PRB of the lowest sub-channel of the associated PSSCH, e.g., for a PSCCH transmission with a SCI format 1-A. In an example, PSCCH resource/symbols may be configured in every slot of the resource pool. In an example, PSCCH resource/symbols may be configured in a subset of slot of the resource pool (e.g., based on a period comprising two or more slots).

In an example, each PSSCH transmission is associated with an PSCCH transmission. The PSCCH transmission may carry the 1st stage of the SCI associated with the PSSCH transmission. The 2nd stage of the associated SCI may be carried within the resource of the PSSCH. In an example, the UE transmits a first SCI (e.g., 1st stage SCI, SCI format 1-A) on PSCCH according to a PSCCH resource configuration in slot n and PSCCH resource m. For the associated PSSCH transmission in the same slot, the UE may transmit one transport block (TB) with up to two layers (e.g., one layer or two layers). The number of layers (v) may be determined according to the ‘Number of DMRS port’ field in the SCI. The UE may determine the set of consecutive symbols within the slot for transmission of the PSSCH. The UE may determine the set of contiguous resource blocks for transmission of the PSSCH. Transform precoding may not be supported for PSSCH transmission. For example, wideband precoding may be supported for PSSCH transmission.

The UE may set the contents of the second SCI (e.g., 2nd stage SCI, SCI format 2-A). The UE may set values of the SCI fields comprising the ‘HARQ process number’ field, the ‘NDI’ field, the ‘Source ID’ field, the ‘Destination ID’ field, the ‘HARQ feedback enabled/disabled indicator’ field, the ‘Cast type indicator’ field, and/or the ‘CSI request’ field, as indicated by higher (e.g., MAC and/or RRC) layers. The UE may set the contents of the second SCI (e.g., 2nd stage SCI, SCI format 2-B). The UE may set values of the SCI fields comprising the ‘HARQ process number’ field, the ‘NDI’ field, the ‘Source ID’ field, the ‘Destination ID’ field, the ‘HARQ feedback enabled/disabled indicator’ field, the ‘Zone ID’ field, and/or the ‘Communication range requirement’ field, as indicated by higher (e.g., MAC and/or RRC) layers.

In an example, one transmission scheme may be defined for the PSSCH and may be used for all PSSCH transmissions. PSSCH transmission may be performed with up to two antenna ports, e.g., with antenna ports 1000-1001.

In sidelink resource allocation mode 1, for PSSCH and/or PSCCH transmission, dynamic grant, configured grant type 1 and/or configured grant type 2 may be supported. The configured grant Type 2 sidelink transmission is semi-persistently scheduled by a SL grant in a valid activation DCI.

The UE may transmit the PSSCH in the same slot as the associated PSCCH. The (minimum) resource allocation unit in the time domain may be a slot. The UE may transmit the PSSCH in consecutive symbols within the slot. The UE may not transmit PSSCH in symbols which are not configured for sidelink. A symbol may be configured for sidelink, according to higher layer parameters indicating the starting sidelink symbol (e.g., startSLsymbols) and a number of consecutive sidelink symbols (e.g., lengthSLsymbols). For example, startSLsymbols is the symbol index of the first symbol of lengthSLsymbols consecutive symbols configured for sidelink. Within the slot, PSSCH resource allocation may start at symbol startSLsymbols+1 (e.g., second sidelink symbol of the slot). The UE may not transmit PSSCH in symbols which are configured for use by PSFCH, if PSFCH is configured in this slot. The UE may not transmit PSSCH in the last symbol configured for sidelink (e.g., last sidelink symbol of the slot). The UE may not transmit PSSCH in the symbol immediately preceding the symbols which are configured for use by PSFCH, if PSFCH is configured in this slot. FIG. 19 shows an example of sidelink symbols and the PSSCH resource allocation within the slot.

A Sidelink grant may be received dynamically on the PDCCH, and/or configured semi-persistently by RRC, and/or autonomously selected by the MAC entity of the UE. The MAC entity may have a sidelink grant on an active SL BWP to determine a set of PSCCH duration(s) in which transmission of SCI occurs and a set of PSSCH duration(s) in which transmission of SL-SCH associated with the SCI occurs. A sidelink grant addressed to SLCS-RNTI with NDI=1 is considered as a dynamic sidelink grant. The UE may be configured with Sidelink resource allocation mode 1. The UE may for each PDCCH occasion and for each grant received for this PDCCH occasion (e.g., for the SL-RNTI or SLCS-RNTI of the UE), use the sidelink grant to determine PSCCH duration(s) and/or PSSCH duration(s) for initial transmission and/or one or more retransmission of a MAC PDU for a corresponding sidelink process (e.g., associated with a HARQ buffer and/or a HARQ process ID).

The UE may be configured with Sidelink resource allocation mode 2 to transmit using pool(s) of resources in a carrier, based on sensing or random selection. The MAC entity for each Sidelink process may select to create a selected sidelink grant corresponding to transmissions of multiple MAC PDUs, and SL data may be available in a logical channel. The UE may select a resource pool, e.g., based on a parameter enabling/disabling sidelink HARQ feedback. The UE may perform the TX resource (re-)selection check on the selected pool of resources. The UE may select the time and frequency resources for one transmission opportunity from the resources pool and/or from the resources indicated by the physical layer, according to the amount of selected frequency resources and the remaining PDB of SL data available in the logical channel(s) allowed on the carrier. The UE may use the selected resource to select a set of periodic resources spaced by the resource reservation interval for transmissions of PSCCH and PSSCH corresponding to the number of transmission opportunities of MAC PDUs. The UE may consider the first set of transmission opportunities as the initial transmission opportunities and the other set(s) of transmission opportunities as the retransmission opportunities. The UE may consider the sets of initial transmission opportunities and retransmission opportunities as the selected sidelink grant. The UE may consider the set as the selected sidelink grant. The UE may use the selected sidelink grant to determine the set of PSCCH durations and the set of PSSCH durations.

The UE may for each PSSCH duration and/or for each sidelink grant occurring in this PSSCH duration, select a MCS table allowed in the pool of resource which is associated with the sidelink grant. The UE may determine/set the resource reservation interval to a selected value (e.g., 0 or more). In an example, if the configured sidelink grant has been activated and this PSSCH duration corresponds to the first PSSCH transmission opportunity within this period of the configured sidelink grant, the UE may set the HARQ Process ID to the HARQ Process ID associated with this PSSCH duration and, if available, all subsequent PSSCH duration(s) occurring in this period for the configured sidelink grant. The UE may flush the HARQ buffer of Sidelink process associated with the HARQ Process ID. The UE may deliver the sidelink grant, the selected MCS, and the associated HARQ information to the Sidelink HARQ Entity for this PSSCH duration.

The MAC entity may include at most one Sidelink HARQ entity for transmission on SL-SCH, which maintains a number of parallel Sidelink processes. The (maximum) number of transmitting Sidelink processes associated with the Sidelink HARQ Entity may be a value (e.g., 16). A sidelink process may be configured for transmissions of multiple MAC PDUs. For transmissions of multiple MAC PDUs with Sidelink resource allocation mode 2, the (maximum) number of transmitting Sidelink processes associated with the Sidelink HARQ Entity may be a second value (e.g., 4). A delivered sidelink grant and its associated Sidelink transmission information may be associated with a Sidelink process. Each Sidelink process may support one TB.

For each sidelink grant and for the associated Sidelink process, the Sidelink HARQ Entity may obtain the MAC PDU to transmit from the Multiplexing and assembly entity, if any. The UE may determine Sidelink transmission information of the TB for the source and destination pair of the MAC PDU. The UE may set the Source Layer-1 ID to the 8 LSB of the Source Layer-2 ID of the MAC PDU, and set the Destination Layer-1 ID to the 16 LSB of the Destination Layer-2 ID of the MAC PDU. The UE may set the following information of the TB: cast type indicator, HARQ feedback enabler/disabler, priority, NDI, RV. The UE may deliver the MAC PDU, the sidelink grant and the Sidelink transmission information of the TB to the associated Sidelink process. The MAC entity of the UE may instruct the associated Sidelink process to trigger a new transmission or a retransmission.

In sidelink resource allocation mode 1, for sidelink dynamic grant, the PSSCH transmission may be scheduled by a DCI (e.g., DCI format 3_0). In sidelink resource allocation mode 1, for sidelink configured grant type 2, the configured grant may be activated by a DCI (e.g., DCI format 3_0). In sidelink resource allocation mode 1, for sidelink dynamic grant and sidelink configured grant type 2 the “Time gap” field value m of the DCI may provide an index m+1 into a slot offset table (e.g., the table may be configured by higher layer parameter sl-DCI-ToSL-Trans). The table value at index m+1 may be referred to as slot offset K_SL. The slot of the first sidelink transmission scheduled by the DCI may be the first SL slot of the corresponding resource pool that starts not earlier than T_“DL”-T_“TA”/2+K_SL×T_“slot”, where T_“DL” is the starting time of the downlink slot carrying the corresponding DCI, T_“TA” is the timing advance value corresponding to the TAG of the serving cell on which the DCI is received and K_SL is the slot offset between the slot of the DCI and the first sidelink transmission scheduled by DCI and T_slot is the SL slot duration. The “Configuration index” field of the DCI, if provided and not reserved, may indicate the index of the sidelink configured type 2. In sidelink resource allocation mode 1, for sidelink configured grant type 1, the slot of the first sidelink transmissions may follow the higher layer configuration.

For each sidelink grant, the UE (e.g., the MAC entity of the UE) may determine whether the sidelink grant is used for initial transmission or retransmission.

For example, the UE may determine that the delivered sidelink grant is used for a retransmission. The UE may determine the HARQ process indicated by the sidelink grant. The UE may ignore the sidelink grant e.g., if the HARQ Process ID corresponding to the sidelink grant is associated to a Sidelink process of which HARQ buffer is empty; and/or if the HARQ Process ID corresponding to the sidelink grant received on PDCCH is not associated to any Sidelink process; and/or if PSCCH duration(s) and PSSCH duration(s) for one or more retransmissions of a MAC PDU of the dynamic sidelink grant or the configured sidelink grant is not in SL DRX Active time of the destination that has data to be sent (e.g., the destinaiton UE of the MAC PDU). The UE may identify the Sidelink process associated with this grant (e.g., based on the HARQ process of the grant). For the associated Sidelink process, the UE may deliver the sidelink grant of the MAC PDU to the associated Sidelink process. The UE may instruct the associated Sidelink process to trigger a retransmission of the MAC PDU.

For example, the UE may determine that the delivered sidelink grant is used for initial transmission (e.g., the NDI in/of the grant may be toggled for the indicated HARQ process). The UE may associate or reassociate a sidelink process to the delivered grant. For example, the sidelink grant may be a configured sidelink grant and no MAC PDU may be obtained in a CG period pf the configured sidelink grant (e.g., the MAC PDU may have been acknowledged and/or the HARQ buffer may be flushed or empty). For example, the sidelink grant may be dynamic sidelink grant or a selected sidelink grant and no MAC PDU may have been obtained in the previous sidelink grant (e.g., when PSCCH duration(s) and/or 2nd stage SCI on PSSCH of the previous sidelink grant is not in SL DRX Active time of any destination that has data to be sent).

For a sidelink process associated to a sidelink grant, if all PSCCH duration(s) and PSSCH duration(s) for initial transmission of a MAC PDU of the dynamic sidelink grant or the configured sidelink grant is not in SL DRX Active time of the destination (e.g., any destination) that has data to be sent, the UE may ignore the sidelink grant. Otherwise, e.g., if at least one PSCCH duration(s) and PSSCH duration(s) for initial transmission of a MAC PDU of the dynamic sidelink grant or the configured sidelink grant is in SL DRX Active time of at least one destination that has data to be sent, the UE may obtain the MAC PDU to transmit from the Multiplexing and assembly entity (if any).

If the UE has not obtained a MAC PDU, the UE may flush the HARQ buffer of the associated Sidelink process.

If the UE has obtained a MAC PDU, and/or a HARQ process ID is set for the sidelink grant, the UE may (re-)associated the HARQ process ID corresponding to the sidelink grant to the Sidelink process. There is one-to-one mapping between a HARQ Process ID and a Sidelink process in the MAC entity configured with Sidelink resource allocation mode 1.

The UE may determine Sidelink transmission information of the TB for the source and destination pair of the MAC PDU. The UE may set the Source Layer-1 ID to the 8 LSB of the Source Layer-2 ID of the MAC PDU, and/or set the Destination Layer-1 ID to the 16 LSB of the Destination Layer-2 ID of the MAC PDU, and/or (re-)associate the Sidelink process to a Sidelink process ID. The UE may consider the NDI to have been toggled compared to the value of the previous transmission corresponding to the Sidelink identification information and the Sidelink process ID of the MAC PDU and set the NDI to the toggled value. The UE may set the cast type indicator to one of broadcast, groupcast and unicast as indicated by upper layers. The UE may set the HARQ feedback enabled/disabled indicator to enabled, e.g., if HARQ feedback has been enabled for the MAC PDU, otherwise, the UE may set the HARQ feedback enabled/disabled indicator to disabled. The UE may set the priority to the value of the highest priority of the logical channel(s), if any, and MAC CE(s), if included, in the MAC PDU. The UE may set the Redundancy version to the selected value. The UE may deliver the MAC PDU, the sidelink grant and the Sidelink transmission information of the TB to the associated Sidelink process. The UE may instruct the associated Sidelink process to trigger a new transmission.

The Sidelink process is associated with a HARQ buffer. New transmissions and retransmissions are performed on the resource indicated in the sidelink grant with a selected MCS. The UE determines the priority of a MAC PDU based on the highest priority of the logical channel(s) or MAC CE(s) in the MAC PDU.

If the Sidelink HARQ Entity requests a new transmission, the Sidelink process may store the MAC PDU in the associated HARQ buffer, and/or store the sidelink grant received from the Sidelink HARQ Entity, and/or generate a transmission. If the Sidelink HARQ Entity requests a retransmission, the Sidelink process may store the sidelink grant received from the Sidelink HARQ Entity, and/or generate a transmission. The Sidelink process may instruct the physical layer to transmit SCI according to the stored sidelink grant with the associated Sidelink transmission information; and/or instruct the physical layer to generate a transmission according to the stored sidelink grant. If HARQ feedback has been enabled for the MAC PDU, the UE may instruct the physical layer to monitor PSFCH for the transmission and perform PSFCH reception.

If PUCCH for sidelink (e.g., sl-PUCCH-Config) is configured by RRC for the stored sidelink grant, the UE determines transmission of an acknowledgement on the PUCCH. if a positive acknowledgement to this transmission of the MAC PDU was received on PFSCH, and/or if negative-only acknowledgement was enabled in the SCI and no negative acknowledgement was received for this transmission of the MAC PDU on PSFCH, the UE may flush the HARQ buffer of the associated Sidelink process.

For PDU(s) associated with one SCI, UE may consider only logical channels with the same Source Layer-2 ID-Destination Layer-2 ID pair for one of unicast, groupcast and broadcast which is associated with the pair. The UE may independently perform multiple transmissions for different Sidelink processes in different PSSCH durations.

The UE applies sidelink Logical Channel Prioritization (LCP) procedure whenever a new transmission is performed. The BS may control scheduling of sidelink data for each logical channel by RRC signaling. The RRC parameters may comprise a SL priority for each logical channel (e.g., sl-Priority, where an increasing priority value indicates a lower priority level); and/or a sidelink Prioritized Bit Rate (sPBR) (e.g., by sl-PrioritisedBitRate); and/or a sidelink Bucket Size Duration (sBSD) (e.g., by sl-BucketSizeDuration). For each logical channel, RRC parameters may indicate whether a configured grant Type 1 can be used for sidelink transmission.

For each SCI corresponding to a new transmission, the UE may select a Destination associated to one of unicast, groupcast and broadcast. The destination is in the SL Active time for the SL transmission occasion if SL DRX is applied for the destination. The destination has at least one of the MAC CE and the logical channel with the highest priority, among the logical channels that satisfy some conditions and MAC CE(s), if any, for the SL grant associated to the SCI. For example, SL data is available in the logical channel for transmission. Transmission of SL data from the logical channel is allowed on the grant (e.g., for configured grant). If multiple Destinations have the logical channels satisfying the conditions above with the same highest priority, and/or if multiple Destinations have either the MAC CE and/or the logical channels satisfying the conditions above with the same priority as the MAC CE, which Destination is selected among them is up to UE implementation.

The UE may select the logical channels satisfying some conditions among the logical channels belonging to the selected Destination. For example, SL data is available in the logical channel for transmission, and/or transmission of SL data from the logical channel is allowed on the grant (e.g., for configured grant).

The MAC entity multiplexes MAC CEs and MAC SDUs in a MAC PDU.

The resource allocation unit in the frequency domain may be the sub-channel. The sub-channel assignment for sidelink transmission may be determined using the “Frequency resource assignment” field in the associated SCI. The lowest sub-channel for sidelink transmission may be the sub-channel on which the lowest PRB of the associated PSCCH is transmitted. For example, if a PSSCH scheduled by a PSCCH would overlap with resources containing the PSCCH, the resources corresponding to a union of the PSCCH that scheduled the PSSCH and associated PSCCH DM-RS may not be available for the PSSCH.

The redundancy version for transmitting a TB may be given by the “Redundancy version” field in the 2nd stage SCI (e.g., SCI format 2-A or 2-B). The modulation and coding scheme IMCS may be given by the ‘Modulation and coding scheme’ field in the 1st stage SCI (e.g., SCI format 1-A). The UE may determine the MCS table based on the following: a pre-defined table may be used if no additional MCS table is configured by higher layer parameter sl-MCS-Table; otherwise an MCS table is determined based on the ‘MCS table indicator’ field in the 1st stage SCI (e.g., SCI format 1-A). The UE may use IMCS and the MCS table determined according to the previous step to determine the modulation order (Qm) and Target code rate (R) used in the physical sidelink shared channel.

The UE may determine the TB size (TBS) based on the number of REs (NRE) within the slot. The UE may determine the number of REs allocated for PSSCH within a PRB (N_RE \hat{ }′) by N_RE \hat{ }′=N_sc \hat{ }RB (N_symb \hat{ }sh−N_symb \hat{ }PSFCH)−N_oh \hat{ }PRB-N_RE \hat{ }DMRS, where N_sc \hat{ }RB=12 is the number of subcarriers in a physical resource block; N_symb \hat{ }sh=sl−LengthSymbols-2, where sl-LengthSymbols is the number of sidelink symbols within the slot provided by higher layers; N_symb \hat{ }PSFCH=3 if ‘PSFCH overhead indication’ field of SCI format 1-A indicates “1”, and N_symb \hat{ }PSFCH=0 otherwise, if higher layer parameter sl-PSFCH-Period is 2 or 4. If higher layer parameter sl-PSFCH-Period is 0, N_symb\hat{ }PSFCH=0. If higher layer parameter sl-PSFCH-Period is 1, N_symb \hat{ }PSFCH=3. N_oh \hat{ }PRB is the overhead given by higher layer parameter sl-X-Overhead. N_RE \hat{ }DMRS is given by higher layer parameter sl-PSSCH-DMRS-TimePattern. The UE may determine the total number of REs allocated for PSSCH( ) by N_RE=N_RE\hat{ }′·n_PRB-N_RE\hat{ }(SCI, 1)-N_RE \hat{ }(SCI,2), where nPRB is the total number of allocated PRBs for the PSSCH; N_RE \hat{ }(SCI, 1) is the total number of REs occupied by the PSCCH and PSCCH DM-RS; N_RE \hat{ }(SCI,2) is the number of coded modulation symbols generated for 2nd-stage SCI transmission (prior to duplication for the 2^{nd} layer, if present). The UE may determine the TBS based on the total number of REs allocated for PSSCH( ) and/or the modulation order (Qm) and Target code rate (R) used in the physical sidelink shared channel.

For the single codeword q=0 of a PSSCH, the block of bits b \hat{ }(q)) (0), . . . , b\hat{ }(q)) (M_“bit” \hat{ }(q))−1), where M_“bit” \hat{ }(q)=M_“bit,SCI2” \hat{ }(q)+M_“bit, data” \hat{ }(q) is the number of bits in codeword q transmitted on the physical channel, may be scrambled prior to modulation (e.g., using a scrambling sequence based on a CRC of the PSCCH associated with the PSSCH). For the single codeword q=0, the block of scrambled bits may be modulated, resulting in a block of complex-valued modulation symbols d \hat{ }(q)) (0), . . . , d \hat{ }(q)) (M_“symb” \hat{ }(q))−1) where M_“symb” \hat{ }(q)=M_“symb,1” \hat{ }(q))+M_“symb,2” \hat{ }(q)). Layer mapping may be done with the number of layers u∈{1,2}, resulting in x(i)=[▪(x\hat{ }((0)) (i)& . . . &x\hat{ }(u−1)) (i))]\hat{ }“T”, i=0, 1, . . . , M_“symb” \hat{ }“layer”−1. The block of vectors [=(x \hat{ }(0)) (i)& . . . &x \hat{ }(u−1)) (i))] \hat{ }“T” may be pre-coded where the precoding matrix W equals the identity matrix and M_“symb” \hat{ }“ap”=M_“symb”\hat{ }“layer”. For each of the antenna ports used for transmission of the PSSCH, the block of complex-valued symbols z\hat{ }((p)) (0), . . . , z \hat{ } ((p)) (M_“symb” \hat{ }“ap”−1) may be multiplied with the amplitude scaling factor β_“DMRS”\hat{ }“PSSCH” in order to conform to the transmit power and mapped to resource elements [symbol] (k′,l) [symbol] _(p,μ) in the virtual resource blocks assigned for transmission, where k \hat{ }′=0 is the first subcarrier in the lowest-numbered virtual resource block assigned for transmission. The mapping operation may be done in two steps: first, the complex-valued symbols corresponding to the bit for the 2nd-stage SCI in increasing order of first the index k′ over the assigned virtual resource blocks and then the index I, starting from the first PSSCH symbol carrying an associated DM-RS, wherein the corresponding resource elements in the corresponding physical resource blocks are not used for transmission of the associated DM-RS, PT-RS, or PSCCH; secondly, the complex-valued modulation symbols not corresponding to the 2nd-stage SCI shall be in increasing order of first the index k′ over the assigned virtual resource blocks, and then the index I with the starting position, wherein the resource elements are not used for 2nd-stage SCI in the first step; and/or the corresponding resource elements in the corresponding physical resource blocks are not used for transmission of the associated DM-RS, PT-RS, CSI-RS, or PSCCH.

The resource elements used for the PSSCH in the first OFDM symbol in the mapping operation above, including DM-RS, PT-RS, and/or CSI-RS occurring in the first OFDM symbol, may be duplicated in the OFDM symbol immediately preceding the first OFDM symbol in the mapping (e.g., for AGC training purposes).

Virtual resource blocks may be mapped to physical resource blocks according to non-interleaved mapping. For non-interleaved VRB-to-PRB mapping, virtual resource block n is mapped to physical resource block n.

For a PSCCH, the block of bits b(0), . . . , b(M_“bit”−1), where M_“bit” is the number of bits transmitted on the physical channel, may be scrambled prior to modulation, resulting in a block of scrambled bits b^{~}(0), . . . , b^{~}(M_“bit”−1) according to b^{~}(i)=(b(i)+c(i) “mod” 2. The block of scrambled bits b ^{~}(0), . . . , b^{~}(M_“bit”−1) may be modulated using QPSK, resulting in a block of complex-valued modulation symbols d(0), . . . , d(M_“symb”−1) where M_“symb”=M_“bit”/2. The set of complex-valued modulation symbols d (0), . . . , d(M_“symb”−1) may be multiplied with the amplitude scaling factor β_“DMRS” \hat{ }“PSCCH” in order to conform to the transmit power and mapped in sequence starting with d(0) to resource elements (k,l)_(p,u) assigned for transmission, and not used for the demodulation reference signals associated with PSCCH, in increasing order of first the index k over the assigned physical resources, and then the index I on antenna port p (e.g., p=2000).

The resource elements used for the PSCCH in the first OFDM symbol in the mapping operation above, including DM-RS, PT-RS, and/or CSI-RS occurring in the first OFDM symbol, may be duplicated in the immediately preceding OFDM symbol (e.g., for AGC training purposes).

For sidelink resource allocation mode 1, a UE upon detection of a first SCI (e.g., SCI format 1-A) on PSCCH may decode PSSCH according to the detected second SCI (e.g., SCI formats 2-A and/or 2-B), and associated PSSCH resource configuration configured by higher layers. The UE may not be required to decode more than one PSCCH at each PSCCH resource candidate. For sidelink resource allocation mode 2, a UE upon detection of a first SCI (e.g., SCI format 1-A) on PSCCH may decode PSSCH according to the detected second SCI (e.g., SCI formats 2-A and/or 2-B), and associated PSSCH resource configuration configured by higher layers. The UE may not be required to decode more than one PSCCH at each PSCCH resource candidate. A UE may be required to decode neither the corresponding second SCI (e.g., SCI formats 2-A and/or 2-B) nor the PSSCH associated with a first SCI (e.g., SCI format 1-A) if the first SCI indicates an MCS table that the UE does not support.

Throughout this disclosure, a (sub) set of symbols of a slot, associated with a resource pool of a sidelink BWP, that is (pre-) configured for sidelink communication (e.g., transmission and/or reception) may be referred to as ‘sidelink symbols’ of the slot. The sidelink symbols may be contiguous/consecutive symbols of a slot. The sidelink symbols may start from a sidelink starting symbol (e.g., indicated by an RRC parameter), e.g., sidelink starting symbol may be symbol #0 or symbol #1, and so on. The sidelink symbols may comprise one or more symbols of the slot, wherein a parameter (e.g., indicated by RRC) may indicate the number of sidelink symbols of the slot. The sidelink symbols may comprise one or more guard symbols, e.g., to provide a time gap for the UE to switch from a transmission mode to a reception mode. For example, the OFDM symbol immediately following the last symbol used for PSSCH, PSFCH, and/or S-SSB may serve as a guard symbol. As shown in FIG. 19, the sidelink symbols may comprise one or more PSCCH resources/occasions and/or one or more PSCCH resources and/or zero or more PSFCH resources/occasions. The sidelink symbols may comprise one or more AGC symbols.

An AGC symbol may comprise duplication of (content of) the resource elements of the immediately succeeding/following symbol (e.g., a TB and/or SCI may be mapped to the immediately succeeding symbol). In an example, the AGC symbol may be a dummy OFDM symbol. In an example, the AGC symbol may comprise a reference signal. For example, the first OFDM symbol of a PSSCH and its associated PSCCH may be duplicated (e.g., in the AGC symbol that is immediately before the first OFDM symbol of the PSSCH). For example, the first OFDM symbol of a PSFCH may be duplicated (e.g., for AGC training purposes).

In a sidelink slot structure configuration, the first symbol is used for automatic gain control (AGC) and the last symbol is used for a gap. During an AGC symbol, a receiving and/or sensing UE may perform AGC training. For AGC training, a UE detects the energy/power of a signal in the channel during the AGC symbol and applies a hardware gain to maximize the signal amplitude to the dynamic range of the analog to digital convertor (ADC) at the receiver. The receiver may determine a gain for a received signal, and an AGC duration allows time for the receiver to determine the gain and apply the gain (e.g., hardware gain component) such that when the receiver receives the data (e.g., in the next symbol(s), the gain of the amplifier has already been adjusted.

For sidelink communication, the transmitter UE may not map data/control information to the AGC symbol. The AGC symbol may not be used for communication and sending information other than energy. The AGC symbol may be a last symbol prior to an earliest symbol of a transmission, such that a gap between AGC symbol and signal/channel transmission is minimized and an accurate gain is determined for receiving the following signal/channel. For example, the AGC symbol, as shown in FIG. 19, maybe a symbol immediately preceding the first/earliest symbol of a resource used for a transmission via a channel (e.g., PSCCH and/or PSSCH and/or PSFCH transmission).

In an example, the AGC symbol may comprise duplication of resource elements of the next (immediately following) OFDM symbol. In an example, the AGC symbol may comprise any signal, e.g., a per-defined signal/sequence and/or dummy information. The purpose of the AGC symbol is to allow the receiver UE to perform AGC training and adjust the hardware gain for a most efficient reception of the following signal.

Throughout this disclosure, the “AGC symbol” may be referred to as “duplicated symbol” and/or “duplication” and/or “the symbol used for duplication” and/or “the immediately preceding symbol comprising the duplication of a first symbol”.

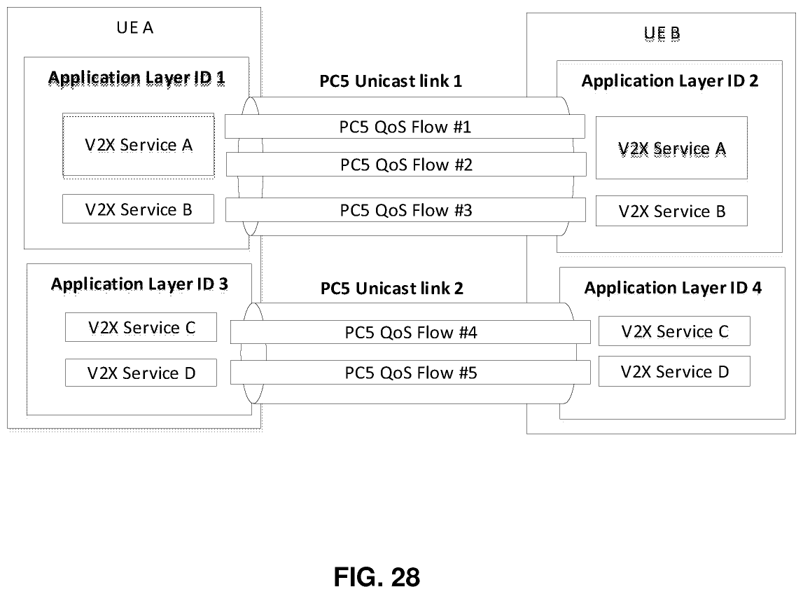

FIG. 28 shows an example of PC5 unicast links. A unicast mode of operation/communication may be supported over NR based PC5 reference point. In this example, two wireless devices are illustrated: UE A and UE B. Each wireless device (UE) supports one or more sidelink services, e.g., V2X Service A, V2X Service B, V2X Service C, and V2X Service D. The two wireless devices may communicate traffic of a peer sidelink/V2X service with each other. Sidelink/V2X communication may be carried over a PC5 link, e.g., a PC5 unicast link. A PC5 unicast link between two UEs allows V2X communication between one or more pairs of peer V2X services in these UEs. In the example of FIG. 28, a first PC5 unicast link (PC5 unicast link 1) allows V2X communication between a first pair of V2X Service A in UE A and UE B, and a second pair of V2X Service B in UE A and UE B, and a second PC5 unicast link (PC5 unicast link 2) allows V2X communication between a third pair of V2X Service C in UE A and UE B, and a fourth pair of V2X Service D in UE A and UE B.

In an example, V2X services in a UE using the same PC5 unicast link use the same Application Layer ID. In the example of FIG. 28, in UE A, V2X Service A and V2X Service B use the same PC5 unicast link 1, and they both use the same Application Layer ID 1, V2X Service C and V2X Service D use the same PC5 unicast link 2, and they both use the same Application Layer ID 3. In UE B, V2X Service A and V2X Service B use the same PC5 unicast link 1, and they both use the same Application Layer ID 2, V2X Service C and V2X Service D use the same PC5 unicast link 2, and they both use the same Application Layer ID 4.

One PC5 unicast link may support one or more V2X service types. For example, the V2X service types using the same PC5 unicast link may be at least associated with the pair of peer Application Layer IDs for this PC5 unicast link. For example, as illustrated in FIG. 28, UE A and UE B have two PC5 unicast links, one between peer Application Layer ID 1/UE A and Application Layer ID 2/UE B and one between peer Application Layer ID 3/UE A and Application Layer ID 4/UE B.

In an example, a source UE may not be required to know whether different target Application Layer IDs over different PC5 unicast links belong to the same target UE/wireless device.

A PC5 unicast link may support V2X communication using a single network layer protocol e.g., IP or non-IP. A PC5 unicast link may support per-flow QoS model. If multiple V2X service types use a PC5 unicast link, one PC5 QoS Flow identified by PFI may be associated with more than one V2X service types.

The Application layer in a UE may initiate data transfer for a V2X service type which requires unicast mode of communication over PC5 reference point. In an example, the UE may reuse an existing PC5 unicast link if the pair of peer Application Layer IDs and the network layer protocol of this PC5 unicast link are identical to those required by the application layer in the UE for this V2X service, and modify the existing PC5 unicast link to add this V2X service type. In an example, the UE may trigger the establishment of a new PC5 unicast link.

To perform unicast mode of V2X communication over PC5 reference point, the UE may be configured with the related information. For example, the UE may receive one or more RRC messages (e.g., SIB12 and/or sidelink RRC Reconfiguration message) from a base station or a second UE comprising the information related to the unicast mode of V2X communication.

The link establishment (e.g., layer-2 link establishment) procedure for unicast mode of V2X communication over PC5 reference point may be as follows. One or more second UEs (e.g., UE-2 and/or UE-3 and/or UE-4, etc.) may determine the destination Layer-2 ID for signaling reception for PC5 unicast link establishment. The destination Layer-2 ID may be configured with the one or more second UEs. The V2X application layer in a first UE (e.g., UE-1) may provide application information for PC5 unicast communication. The application information may include the V2X service type(s) and the initiating UE's (e.g., the first UE, UE-1) Application Layer ID. The target UE's Application Layer ID may be included in the application information. The V2X application layer in the first UE may provide V2X Application Requirements for this unicast communication. The first UE may determine the PC5 QoS parameters and PFI. If the first UE decides to reuse the existing PC5 unicast link, the first UE triggers Layer-2 link modification procedure. The first UE may send a Direct Communication Request (DCR) message to initiate the unicast layer-2 link establishment procedure. The Direct Communication Request message may include one or more of the followings: Source User Info: the initiating UE's (the first UE) Application Layer ID (e.g., UE-1's Application Layer ID); Target User Info (e.g., if the V2X application layer provided the target UE's Application Layer ID): the target UE's Application Layer ID (e.g., the one or more second UEs, or UE-2's Application Layer ID); V2X Service Info: the information about V2X service type(s) requesting Layer-2 link establishment; and/or Security Information: the information for the establishment of security. The destination Layer-2 ID may be broadcast or unicast Layer-2 ID. When unicast Layer-2 ID is used, the Target User Info may be included in the Direct Communication Request message.

The first UE (UE-1) may send the Direct Communication Request message via PC5 broadcast or unicast using the source Layer-2 ID and the destination Layer-2 ID. For transmitting and receiving the Direct Communication Request message, a default PC5 DRX configuration is used when the PC5 DRX operation is needed, e.g., based on the NR Tx Profile.

UEs may determine the source Layer-2 ID and the destination Layer-2 ID used to send the Direct Communication Request message. Source Layer-2 IDs may (always) be self-assigned by the UE originating the corresponding layer-2 frames. The selection of the source and destination Layer-2 ID(s) by a UE may depend on the communication mode of V2X communication over PC5 reference point for this layer-2 link. For unicast mode of V2X communication over PC5 reference point, the destination Layer-2 ID used may depend on the communication peer. The Layer-2 ID of the communication peer, identified by the Application Layer ID, may be discovered during the establishment of the PC5 unicast link, or known to the UE via prior V2X communications, e.g., existing or prior unicast link to the same Application Layer ID, or obtained from application layer service announcements. The initial signaling for the establishment of the PC5 unicast link may use the known Layer-2 ID of the communication peer, or a default destination Layer-2 ID associated with the V2X service type configured for PC5 unicast link establishment. During the PC5 unicast link establishment procedure, Layer-2 IDs may be exchanged, and may be used for future communication between the two UEs.

An Application Layer ID may be associated with one or more V2X applications within A UE. If UE has more than one Application Layer IDs, each Application Layer ID of the same UE may be seen as different UE's Application Layer ID from the peer UE's perspective. The UE may maintain a mapping between the Application Layer IDs and the source Layer-2 IDs used for the PC5 unicast links, as the V2X application layer does not use the Layer-2 IDs. This allows the change of source Layer-2 ID without interrupting the V2X applications. When Application Layer IDs change, the source Layer-2 ID(s) of the PC5 unicast link(s) may be changed if the link(s) was used for V2X communication with the changed Application Layer IDs. Based on privacy configuration, the update of the new identifiers of a source UE to the peer UE for the established unicast link may cause the peer UE to change its Layer-2 ID and optionally IP address/prefix if IP communication is used. A UE may establish multiple PC5 unicast links with a peer UE and use the same or different source Layer-2 IDs for these PC5 unicast links.

The first UE (UE-1) may send the Direct Communication Request message via PC5 broadcast or unicast using the source Layer-2 ID and the destination Layer-2 ID. The first UE may determine the source Layer-2 ID used for the security establishment procedure. The one or more second UEs may set the destination Layer-2 ID of the first UE to the source Layer-2 ID of the received Direct Communication Request message. Upon receiving the security establishment procedure messages, the first UE may obtain the peer UE's Layer-2 ID for future communication, for signaling and data traffic for this unicast link.

The one or more second/target UEs that have successfully established security with the first UE may send a Direct Communication Accept (DCA) message. The V2X layer of the UE that established PC5 unicast link (the first UE, UE-1, or the initiator UE) may pass the PC5 Link Identifier assigned for the unicast link and the PC5 unicast link related information down to the AS layer. The PC5 unicast link related information may include Layer-2 ID information (e.g., source Layer-2 ID and destination Layer-2 ID) and the corresponding PC5 QoS parameters. This enables the AS layer to maintain the PC5 Link Identifier together with the PC5 unicast link related information.

The UEs may transmit V2X service data over the established unicast link as below: The PC5 Link Identifier, and PFI are provided to the AS layer, together with the V2X service data. Optionally in addition, the Layer-2 ID information (e.g., source Layer-2 ID and destination Layer-2 ID) may be provided to the AS layer. It may be up to UE implementation to provide the Layer-2 ID information to the AS layer. The first UE (UE-1) may send the V2X service data using the source Layer-2 ID (e.g., UE-1's Layer-2 ID for this unicast link) and the destination Layer-2 ID (e.g., the peer UE's Layer-2 ID for this unicast link). PC5 unicast link is bi-directional, therefore the peer UE of UE-1 may send the V2X service data to UE-1 over the unicast link with UE-1.

Referring to FIG. 28, after successful PC5 unicast link establishment, UE A and UE B may use the same pair of Layer-2 IDs for subsequent PC5-S signaling message exchange and V2X service data transmission. The V2X layer of the transmitting UE may indicate to the AS layer whether a transmission is for a PC5-S signaling message (e.g., Direct Communication Request/Accept, Link Identifier Update Request/Response/Ack, Disconnect Request/Response, Link Modification Request/Accept, Keep-alive/Ack) and/or V2X service data.

For every PC5 unicast link, a UE may self-assign a distinct PC5 Link Identifier that uniquely identifies the PC5 unicast link in the UE for the lifetime of the PC5 unicast link. Each PC5 unicast link may be associated with a Unicast Link Profile which includes: Application Layer ID and Layer-2 ID of UE A; Application Layer ID and Layer-2 ID of UE B; network layer protocol used on the PC5 unicast link; and/or the information about PC5 QoS Flow(s).

A first UE may transmit an RRC message (e.g., Sidelink RRC reconfiguration, RRCReconfigurationSidelink) to a second UE to modify a PC5-RRC connection, e.g., to establish/modify/release sidelink DRBs and/or PC5 Relay RLC channels, to (re-)configure NR sidelink measurement and reporting, to (re-)configure sidelink CSI reference signal resources, to (re) configure CSI reporting latency bound, to (re) configure sidelink DRX, and/or to (re-)configure the latency bound of SL Inter-UE coordination report. The UE may initiate the sidelink RRC reconfiguration procedure and perform the operation on the corresponding PC5-RRC connection. For example, the UE may initiate the sidelink RRC reconfiguration procedure for (re-)configuration of the peer UE to perform NR sidelink measurement and report. For example, the UE may initiate the sidelink RRC reconfiguration procedure for (re-) configuration of the sidelink CSI reference signal resources and CSI reporting latency bound. For example, the UE may initiate the sidelink RRC reconfiguration procedure for (re-)configuration of the peer UE to perform sidelink DRX. For example, the UE may initiate the sidelink RRC reconfiguration procedure for (re-) configuration of beam management of the peer UE, e.g., to perform beam sweeping and/or trigger beam measurement and/or request beam report.

In RRC_CONNECTED, the UE may apply the NR sidelink communications parameters provided in RRCReconfiguration (if any). In RRC_IDLE or RRC_INACTIVE, the UE may apply the NR sidelink communications parameters provided in system information (if any).

The first UE may set the contents of RRCReconfigurationSidelink message. For example, the first UE may set the sidelink CSI-RS configuration (e.g., sl-CSI-RS-Config). For example, the sidelink CSI-RS may comprise configuration parameters indicating periodicity and/or time/frequency resources for transmission of the CSI-RS, e.g., a number and/or location of symbols in a slot, a number and location of resource block or PRBs in the resource pool, etc. For example, the first UE may set a parameter indicating a latency bound for reception of the CSI report (e.g., sl-LatencyBoundCSI-Report). In an example, whether/how to set the parameters included in sl-CSI-RS-Config, sl-LatencyBoundCSI-Report and sl-ResetConfig is up to UE implementation.

A UE may receive a sidelink system information block (e.g., SIB12) from a base station and/or a second UE. The sidelink SIB may comprise a parameter (e.g., sl-CSI-Acquisition) indicating whether CSI reporting is enabled in sidelink unicast or not. For example, if the parameter is not set, SL CSI reporting may be disabled. In an example, the parameter may indicate whether beam management and/or beam sweeping (e.g., Tx beam sweeping and/or Rx beam sweeping) is enabled or not. In an example, the SIB may comprise a second parameter indicating whether the beam management and/or beam sweeping (e.g., Tx beam sweeping and/or Rx beam sweeping) is enabled or not.

Sidelink supports SL DRX for unicast, groupcast, and broadcast. SL DRX parameters (e.g., on-duration, inactivity-timer, retransmission-timer, cycle) may be defined/configured for SL to determine the SL active time for SL DRX. During the SL active time, the UE may perform SCI monitoring for data reception (e.g., PSCCH and 2nd stage SCI on PSSCH). The UE may skip monitoring of SCI for data reception during SL DRX inactive time.

The SL active time of the RX UE may include the time in which any/at least one of its applicable SL on-duration timer(s), SL inactivity-timer(s) and/or SL retransmission timer(s) (for any of unicast, groupcast, or broadcast) are running. For example, one or more slots associated with announced periodic transmissions by the TX UE and the time in which a UE is expecting CSI report following a CSI request (for unicast) are considered as SL active time of the RX UE. The time for the unicast link establishment procedure and the time for the PC5 RRC reconfiguration with initial SL DRX configuration procedure are considered as SL active time of the RX UE.

The TX UE may maintain a set of timers corresponding to the SL DRX timers in the RX UE(s) for each pair of source/destination L2 ID for unicast or destination L2 ID for groupcast/broadcast. When data is available for transmission to one or more RX UE(s) configured with SL DRX, the TX UE may select resources taking into account the active time of the RX UE(s) determined by the timers maintained at the TX UE.

The UE may determine from SIB12 whether the gNB supports SL DRX or not.

For unicast, SL DRX may be configured per pair of source and destination (e.g., source L2 ID and destination L2 ID).

The UE may maintain a set of SL DRX timers for each direction per pair of source L2 ID and destination L2 ID. The SL DRX configuration for a pair of source/destination L2 IDs for a direction may be negotiated between the UEs, e.g., in the AS layer. For SL DRX configuration of each direction, one UE is the TX UE and the other is the RX UE. The RX UE may send assistance information, which includes its desired SL on-duration timer, SL DRX start offset, and SL DRX cycle, to the TX UE. The mode 2 TX UE may use the assistance information to determine the SL DRX configuration for the RX UE. The TX UE (e.g., in RRC_IDLE/RRC_INACTIVE/OOC, or in RRC_CONNECTED) using mode 2 resource allocation, may determine the SL DRX Configuration for the RX UE, e.g., regardless of whether assistance information is provided or not. For a TX UE in RRC_CONNECTED and using mode 1 resource allocation, the SL DRX configuration for the RX UE may be determined by the serving gNB of the TX UE. The TX UE may send the SL DRX configuration to be used by the RX UE to the RX UE. The RX UE may accept or reject the SL DRX configuration.

When the TX UE is in RRC_CONNECTED and using mode 1 resource allocation, the TX UE may report the received assistance information or the received SL DRX configuration reject information to its serving gNB supporting SL DRX. The Tx UE may send the SL DRX configuration to the RX UE, e.g., upon receiving the SL DRX configuration in dedicated RRC signaling from the gNB. When the RX UE is in RRC_CONNECTED and using mode 1 resource allocation, the RX UE may report the received SL DRX configuration to its serving gNB supporting SL DRX, e.g. for alignment of the Uu and SL DRX configurations.

SL on-duration timer, SL inactivity-timer, SL HARQ RTT timer, and SL HARQ retransmission timer may be supported/configured in unicast. SL HARQ RTT timer and SL HARQ retransmission timer may be maintained per SL process at the RX UE. In addition to (pre) configured values for each of these timers, SL HARQ RTT timer value may be derived from the retransmission resource timing when SCI indicates more than one transmission resource. SL HARQ RTT timer may be set to different values to support both HARQ enabled and HARQ disabled transmissions.

SL DRX MAC CE may be used for SL DRX operation in unicast, e.g., only in unicast.

For groupcast/broadcast, SL DRX may be configured commonly among multiple UEs, e.g., based on QoS profile and/or Destination L2 ID. Multiple SL DRX configurations may be supported for each of groupcast and broadcast.

SL on-duration timer, SL inactivity-timer, SL HARQ RTT and SL retransmission timers may be supported/configured for groupcast. Only SL on-duration timer may be supported/configured for broadcast. SL DRX cycle, SL on-duration, and SL inactivity timer (only for groupcast) may be configured per QoS profile. The starting offset and slot offset of the SL DRX cycle may be determined based on the destination L2 ID. The SL HARQ RTT timer (only for groupcast) and SL HARQ retransmission timer (only for groupcast) may not be configured per QoS profile or per destination L2 ID. For groupcast, the RX UE may maintain a SL inactivity timer for each destination L2 ID, and select the largest SL inactivity timer value, e.g., if multiple SL inactivity timer values associated with different QoS profiles are configured for that L2 ID. For groupcast and broadcast, the RX UE may maintain a single SL DRX cycle (e.g., selected as the smallest SL DRX cycle of any QoS profile of that L2 ID) and single SL on-duration (e.g., selected as the largest SL on-duration of any QoS profile of that L2 ID) for each destination L2 ID, e.g., when multiple QoS profiles are configured for that L2 ID.

For groupcast, SL HARQ RTT timer and SL retransmission timer may be maintained per SL process at the RX UE. SL HARQ RTT timer may be set to different values to support both HARQ enabled and HARQ disabled transmissions.

A default SL DRX configuration, common between groupcast and broadcast, may be used/configured for a QoS profile which is not mapped onto any non-default SL DRX configuration(s). The default SL DRX configuration for groupcast and broadcast may be used for discovery message in sidelink discovery and/or relay discovery messages and/or for Direct Link Establishment Request message.

In-coverage TX UEs and RX UEs in RRC_IDLE/RRC_INACTIVE may obtain their SL DRX configuration from SIB (e.g., SIB12). UEs (TX and/or RX) in RRC_CONNECTED may obtain the SL DRX configuration from SIB (e.g., SIB12), and/or from dedicated RRC signaling during handover (e.g., RRC reconfiguration message). For the out of coverage case, the UE may obtain SL DRX configuration from pre-configuration.

For groupcast, the TX UE may restart its timer corresponding to the SL inactivity timer for the destination L2 ID (used for determining the allowable transmission time) upon reception of new data with the same destination L2 ID.

TX profile may be used to ensure compatibility for groupcast and broadcast communication between UEs supporting/not-supporting SL DRX functionality. A TX profile is provided by upper layers to AS layer and identifies one or more sidelink feature group(s). Multiple TX profiles with the support of SL DRX and without the support of SL DRX can be associated to a destination L2 ID. For a given destination L2 ID, all TX and RX UEs may be configured with the same set of TX profile(s). A UE assumes SL DRX for the given destination L2 ID when the associated TX profiles correspond to support of SL DRX. A UE assumes no SL DRX for the given destination L2 ID if there is no associated TX profile. An RX UE determines that SL DRX is used if all destination L2 IDs of interest are assumed to support SL DRX. For groupcast, when the UE is in RRC_CONNECTED and using mode 1 resource allocation, the UE reports each destination L2 ID and associated SL DRX on/off indication to the gNB supporting SL DRX.

Alignment of Uu DRX and SL DRX for a UE in RRC_CONNECTED is supported for unicast, groupcast, and broadcast. Alignment of Uu DRX and SL DRX at the same UE is supported. In addition, for mode 1 scheduling, the alignment of Uu DRX of the TX UE and SL DRX of the RX UE is supported. Alignment may comprise of either full overlap and/or partial overlap in time between Uu DRX and SL DRX. For SL RX UEs in RRC_CONNECTED, alignment is achieved by the gNB.

A transmitting wireless device may select, among a plurality of destinations (e.g., among a plurality of receiving wireless devices), a destination (e.g., a receiving wireless device) for SL transmission. For example, the transmitting wireless device may schedule the SL transmission using a grant received from a base station (e.g., mode 1). For example, the grant from the base station may not be associated with a particular destination of a SL transmission. For example, the grant may not comprise a destination ID (e.g., identifier of a receiving wireless device and/or a group identifier of one or more receiving wireless device) of the SL transmission. The transmitting wireless device may select the destination for the SL transmission, e.g., after or in response to receiving the grant from the base station. The transmitting wireless device may determine active time (e.g., DRX active time) of the destination/RX UE when a SL DRX operation is configured. For example, the active time comprises one or more times (e.g., time duration, time interval, time window and/or the like). For example, the transmitting wireless device may select the first destination to transmit, via and/or using the grant (e.g., and/or a respective SL grant) a respective SCI and/or a transport block. The selecting the first destination may be in response to a time domain resource allocation indicated by the grant (e.g., and/or the respective SL grant) being in the SL DRX active time of the first destination. For example, the transmitting wireless device may not select the second destination to transmit, via and/or using the grant (e.g., and/or a respective SL grant), a respective SCI and/or a transport block, e.g., in response to the time domain resource allocation indicated by the grant (e.g., and/or the respective SL grant) being outside the SL DRX active time of the second destination. For example, the transmitting wireless device may select the second destination to transmit, via and/or using the grant (e.g., and/or a respective SL grant), a respective SCI and/or a transport block. The selecting the second destination may be in response to a time domain resource allocation indicated by the grant (e.g., and/or the respective SL grant) being in the SL DRX active time of the second destination. For example, the transmitting wireless device may not select the first destination to transmit, via and/or using the grant (e.g., and/or a respective SL grant), a respective SCI and/or a transport block, e.g., in response to the time domain resource allocation indicated by the grant (e.g., and/or the respective SL grant) being outside the SL DRX active time of the first destination.

In the example embodiment(s) of the presence disclosure, a grant (e.g., DCI format 3_0) that the transmitting wireless device receives, e.g., via a Uu interface, from a base station may be referred to as an SL grant (e.g., a first-stage SCI and/or a second-stage SCI) that the transmitting wireless device transmits, for SL transmission, to the receiving wireless device. For example, example embodiment(s) of the presence disclosure may refer the grant as the SL grant, e.g., if the transmitting wireless device determines one or more first field values of the SL grant based on one or more second fields of the grant. For example, the one or more first field values indicate at least one of: a value of a priority of the SL transmission, a frequency resource assignment of the SL transmission (e.g., PSSCH), a time resource assignment of the SL transmission (e.g. PSSCH), a resource reservation period, a DMRS pattern of the PSSCH, a second-stage SCI format, a value of a Beta_offset indicator, a value of a number of DMRS port for SL transmission (e.g., PSSCH), a modulation and coding scheme of the SL transmission (e.g., PSSCH), a value of PSFCH overhead indication, a value of HARQ process number for the SL transmission (e.g., an SL TB of PSSCH), a value of new data indicator, a redundancy version of the SL transmission (e.g., an SL TB of PSSCH), a source ID (e.g., Source Layer-1 ID and/or Source Layer-2 ID) of the transmitting wireless device, a destination ID (e.g., Destination Layer-1 ID and/or Destination Layer-2 ID) of the receiving wireless device, a value of HARQ feedback enabled/disabled indicator indicating whether a HARQ feedback of the SL transmission (e.g., an SL TB of PSSCH) is enabled or disabled, a value of a cast type indicator, an indication of a CSI request, and/or a zone identifier. For example, the one or more second values may indicate at least one of: a resource pool index indicating the number of resource pools for transmission configured by the higher layer parameter (e.g., sl-TxPoolScheduling), a time gap, a HARQ process number (e.g., of the SL transmission), a new data indicator indicating whether the SL transmission of the HARQ process number is a new transmission or a retransmission, a lowest index of the subchannel allocation to the initial transmission (e.g., SL transmission), a value of a frequency resource assignment field of SL grant (e.g., SCI format 1-A), a value of a time resource assignment field of SL grant (e.g., SCI format 1-A), a value of a PSFCH-to-HARQ feedback timing indicator indicating a PSFCH resource for a PSFCH transmission with HARQ-ACK information in response to a PSSCH transmission or reception, a value of PUCCH resource indicator indicating a PUCCH resource to transmit HARQ-ACK information to the base station for a PSSCH transmission with HARQ-ACK information in response to a PSSCH transmission, a value of configuration index, a value of a counter sidelink assignment index.

For example, a transmitting wireless device configured (e.g., selecting) the sidelink resource allocation mode 2 may determine an SL grant based on configuration parameters associated with the sidelink resource allocation mode 2. For example, the transmitting wireless device configured (e.g., selecting) the sidelink resource allocation mode 2 may determine the SL grant without receiving a grant from a base station. The transmitting wireless device may select, among a plurality of destinations (e.g., among a plurality of receiving wireless devices), a destination (e.g., a receiving wireless device) for SL transmission. For example, the transmitting wireless device may determine one or more field values of the SL grant. For example, the transmitting wireless device may determine a destination ID (e.g., identifier of a receiving wireless device and/or a group identifier of one or more receiving wireless device) of the SL grant for the SL transmission. A transmitting wireless device may determine active time (e.g., DRX active time) of a particular destination, e.g., if the transmitting wireless device transmits configuration parameters of SL DRX operation to the particular destination. For example, the active time comprises one or more times (e.g., time duration, time interval, time window and/or the like). For example, the transmitting wireless device may select the first destination to transmit, via and/or using the SL grant a respective SCI and/or a transport block. The selecting the first destination may be in response to a time domain resource allocation indicated by the SL grant being in the SL DRX active time of the first destination. For example, the transmitting wireless device may not select the second destination to transmit, via and/or using the SL grant, a respective SCI and/or a transport block, e.g., in response to the time domain resource allocation indicated by the SL grant being outside the SL DRX active time of the second destination. For example, the transmitting wireless device may select the second destination to transmit, via and/or using the SL grant, a respective SCI and/or a transport block. The selecting the second destination may be in response to a time domain resource allocation indicated by the SL grant being in the SL DRX active time of the second destination. For example, the transmitting wireless device may not select the first destination to transmit, via and/or using the SL grant, a respective SCI and/or a transport block, e.g., in response to the time domain resource allocation indicated by the SL grant being outside the SL DRX active time of the first destination.

For example, the transmitting wireless device may transmit to the receiving wireless device and/or via a PSCCH, the first-stage SCI (e.g., the SL grant and/or SCI format 1-A). For example, the first-stage SCI may comprise scheduling information of PSSCH. The PSSCH may comprise the second-stage SCI and/or a sidelink transport block (TB) (e.g., SL-SCH) of the SL transmission. For example, the transmitting wireless device may transmit to the receiving wireless device and/or via the PSSCH, the second-stage SCI (e.g., the sidelink grant, SCI format 2-A, SCI format 2-B, and/or SCI format 2-C) in which one or more field values are determined based on the grant received from the base station. For example, the transmitting wireless device may transmit to the receiving wireless device and/or via the PSSCH, the sidelink TB (e.g., SL-SCH) of the SL transmission.

A wireless device may receive, from a base station, configuration parameters of SL sensing operation of the wireless device, e.g., for an SL resource allocation mode 2 operation. The configuration parameters may indicate a starting time of an SL sensing window, a duration (e.g., size, and/or length) of an SL sensing window, and/or a periodicity of an SL sensing window. The wireless device may monitor one or more time slots during the sidelink sensing window to determine whether SL resources associated with the one or more time slots are available or not for an SL transmission. During the SL sensing window of the wireless device, the wireless device may monitor, decode, and/or receive an SL grant on PSCCH (e.g., first-stage SCI) and performs Reference Signal Received Power (RSRP) measurements for its own sidelink transmission. The wireless device may perform sensing operation outside of an SL DRX active time and/or within the SL DRX active time of SL DRX.

A wireless device (e.g., an MAC entity of the wireless device) may be configured by RRC (e.g., RRC layer of the wireless device) with a DRX functionality. For example, the wireless device may receive one or more messages comprising one or more configuration parameters of the DRX operation (e.g., the DRX functionality). For example, the one or more messages may comprise at least one of following: RRC message, RRC reconfiguration message, and/or broadcast/multicast message, PC5 RRC message, and/or PC5 RRC reconfiguration message. For example, DRX functionality controls the UE's PDCCH monitoring activity for the MAC entity's one or more RNTIs. For example, the one or more RNTIs comprise at least one of following: C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, and AI-RNTI, and/or one or more RNTIs associated with the SL transmission/reception. For example, the one or more RNTIs associated with the SL transmission/reception may comprise SL-RNTI, SLCS-RNTI and SL Semi-Persistent Scheduling V-RNTI. When using DRX operation, the wireless device may monitor PDCCH, PSFCH, PSCCH, and/or PSSCH according to requirements found in example embodiment(s) of the present specification. The wireless device may receive one or more configuration parameters of the DRX operation. The wireless device may be configured with (e.g., may start) the DRX operation in response to receiving the one or more configuration parameters. The wireless device may monitor the PDCCH, PSFCH, PSCCH, and/or PSSCH discontinuously using the DRX operation, e.g., when in RRC_CONNECTED, if DRX is configured, for all the activated Serving Cells, specified in this clause; otherwise, the wireless device may monitor the PDCCH, PSFCH, PSCCH, and/or PSSCH.

A wireless device may receive message(s) (e.g., RRC message and/or system information). The message(s) may comprise configuration parameters associated with DRX operation. For example, the configuration parameters for the DRX procedure may comprise parameters to control DRX operation. For example, drx-onDurationTimer may indicate the duration at the beginning of a DRX cycle and/or drx-SlotOffset may indicate the delay before starting the drx-onDurationTimer and/or drx-InactivityTimer may indicate the duration after the PDCCH occasion in which a PDCCH indicates a new UL or DL transmission for the MAC entity and/or drx-Retransmission TimerDL may indicate the maximum duration until a DL retransmission is received and/or drx-RetransmissionTimerUL may indicate the maximum duration until a grant for UL retransmission is received and/or drx-LongCycleStartOffset may indicate the Long DRX cycle and drx-StartOffset which defines the subframe where the Long and Short DRX cycle starts and/or drx-ShortCycle may indicate the Short DRX cycle and/or drx-ShortCycleTimer may indicate the duration the UE shall follow the Short DRX cycle and/or drx-HARQ-RTT-TimerDL may indicate the minimum duration before a DL assignment for HARQ retransmission is expected by the MAC entity and/or drx-HARQ-RTT-TimerUL may indicate the minimum duration before a UL HARQ retransmission grant is expected by the MAC entity and/or drx-RetransmissionTimerSL may indicate the maximum duration until a grant for SL retransmission is received and/or drx-HARQ-RTT-TimerSL may indicate the minimum duration before a SL retransmission grant is expected by the MAC entity and/or ps-Wakeup may indicate the configuration to start associated drx-onDurationTimer in case DCP is monitored but not detected and/or ps-TransmitOtherPeriodicCSI may indicate the configuration to report periodic CSI that is not L1-RSRP on PUCCH during the time duration indicated by drx-onDurationTimer in case DCP is configured but associated drx-onDurationTimer is not started and/or ps-TransmitPeriodicL1-RSRP may indicate the configuration to transmit periodic CSI that is L1-RSRP on PUCCH during the time duration indicated by drx-onDurationTimer in case DCP is configured but associated drx-onDurationTimer is not started.

A wireless device may receive, from a base station, one or more messages comprising one or more configuration parameters of the DRX operation for a Uu interface between the base station and the wireless device. The one or more parameters may indicate a plurality of DRX groups (e.g., two DRX groups). The one or more parameters may comprise a plurality of DRX group configuration parameters. Each of the plurality of DRX group configuration parameters may comprise one or more DRX configuration parameters of a respective DRX group of the plurality of DRX groups. For example, each of the plurality of DRX groups is associated with at least one of the plurality of DRX group configuration parameters. For example, one or more configuration parameters indicate which DRX group of the plurality of DRX group is associated with which DRX configuration parameters of the plurality of DRX group configuration parameters. The wireless device may configure only one DRX group and all Serving Cells belong to that one DRX group when RRC does not configure a secondary DRX group. Each Serving Cell is uniquely assigned to either of the two groups when two DRX groups are configured. The wireless device may be separately configured the DRX parameters for each DRX group. For example, drx-onDurationTimer, drx-InactivityTimer. The DRX parameters may be common to the DRX group. For example, drx-SlotOffset, drx-RetransmissionTimerDL, drx-RetransmissionTimerUL, drx-LongCycleStartOffset, drx-ShortCycle (optional), drx-ShortCycleTimer (optional), drx-HARQ-RTT-TimerDL, and drx-HARQ-RTT-TimerUL.

A wireless device may determine Active Time (e.g., DRX active time), e.g., of the Uu interface, for one or more cells in a DRX group, e.g., when DRX operation is configured. For example, the Active time comprises one or more times (e.g., time duration, time interval, time window and/or the like). For example, the one or more times comprise a time while drx-onDurationTimer is running. For example, the one or more times comprise a time while drx-InactivityTimer (e.g., for the DRX group) is running. For example, the one or more times comprise a time while drx-RetransmissionTimerDL and/or drx-RetransmissionTimerUL is running. For example, the one or more times comprise a time while drx-RetransmissionTimerSL (e.g., on any serving cell in the DRX group) is running. For example, the one or more times comprise a time while ra-ContentionResolutionTimer. For example, the wireless device may start ra-ContentionResolutionTimer in response to transmitting Msg 3 1313 (e.g., in FIG. 13A). A wireless device (e.g., an MAC entity of the wireless device) may perform when DRX is configured. For example, a wireless device, e.g., if the wireless device receives a MAC PDU in a configured downlink assignment, may start the drx-HARQ-RTT-TimerDL for the corresponding HARQ process in the first symbol after the end of the corresponding transmission carrying the DL HARQ feedback. For example, a wireless device, e.g., if the wireless device receives a MAC PDU in a configured downlink assignment, may stop the drx-Retransmission TimerDL for the corresponding HARQ process. For example, a wireless device may start the drx-HARQ-RTT-TimerUL for the corresponding HARQ process in the first symbol after the end of the first transmission (within a bundle) of the corresponding PUSCH transmission and/or stop the drx-RetransmissionTimerUL for the corresponding HARQ process at the first transmission (within a bundle) of the corresponding PUSCH transmission. For example, a wireless device starts the drx-RetransmissionTimerUL for the corresponding HARQ process in the first symbol after the expiry of drx-HARQ-RTT-TimerUL. For example, a wireless device may receive a DRX Command MAC CE or a Long DRX Command MAC CE, stop drx-onDurationTimer for each DRX group and/or stop drx-InactivityTimer for each DRX group. For example, a wireless device may start or restart drx-ShortCycleTimer for this DRX group in the first symbol after the expiry of drx-Inactivity Timer and/or use the Short DRX cycle for this DRX group, e.g., if drx-InactivityTimer for a DRX group may expire, and/or if the short DRX cycle is configured. For example, a wireless device may use (e.g., determine to use) the Long DRX cycle for this DRX group, e.g., if drx-InactivityTimer for a DRX group may expire, and/or if the short DRX cycle is configured. For example, a wireless device may start or restart drx-ShortCycleTimer for this DRX group in the first symbol after the expiry of drx-Inactivity Timer, e.g., if the wireless device receives a DRX Command MAC CE and/or if the short DRX cycle is configured. For example, the wireless device may use (e.g., determine to use) the Short DRX cycle for this DRX group, e.g., if the wireless device receives a DRX Command MAC CE and/or if the short DRX cycle is configured. For example, a wireless device may use (e.g., determine to use) the Long DRX cycle for this DRX group, e.g., if the wireless device receives a DRX Command MAC CE and/or if the short DRX cycle is configured. For example, a wireless device may use the Long DRX cycle for this DRX group, e.g., drx-ShortCycleTimer for a DRX group expires. For example, a wireless device may receive a Long DRX Command MAC CE. The wireless device may stop drx-ShortCycleTimer for each DRX group and/or use the Long DRX cycle for each DRX group, e.g., in response to receiving the Long DRX Command MAC CE.

A wireless device (e.g., an MAC entity of the wireless device) may be configured by RRC (e.g., RRC layer of the wireless device) with a sidelink discontinuous reception (SL DRX) functionality. For example, SL DRX functionality controls the UE's SCI (e.g., first-stage SCI and second-stage SCI) monitoring activity for SL unicast, for SL groupcast transmission and SL broadcast transmission. When using SL DRX operation, the wireless device may monitor first-stage SCI and/or second-stage SCI according to requirements found in example embodiment(s) of the present specification. The wireless device may receive message(s) (e.g., RRC message and/or system information). The message(s) may comprise configuration parameters associated with DRX operation. For example, the configuration parameters for the DRX procedure may comprise parameters to control DRX operation. For example, sl-drx-onDurationTimer may indicate the duration at the beginning of a SL DRX cycle and/or drx-SlotOffset may indicate the delay before starting the sl-drx-onDurationTimer and/or sl-drx-InactivityTimer may indicate the duration after the first slot of SCI (e.g., first-stage SCI and second-stage SCI) reception in which a SCI indicates a new SL transmission for the MAC entity and/or sl-drx-RetransmissionTimer may indicate the maximum duration until a SL retransmission is received and/or sl-drx-StartOffset may indicate the (e.g., symbol/slot) where the SL DRX cycle starts and/or sl-drx-Cycle may indicate the Sidelink DRX cycle and/or sl-drx-HARQ-RTT-Timer may indicate the minimum duration before a SL HARQ retransmission is expected by the MAC entity.

A wireless device may determine an SL DRX active time (e.g., SL DRX active time) when a SL DRX operation is configured. For example, the SL DRX active time comprises one or more times (e.g., time duration, time interval, time window and/or the like). For example, the one or more times comprise a time while a sl-drx-onDurationTimer is running. For example, the one or more times comprise a time while a sl-drx-Inactivity Timer is running. For example, the one or more times comprise a time while a sl-drx-RetransmissionTimer is running. For example, the one or more periods comprise a period sl-LatencyBoundCSI-Report configured by RRC in case SL-CSI reporting MAC CE is not received. For example, the one or more times comprise a time while the time between the transmission of the request of SL-CSI reporting and the reception of the SL-SCI reporting MAC CE in case SL-CSI reporting MAC CE is received. Examples of active time in sidelink resource allocation mode 1 and sidelink resource allocation mode 2 are shown in FIGS. 23 and 24, respectively.

In an example, the wireless device may transition from an SL DRX active time to a non-SL DRX active time and/or vice versa. For example, the non-SL DRX active time may refer to a time outside the SL DRX active time. In an example, the wireless device may maintain (e.g., keep and/or continue) an SL DRX active time, e.g., an event (e.g., a condition) determining the SL DRX active time occurs. For example, the event may comprise the wireless device (re-)starting SL DRX timer (e.g., sl-drx-onDurationTimer, sl-drx-InactivityTimer, and/or sl-drx-RetransmissionTimer) during the SL DRX active time according to the example embodiment of the present disclosure.

A wireless device (e.g., an MAC entity of the wireless device) may be configured one or multiple SL DRX configurations. For example, each of the one or multiple SL DRX configurations comprise a respective identifier. The wireless device may use the identifier to identify a particular SL DRX configuration of the one or multiple SL DRX configurations. For example, multiple SL DRX Cycles that are mapped to multiple SL-QoS-Profiles of a Destination Layer-2 ID and interested cast types are associated to groupcast and broadcast. For example, the wireless device may select sl-drx-Cycle whose length of the sl-drx-cycle is the shortest one among multiple SL DRX Cycles that are mapped with multiple SL-QoS-Profiles of Destination Layer-2 ID. A wireless device (e.g., an MAC entity of the wireless device) may be configured with one or multiple SL DRX. A wireless device may (re-)start a sl-drx-HARQ-RTT-Timer during the SL DRX operation. The sl-drx-HARQ-RTT-Timer may be expired. For example, the wireless device may (re-)start the sl-drx-RetransmissionTimer for the corresponding Sidelink process in the first [slot/symbol] after the expiry of sl-drx-HARQ-RTT-Timer, e.g., if the data of the corresponding Sidelink process (e.g., operating according to the example embodiment of the present disclosure) was not successfully decoded for unicast, and/or if the HARQ feedback (i.e., negative acknowledgement) is not transmitted due to UL/SL prioritization. A wireless device (e.g., an MAC entity of the wireless device) may be configured with one or multiple SL DRX configurations. For example, a SL DRX configuration of the one or more multiple SL DRX configuration may indicate a respective SL DRX cycle. For example, the SL DRX cycle may repeat with a periodicity respective to the SL DRX configuration. For example, the wireless device may determine a SL DRX cycle based on a reference formula. For example, the reference formula may be [(reference transmission time interval of subframe number×10)+the subframe number] modulo (sl-drx-Cycle)=sl-drx-StartOffset. For example, the wireless device may start sl-drx-onDurationTimer after sl-drx-SlotOffset from the beginning of the subframe (indicated by the subframe number), e.g., if the reference transmission time interval and the subframe number satisfy [(reference transmission time interval of subframe number×10)+the subframe number] modulo (sl-drx-Cycle)=sl-drx-StartOffset. For example, the reference transmission time interval may comprise a SFN (system frame number). For example, the reference transmission time interval may comprise a DFN (Direct Frame Number). When the wireless device selects GNSS as the synchronization reference source, the DFN, the subframe number within a frame and slot number within a frame used for sidelink communication may be derived from the current UTC time, by the following formulae:

DFN=Floor(0.1*(Tcurrent−Tref−OffsetDFN)mod 1024

SubframeNumber=Floor(Tcurrent−Tref−OffsetDFN)mod 10

SlotNumber=Floor((Tcurrent−Tref−OffsetDFN)*2μ)mod(10*2μ)
Where:
   Tcurrent may be the current UTC time obtained from GNSS. This value may be expressed in milliseconds;
   Tref may be the reference UTC time 00:00:00 on Gregorian calendar date 1 Jan. 1900 (midnight between Thursday, Dec. 31, 1899 and Friday, Jan. 1, 1900). This value may be expressed in milliseconds; and
   OffsetDFN may be the value sl-OffsetDFN if configured, otherwise it may be zero. This value may be expressed in milliseconds.

A wireless device (e.g., an MAC entity of the wireless device) may be configured one or multiple SL DRX configurations. A wireless device may be in SL DRX active time (e.g., DRX active time) when a SL DRX operation is configured. For example, the wireless device may monitor the SCI (i.e., first-stage SCI and second-stage SCI) in the SL DRX active time. The SCI may indicate a new SL transmission. For example, the wireless device may start or restart sl-drx-InactivityTimer for the corresponding Source Layer-1 ID and Destination Layer-1 ID pair, e.g., after the first slot of SCI reception, e.g., if the wireless device may be in SL DRX active time, if the SCI may indicate a new SL transmission, if Source Layer-1 ID of the SCI may be equal to the 8 LSB of the intended Destination Layer-2 ID, if Destination Layer-1 ID of the SCI may be equal to the 8 LSB of the intended Source Layer-2 ID, and/or if the cast type indicator in the SCI may be set to unicast. For example, the wireless device may start or restart sl-drx-Inactivity Timer for the corresponding Destination Layer-1 ID after the first slot of SCI reception, e.g., if the wireless device may be in SL DRX active time, if the SCI may indicate a new SL transmission, if Destination Layer-1 ID of the SCI (i.e., second-stage SCI) is equal to the intended Destination Layer-1 ID, if the cast type indicator in the SCI is set to groupcast. For example, the wireless device may select sl-drx-InactivityTimer whose length of the sl-drx-InactivityTimer is the largest one among multiple SL DRX Inactivity timers that are mapped to multiple SL-QoS-Profiles of Destination Layer-2 ID associated with the Destination Layer-1 ID of the SCI, e.g., if the SCI may indicate a new SL transmission, if Destination Layer-1 ID of the SCI (i.e., second-stage SCI) is equal to the intended Destination Layer-1 ID, if the cast type indicator in the SCI is set to groupcast.

A wireless device (e.g., an MAC entity of the wireless device) may (re-)start the sl-drx-HARQ-RTT-Timer for the corresponding Sidelink process in the first slot after the end of the corresponding transmission carrying the SL HARQ feedback, e.g., if the wireless device may be in SL DRX active time, if the wireless device receives an SCI indicating a SL transmission (e.g., a new SL transmission and/or a SL retransmission), and/or if HARQ feedback is enabled by the SCI and the cast type indicator in the SCI is set to unicast. A wireless device (e.g., an MAC entity of the wireless device) may (re-)start the sl-drx-HARQ-RTT-Timer for the corresponding Sidelink process in the first slot after the end of the corresponding resource carrying the SL HARQ feedback when the SL HARQ feedback is not transmitted due to UL/SL prioritization, e.g., if the wireless device may be in SL DRX active time, if the wireless device receives an SCI indicating a SL transmission (e.g., a new SL transmission and/or a SL retransmission), and/or if HARQ feedback is enabled by the SCI and the cast type indicator in the SCI is set to unicast. A wireless device (e.g., an MAC entity of the wireless device) may start the sl-drx-HARQ-RTT-Timer for the corresponding Sidelink process in the first slot after the end of the corresponding PSFCH transmission carrying the HARQ feedback, e.g., if the wireless device may be in SL DRX active time, if the wireless device receives an SCI indicating a SL transmission (e.g., a new SL transmission and/or a SL retransmission), and/or if HARQ feedback is enabled by the SCI and the cast type indicator in the SCI is set to groupcast and if positive-negative acknowledgement or negative-only acknowledgement is selected. The wireless device may (re-) start the sl-drx-HARQ-RTT-Timer for the corresponding Sidelink process in the first slot after the end of the corresponding PSFCH resource carrying the HARQ feedback when the HARQ feedback is not transmitted due to UL/SL prioritization, e.g., if the wireless device may be in SL DRX active time, if the wireless device receives an SCI indicating a SL transmission (e.g., a new SL transmission and/or a SL retransmission), and/or if HARQ feedback is enabled by the SCI and the cast type indicator in the SCI is set to groupcast and if positive-negative acknowledgement or negative-only acknowledgement is selected. A wireless device (e.g., an MAC entity of the wireless device) may (re-)start the sl-drx-HARQ-RTT-Timer for the corresponding Sidelink process, e.g., if the wireless device may be in SL DRX active time, if the wireless device receives an SCI indicating a SL transmission (e.g., a new SL transmission and/or a SL retransmission), and/or if HARQ feedback has been disabled for the MAC PDU. A wireless device (e.g., an MAC entity of the wireless device) may stop the sl-drx-RetransmissionTimer for the corresponding Sidelink process, e.g., if the wireless device may be in SL DRX active time, if the wireless device receives an SCI indicating a SL transmission (e.g., a new SL transmission and/or a SL retransmission).

A wireless device (e.g., an MAC entity of the wireless device) may stop sl-drx-onDurationTimer for the Source Layer-2 ID and Destination Layer-2 ID pair of a unicast, e.g., if the wireless device receives a SL DRX Command MAC CE is received for the Source Layer-2 ID and Destination Layer-2 ID pair of a unicast. The wireless device may stop sl-drx-InactivityTimer for the Source Layer-2 ID and Destination Layer-2 ID pair of a unicast, e.g., if the wireless device receives a SL DRX Command MAC CE is received for the Source Layer-2 ID and Destination Layer-2 ID pair of a unicast.

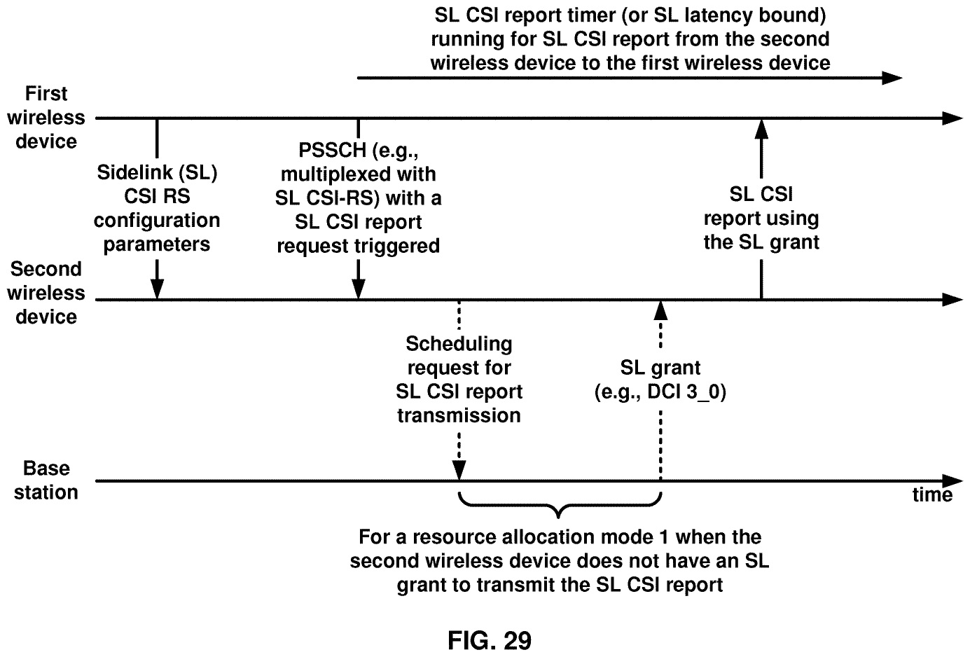

FIG. 29 illustrates an example of sidelink CSI-RS transmission and a sidelink CSI reporting procedure as per an aspect of an example embodiment of the present disclosure. A first wireless device (transmitter UE, Tx UE) may initiate (trigger, perform, run, and/or apply) a sidelink RRC reconfiguration procedure with a second wireless device (receiver UE, Rx UE). Purposes of the sidelink RRC reconfiguration procedure may comprise to indicate (e.g., configure or reconfigure) one or more parameters on sidelink measurement and reporting, to indicate (e.g., configure or reconfigure) sidelink CSI reference signal resources, and/or to indicate (e.g., configure or reconfigure) a CSI reporting latency bound.

For example, referring to FIG. 29, the first wireless device may initiate the sidelink RRC reconfiguration procedure on (e.g., for) a corresponding PC5-RRC connection and/or PC5 link (e.g., established between the first the wireless device and the second wireless device). In an example, in response to or after initiating the sidelink RRC reconfiguration procedure, the first wireless device may transmit a message (e.g., an RRC message, e.g., RRCReconfigurationSidelink) to the second wireless device. For example, the message may comprise one or more parameters, e.g., that comprise SL CSI RS configuration parameters in FIG. 29. The one or more parameters may comprise sl-LatencyBoundCSI-Report (e.g., latency bound in FIG. 29). sl-LatencyBoundCSI-Report (e.g., sidelink latency bound in FIG. 29) may indicate the SL CSI reporting latency bound. The one or more parameters included in the message may comprise, for SL CSI-RS transmission (and/or reception), a time resource allocation and/or time resource offset (e.g., sl-CSI-RS-FirstSymbol) indicating a first OFDM symbol in a PRB used for (e.g., that carries, if/when sidelink CSI reporting is triggered) SL CSI-RS; and/or a frequency resource allocation and/or frequency resource offset (e.g., sl-CSI-RS-FreqAllocation) indicating the number of antenna ports and/or the frequency domain allocation for (e.g., indicating frequency radio resource(s) that carries, if/when CSI reporting is triggered) SL CSI-RS. The time resource allocation and/or the time resource offset may start from a reference symbol in a slot where the wireless device receives SCI indicating a SL CSI-RS report/request. For example, the reference symbol may be a first symbol of the slot, a first symbol of PSCCH transmission in the slot, a first symbol of PSSCH transmission in the slot. The frequency resource allocation, and/or the frequency resource offset may start from a reference PRB (or RB or subchannel) in a slot where the wireless device receives the SCI indicating the SL CSI-RS report. For example, the reference PRB (or RB) may be a lowest PRB (or RB) of (e.g., carrying) the PSSCH and/or PSCCH transmission in a frequency domain. For example, the reference subchannel may be a lowest subchannel of (e.g., carrying) the PSSCH/PSCCH transmission in a frequency domain. For example, the reference PRB (or RB) may be a lowest PRB (or RB) of a lowest subchannel of (e.g., carrying) the PSSCH/PSCCH transmission in a frequency domain.

In an example, referring to FIG. 29, the first wireless device may transmit, via a slot (e.g., a single slot) a sidelink transmission comprising SCI that comprises a value of a field (e.g., and/or an indicator) triggering (e.g., indicating a trigger of or a request of) a transmission of SL CSI report and/or a transmission of SL CSI-RS(s). For example, the sidelink transmission comprises a first sidelink transmission via the slot and a second sidelink transmission via the slot. The first sidelink transmission may be a PSCCH transmission (e.g., PSCCH) that comprises a first stage SCI (e.g., as shown in FIG. 19). The second sidelink transmission may be a PSSCH transmission (e.g., PSSCH) that comprises a second stage SCI and SL-SCH data (e.g., comprising MAC PDU, MAC SDU(s) and/or MAC CE(s)) (e.g., as shown in FIG. 19). The SCI triggering the SL CSI report may be at least one of the first stage SCI and/or the second stage SCI. The first wireless device may transmit the sidelink CSI-RS within or via a PSSCH transmission. The sidelink transmission may be a unicast transmission. The PSSCH transmission may be a unicast PSSCH transmission.

Referring to FIG. 29, at least one of the first stage SCI and/or the second stage SCI may comprise a destination identifier associated with a unicast PC5 link (e.g., ProSe and/or V2X application layer(s)/server(s) send the destination identifier to the first wireless device). The second wireless device may receive the sidelink transmission. The second wireless device may determine that the destination identifier in the sidelink transmission matches an identifier of the second wireless device. The second wireless device may determine that the destination identifier in the sidelink transmission matches an identifier of the second wireless device. The second wireless device may determine that the value of the field in the SCI indicates a trigger of (e.g., triggering) a sidelink CSI report. The second wireless device may determine to transmit (e.g., may transmit) the sidelink CSI report to the first wireless device, e.g., if the second wireless device determines that the destination identifier in the sidelink transmission matches an identifier of the second wireless device, and/or if the value of the field in the SCI indicates a trigger of (e.g., triggering) the sidelink CSI report.

In an example, referring to FIG. 29, the second wireless device may start a timer or a window (e.g., sl-CSI-ReportTimer), e.g., if (e.g., in response to and/or after) e.g., the second wireless device determines to transmit (e.g., transmits) the sidelink CSI report. The first wireless device may start a second timer or a second window (e.g., sl-CSI-ReportTimer) that is the same as the timer or the window that the second wireless device starts, e.g., if (e.g., in response to and/or after) e.g., the first wireless device transmits the SCI indicating the trigger of the SL CSI report. The second wireless device may transmit the sidelink CSI report before the timer expires and/or while the timer is running. The SL latency bound in FIG. 29 may be a value for the timer. For example, the timer may run during a time duration indicated by the SL latency bound.

In an example, referring to FIG. 29, the second wireless device, e.g., configured with a resource allocation mode 1, receives, from a base station, a grant (e.g., SL grant (e.g., DCI 3_0) in FIG. 29) indicating a sidelink resource that is used for transmission of the SL CSI report to the first wireless device and/or that is located (e.g., occurs) within the SL latency bound that starts from a starting time of the timers. The second wireless device may transmit, to the base station, a scheduling request to receive the grant (e.g., SL grant in FIG. 29), e.g., if the second wireless device does not have an SL grant transmit the SL CSI report. The base station may transmit the grant (e.g., SL grant in FIG. 29) to the second wireless device, e.g., in response to and/or after receiving the scheduling request from the second wireless device. For example, the second wireless device, e.g., configured with a resource allocation mode 2, selects a sidelink resource that is used for transmission of the SL CSI report to the first wireless device and/or that is located within the SL latency bound that starts from a starting time of the timers.

In an example, referring to FIG. 29, the second wireless device may transmit to the first wireless device, the sidelink CSI report via the sidelink resource (indicated by the SL grant in FIG. 29 or selected by the second wireless device configured with resource allocation mode 2), e.g., before the timer expires, while the timer is running, and/or within the latency bound that starts from a starting time of the timer. For example, if the timer runs for the time duration indicated by the latency bound, the second wireless device may determine that the timer expires. The second wireless device may cancel the triggered sidelink CSI report (e.g., may cancel a transmission of the sidelink CSI report), e.g., if (e.g., the second wireless device determines that) the timer expires and/or if the second wireless device does not transmitting the sidelink CSI report before/until the timer expires, while the timer is running, and/or within the latency bound that starts from a starting time of the timer.

Conditions for the first wireless device to transmit the sidelink CSI-RS(s) may comprise that 1) sidelink CSI reporting is enabled by a higher layer parameter (e.g., sl-CSI-Acquisition); and 2) a field (e.g., the ‘CSI request’ field) in a corresponding SCI (e.g., SCI format 2-A) is set to 1. The corresponding SCI may schedule the PSSCH (e.g., be used for decoding of the PSSCH). The first wireless device may set a value of the ‘CSI request’ field as indicated by higher layers (e.g., to 1). When the first wireless device is configured with Qp={1,2} sidelink CSI-RS port(s) in sidelink and the number of scheduled layers is

$${n}_{layer}^{PSSCH} ,$$

the sidelink CSI-RS scaling factor β_{CSIRS} is given by

$${β}_{CSIRS} = {β}_{DMRS}^{PSSCH} \cdot \sqrt{\frac{{n}_{layer}^{PSSCH}}{{Q}_{p}}} , where {β}_{DMRS}^{PSSCH}$$

is the scaling factor for the corresponding PSSCH.

A SL CSI report may comprise SL CSI. The SL CSI may comprise information and/or one or more measurement quantities indicating a channel state that the second wireless device may determine and/or measure from/based on the sidelink CSI-RS received from the first wireless device. For example, the information and/or the one or more measurement quantities may comprise CQI, RI, LI, CRI, PMI, L1-RSRP, L1-SINR, and/or any combination thereof. The second wireless device may transmit, to the first wireless device, the SL CSI via a SL CSI report. The CQI and RI may be reported together. A procedure of transmitting the SL CSI report (and generating the sidelink CSI) may be denoted as SL CSI reporting. The CSI reporting may be aperiodic or periodic. Configured SL CSI-RS(s) may be aperiodic, semi-persistent, or periodic.

In the present embodiments, a SL CSI-RS may be interchangeable with and/or referred to as a CSI-RS, e.g., if the CSI-RS is transmitted via/as a sidelink transmission. In the present embodiments, a SL CSI report (or reporting) may be interchangeable with and/or referred to as a CSI-RS report (or reporting), e.g., if the CSI in the CSI-RS report comprise information and/or one or more measurement quantities indicating a channel state that a wireless device may determine and/or measure from the SL CSI-RS received from another wireless device.

In an example, referring to FIG. 29, the CSI report triggered by the SCI may be aperiodic CSI report. The SCI (e.g., SCI format 2-A) may comprise ‘CSI request’ field with a value set to 1 that indicate a trigger of (e.g., aperiodic) CSI report. The first wireless device (e.g., A CSI-triggering wireless device or a wireless device transmitting CSI-RS) may not be allowed to trigger (e.g., aperiodic) CSI report for the same wireless device (e.g., second wireless device) before/until a slot or a symbol in which the SL CSI report timer expires or before/until receiving the CSI report triggered by the SCI (e.g., SCI format 2-A) with the ‘CSI request’ field set to 1. The second wireless device may not be expected to transmit a sidelink CSI-RS and a sidelink PT-RS which overlap.

In FIG. 29, the second wireless device may receive a message (e.g., RRC message and/or RRCReconfigurationSidelink) comprising SL CSI-RS configuration parameters. The message may comprise SL-CSI-RS-Config. The SL-CSI-RS-Config may comprise SL CSI-RS configuration parameters, e.g., sl-CSI-RS-FreqAllocation, sl-CSI-RS-FirstSymbol, that indicate a resource allocation of SL CSI-RS in a frequency domain and a time domain.

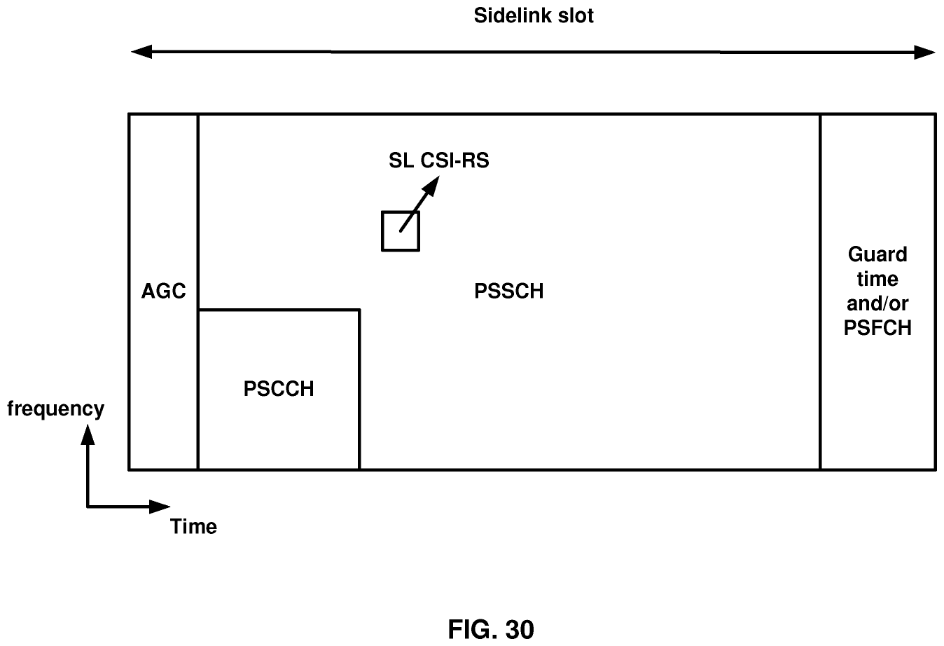

FIG. 30 illustrates an example of resource allocation of SL CSI-RS. The SL CSI-RS configuration parameters that the first wireless device transmits and/or that the second wireless device receives in FIG. 30 may indicate a starting frequency and a starting time of the SL CSI-RS in a slot where the first wireless device transmits a SCI triggering a SL CSI report. For example, the SL CSI-RS configuration parameters may indicate how many symbols and/or how many REs, and/or how many PRB carry the SL CSI-RS.

The second wireless device may determine (e.g., assume) non-zero transmission power for SL CSI-RS. A SL CSI-RS and the PSCCH (that is located in the same slot and/or that schedules PSSCH carrying the SL CSI-RS) may not be mapped to the same resource element. The SL CSI-RS and PSSCH DM-RS may not be scheduled, mapped, allocated in a same symbol. The SL CSI-RS and SCI (1st-stage CSI and/or 2nd-stage SCI) may not be scheduled, mapped, allocated in a same symbol. The first wireless device may transmit the SL CSI-RS in resource block(s) used for transmitting the PSSCH, e.g., that carries the SCI format 2-A scheduling the PSSCH, triggering a SL CSI report comprising SL CSI measured based on the SL CSI-RS. The second wireless device may receive, e.g., from the first wireless device, one SL latency bound, sl-LatencyBoundCSI-Report, configured for different SL CSI-RS transmissions.

In an example, the SL CSI reporting (e.g., SL CSI reporting procedure) may be used to provide a peer wireless device (the first wireless device) with sidelink CSI. For example, the SL latency bound, sl-LatencyBoundCSI-Report, may be defined, configured, and/or received per (e.g., for) each PC5-RRC connection. For example, the second wireless device may receive a first SL latency bound from a first wireless device for a first PC5-RRC connection and/or first a PC5 link established with the first wireless device. For example, the second wireless device may receive a second SL latency bound from a third wireless device for a second PC5-RRC connection and/or second a PC5 link established with the third wireless device.

In an example, a MAC entity (of the first wireless device and/or the second wireless device) may maintain a timer (e.g., sl-CSI-ReportTimer, SL CSI report timer in FIG. 30) for each pair of the Source Layer-2 ID and the Destination Layer-2 ID corresponding to a PC5-RRC connection. The sl-CSI-ReportTimer may be used for an SL-CSI reporting wireless device (e.g., the second wireless device) to follow the latency requirement (e.g., sl-LatencyBoundCSI-Report) signaled from a CSI-report-triggering wireless device (e.g., the first wireless device). The value (e.g., an initial value) of sl-CSI-ReportTimer may be the same as the latency requirement of the SL-CSI reporting in the sl-LatencyBoundCSI-Report configured by RRC. The value indicates a (e.g., maximum) running time of the sl-CSI-ReportTimer. If the sl-CSI-ReportTimer runs for a duration indicated by the value, the wireless device may determine that the sl-CSI-ReportTimer expires. The wireless device may stop the sl-CSI-ReportTimer if the wireless device receives a CSI report. The MAC entity may for each pair of the Source Layer-2 ID and the Destination Layer-2 ID corresponding to the PC5-RRC connection which has been established by upper layers:
1> if the SL-CSI reporting has been triggered by an SCI and not cancelled:
   2> if the sl-CSI-ReportTimer for the triggered SL-CSI reporting is not running:
      3> start the sl-CSI-ReportTimer.
   2> if the sl-CSI-ReportTimer for the triggered SL-CSI reporting expires:
      3>cancel the triggered SL-CSI reporting.
   2> else if the MAC entity has SL resources allocated for new transmission and the SL-SCH resources can accommodate the SL-CSI reporting MAC CE and its subheader as a result of logical channel prioritization:
      3> instruct the Multiplexing and Assembly procedure to generate a Sidelink CSI Reporting MAC CE;
      3>stop the sl-CSI-ReportTimer for the triggered SL-CSI reporting;
      3>cancel the triggered SL-CSI reporting.
   2> else if the MAC entity has been configured with Sidelink resource allocation mode 1:
      3>trigger a Scheduling Request.

The wireless device may determine that a SL CSI report is pending (e.g., until canceling the SL CSI report), e.g., if the wireless device triggers the SL CSI report. The MAC entity configured with Sidelink resource allocation mode 1 may trigger a Scheduling Request (e.g., FIG. 29) if transmission of a pending SL-CSI reporting with the sidelink grant(s) cannot fulfil the latency requirement associated to the SL-CSI reporting.

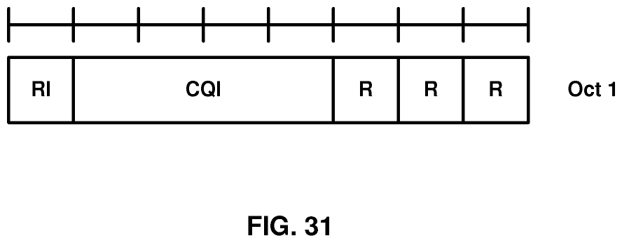

FIG. 31 illustrates an example of SL CSI report as per an aspect of an example embodiment of the present disclosure. For example, the SL CSI report may comprise a MAC CE that includes SL CSI. For example, the MAC CE may be a Sidelink CSI Reporting MAC CE identified by a MAC subheader with LCID predefined (e.g., 62). A priority of the Sidelink CSI Reporting MAC CE is fixed to a predefined value (e.g., ‘1’ indicating a highest priority). In FIG. 31, the RI may be a field indicating a derived value of the Rank Indicator for sidelink CSI reporting from the measurement results of the SL CSI-RS. The length of the RI field is predefined (e.g., 1 bit). In FIG. 31, the CQI may be a field indicating a derived value of the Channel Quality Indicator for sidelink CSI reporting from the measurement results of the SL CSI-RS. The length of the CQI field may be predefined (e.g., 4 bits). In FIG. 31, the R may indicate one or more reserved bits, e.g., that are set to a predefined value (e.g., 0).

In an example, the sidelink transmission may be beam-centric. For example, between peer wireless devices, a transmission of PSCCH, PSSCH, and/or PSFCH may be performed via, through, and/or using a particular beam. A sidelink reference signal (e.g., SL SSB, and/or SL CSI-RS) may represent a particular beam for the sidelink transmission.

In sidelink, a wireless device may perform a beam sweeping for the beam-centric sidelink transmission. For example, a first wireless device may transmit, as the beam sweeping, a plurality of sidelink reference signal (SL RSs) (e.g., SL CSI-RSs) to a second wireless device. Each of the plurality of SL RSs may be corresponding to (e.g., associated with and/or represent) a respective beam of the first wireless device.

The beam sweeping may be for a sidelink unicast link between a pair of a source UE (e.g., identified/indicated by a source identifier, e.g., Layer-2 Source ID) and a destination UE (e.g., identified/indicated by a destination identifier, e.g., Layer-2 Destination ID). Referring to FIG. 28, a source UE and/or a destination UE may refer to an Application Layer ID in a wireless device that supports one or more V2X services that communicate using a same PC5 unicast link. A PC5 unicast link is bi-directional, e.g., the wireless device may transmit to and receive from another wireless device using the PC5 unicast link. The UE (e.g., the application layer of the wireless device) may use the source ID when transmitting in sidelink using the PC5 unicast link. The UE (e.g., the application layer of the wireless device) may use the destination ID when receiving in sidelink using the PC5 unicast link. A source UE may be referred to as source. A destination UE may be referred to as destination. Referring to FIG. 28, a pair of wireless devices may comprise/have/be associated with one or more PC5 unicast links, and thus, one or more pairs of (Source ID, Destination ID).

The sidelink unicast link may refer to direct communication link established between the pair of the source and the destination. The sidelink unicast link may be referred to as a PC5 (Proximity Service Communication 5) link, PC5 unicast link, PC5-RRC connection, and/or the like. For example, PC5-RRC connection may refer to a PC5 link over which a RRC layer is setup/established between the source and the destination.

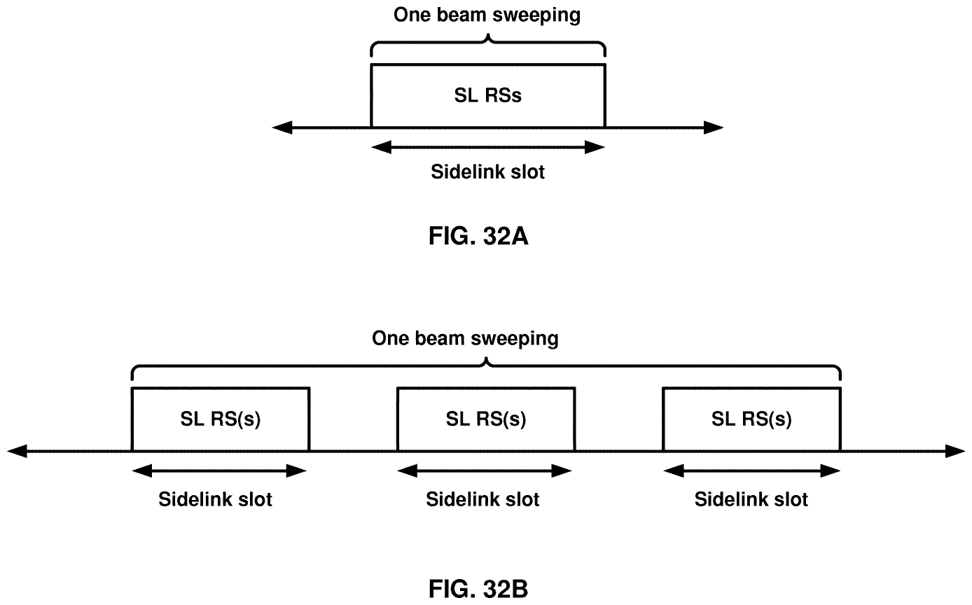

FIG. 32A and FIG. 32B illustrate examples of SL RSs as per an aspect of an example embodiment of the present disclosure. For example, as illustrated in FIG. 32A, a first wireless device may transmit a plurality of SL RSs (e.g., a group/set of SL RSs), corresponding to (e.g., for or associated with) a respective beam sweeping, within a sidelink slot (a.k.a., intra-slot beam sweeping). For example, as illustrated in FIG. 32B, a first wireless device may transmit a plurality of SL RSs (e.g., a group/set of SL RSs), corresponding to (e.g., for or associated with) a respective beam sweeping, via (e.g., across) multiple sidelink slots (a.k.a., inter-slot beam sweeping). The first wireless device may transmit one or more SL RSs via each of the sidelink slots in FIG. 32B.

The plurality of SL RSs in FIG. 32A and/or in FIG. 32B are associated with a particular set or group (e.g., beam sweeping group) of SL RS transmission. For example, each of the plurality of SL RSs is associated with a same set or a same group. For example, a set or a group (e.g., that is associated with one or more SL RSs or that comprises one or more SL RSs) may be associated with a particular beam sweeping of SL RS transmission. Each set or group (or its respective beam sweeping) may be associated with a particular purpose of SL RS transmission. For example, a particular set or group (or its respective beam sweeping) may be for a periodic transmission of a plurality of SL RSs, aperiodic transmission of a plurality of SL RSs, and/or semi-persistent transmission of the plurality of SL RS, transmission(s) of a plurality of SL RSs for an initial beam pairing procedure, transmission(s) of a plurality of SL RSs for beam management procedure, transmission(s) of a plurality of SL RSs for a beam failure detection/recovery procedure, and/or any combination thereof.

For example, a first wireless device may transmit, to a second wireless device, a message comprising a plurality of configurations (e.g., sl-CSIRS-ResourceConfig IE or the like). Each of the plurality of configurations may be associated with a respective set (or a group) of a plurality of sets (or groups). Each of the plurality of configurations may comprise a respective configuration identifier (additionally or alternatively, a respective set identifier or a respective group identifier) that indicates a respective set (or a group) of the plurality of sets (or groups). Each of the plurality of configurations may comprise parameters indicating one or more SL RSs associated with a respective set (or a group).

In FIG. 32A and FIG. 32B, the first wireless device may transmit, to a second wireless device, the SL RSs with an indication of a set and/or a group associated with the SL RSs. For example, in a sidelink slot in FIG. 32A, the first wireless device may transmit, to the second wireless device, a control information (e.g., SCI, a first stage SCI, and/or a second stage SCI) comprising a field value (e.g., set identifier, group identifier, and/or configuration identifier) indicating the set and/or the group associated with the SL RSs. For example, the first wireless device transmits the control information via a sidelink slot where the first wireless device transmits the SL RSs. The second wireless device may determine that the control information (comprising the field value) indicates a transmission of the SL RSs, associated with the set and/or the group (indicated by the field value in the SCI). The second wireless device may determine that the SL RSs are being transmitted in the sidelink slot. In FIG. 32B, in at least one sidelink slot (e.g., the firstly located sidelink slot or all of three sidelink shots) of three shots in FIG. 32B, the first wireless device may transmit, to the second wireless device, a control information (e.g., SCI, a first stage SCI, and/or a second stage SCI) comprising a field value (e.g., set identifier, group identifier, and/or configuration identifier) indicating the set and/or the group associated with the SL RSs. The second wireless device may determine that the control information (comprising the field value) indicates a transmission of the SL RSs, associated with the set and/or the group (indicated by the field value in the SCI), being in the at least one sidelink slot and/or in all three sidelink slots.

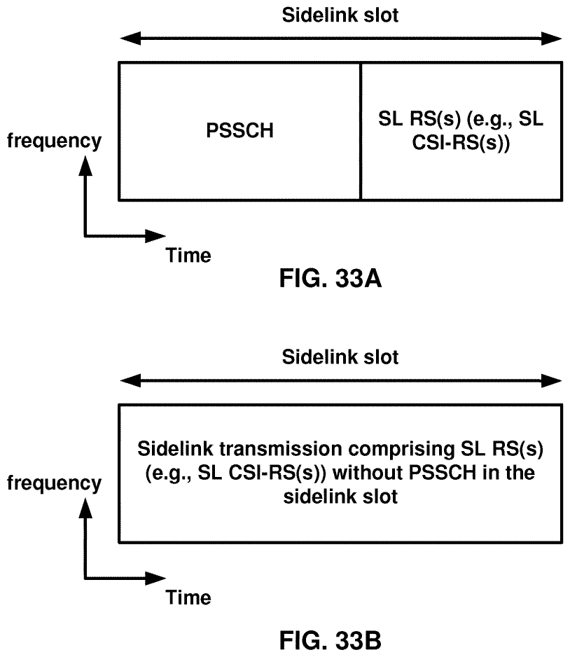

FIG. 33A illustrates an example for SL RS transmission as per an aspect of an embodiment of the present disclosure. A first wireless device may transmit, to a second wireless device, a SL RS (e.g., SL CSI-RS), e.g., each of SL RS(s) (e.g., SL CSI-RS(s), with a (e.g., unicast) PSSCH in a sidelink (e.g., same) slot, as illustrated in FIG. 33A. For example, the first wireless device may transmit a plurality of SL RSs and PSSCH in a same sidelink slot. The first wireless device may transmit the SL RS(s) in FIG. 33A for a beam sweeping (e.g., an initial beam pairing procedure, a beam management procedure, and/or a beam failure detection/recovery procedure). The SL RS(s) in FIG. 33A may be at least one of the SL RSs in FIG. 32A or any one of SL RS(s) in one of three sidelink slots in FIG. 32B. The sidelink slot in FIG. 33A may be a sidelink slot in FIG. 32A or any one of sidelink slots in FIG. 32B.

FIG. 33A is an example of multiplexing SL RS(s) with PSSCH in a time-division multiplexing (TDM) manner. For example, the SL RS may be multiplexed with PSSCH in a sidelink (e.g., same) slot in different ways. In an example, one or more PSSCH symbols may be firstly located in the sidelink slot, followed by one or more SL RS symbols in the sidelink (e.g., same) slot. In an example, SL RS symbols may be firstly located in the sidelink slot, followed by one or more PSSCH symbols in the sidelink slot. In an example, one or more PSSCH symbols may be allocated between two SL RS symbols in the sidelink slot. The transmission of SL RS(s) with PSSCH in a same slot may be referred to as a non-standalone transmission of SL RS(s) or the like. In FIG. 33A, the first wireless device may transmit PSCCH and/or SCI in the sidelink slot where the first wireless device transmits the SL RS(s) and/or the PSSCH. The PSCCH and/or SCI may comprise one or fields whose values indicates at least one of: a number of SL RS(s) in the sidelink slot; a starting position (symbol), in a slot, of each of the SL RS(s) in the sidelink slot; an ending position (symbol), in the sidelink slot, of each of the SL RS(s) in the sidelink slot; and/or a frequency resource allocation of each of the SL RS(s) in the sidelink slot.

FIG. 33B illustrates an example for SL RS transmission as per an aspect of an embodiment of the present disclosure. A first wireless device may transmit, to a second wireless device, a SL RS (e.g., SL CSI-RS), e.g., each of SL RS(s) (e.g., SL CSI-RS(s)), without a (e.g., unicast) PSSCH in a same slot, as illustrated in FIG. 33B. The first wireless device may transmit the SL RS(s) in FIG. 33B for a beam sweeping (e.g., an initial beam pairing procedure, a beam management procedure, and/or a beam failure detection/recovery procedure). The SL RS(s) in FIG. 33B may be at least one of the SL RSs in FIG. 32A or any one of SL RS(s) in one of three sidelink slots in FIG. 32B. The sidelink slot in FIG. 33A may be a sidelink slot in FIG. 32A or any one of sidelink slots in FIG. 32B.

The transmission of SL RS(s) without PSSCH in a sidelink slot, as illustrated in FIG. 33B, may be referred to as a standalone transmission of SL RS(s) or the like. In FIG. 33B, the first wireless device may transmit PSCCH and/or SCI in the sidelink (e.g., same) slot where the first wireless device transmits the SL RS(s). The PSCCH and/or SCI may comprise one or fields whose values indicates at least one of: a number of SL RS(s) in the sidelink slot; a starting position (symbol), in a slot, of each of the SL RS(s) in the sidelink slot; an ending position (symbol), in the sidelink slot, of each of the SL RS(s) in the sidelink slot; and/or a frequency resource allocation of each of the SL RS(s) in the sidelink slot.

In an example, a transmission of a SL RS may be a transmission of a sequence of SL RS (e.g., SL CSI-RS). For example, a sequence of SL RS may be denoted by r(m). A first wireless device may generate the sequence r(m) as a formular predefined. For example, the sequency r(m) may be

$$r ( m ) = \frac{1}{\sqrt{2}} ( 1 - 2 c ( 2 m ) ) + j \frac{1}{\sqrt{2}} ( 1 - 2 c ( 2 m + 1 ) ) .$$

c(i) may be a pseudo-random sequence. c(i) may be initialized with

$${c}_{init} = ( {2}^{10} ( {N}_{symb}^{slot} {n}_{s , f}^{μ} + l + 1 ) ( 2 {n}_{ID} + 1 ) + {n}_{ID} ) mod {2}^{31}$$

at the start of each OFDM symbol.

$${n}_{s , f}^{μ}$$

may be the slot number (or index) within a radio frame. l may be the OFDM symbol number (or index) within a slot. In an example, a first wireless device may transmit a SL RS via a symbol with the OFDM symbol number I within the slot. In an example, the parameter sl-CSI-RS-FirstSymbol may indicate the OFDM symbol number l. A second wireless device may receive the SL RS via the symbol within the slot.

A first wireless device may transmit a plurality of SL RSs (e.g., SL CSI RSs) via a plurality of OFDM symbols within a slot (e.g., for SL beam management), for example, as illustrated in FIG. 32A, FIG. 32B, FIG. 33A, and/or FIG. 33B. The first wireless device may transmit the plurality of SL RSs with a PSSCH in the slot (e.g., in FIG. 33A) or without a PSSCH in the slot (in FIG. 33B). The plurality of SL RSs and the PSSCH may occupy (or be carried on, or be scheduled in) different OFDM symbols in the slot, e.g., if the first wireless device transmits the plurality of SL RSs and the PSSCH in the same slot. The plurality of OFDM symbols may be allocated to SL RSs. An indication (e.g., a field of a SCI within the slot) may indicate the presence of SL RSs for beam measurement in transmission of the PSSCH. For example, a 1 bit field in a SCI Format 1-A may inform (or indicate) that transmitted SL RS is used for beam management.

In example embodiments of present disclosure, a beam sweeping may refer to or comprise a transmission of a plurality of SL RSs from one wireless device to another wireless device. The transmission of the plurality of SL RSs may occur during a plurality symbols via a slot (e.g., FIG. 32A) or via/across multiple slots (e.g., FIG. 32B). Each of the plurality of SL RS may be associated with or be grouped into a same configuration IE (e.g., sl-CSIRS-ResourceConfig IE or the like), a same set, and/or a same group. The same configuration IE (e.g., sl-CSIRS-ResourceConfig IE or the like), the same set, and/or the same group are identified by a respective identifier (e.g., configuration id, set id, group id, and/or the like). For example, a configuration IE may comprise a value of a parameter indicating the respective identifier (e.g., configuration id, set id, group id, and/or the like).

A SL RS may be referred to as or indicated by a different terminology. For example, a SL TCI state, a SL SRI, a SL beam may be used to refer to a SL RS. For example, a SL configuration may comprise a first SL TCI state or a first SL SRI field (or container or IE) that comprises, is linked to, or associated with a first SL RS (e.g., SL CSI RS). In this case, the first SL TCI state or the first SL SRI field (or container or IE) may be used as a terminology to indicate the first SL RS. Likewise, in this case, the first SL RS may be used as a terminology to indicate the first SL TCI state or the first SL SRI field (or container or IE).

The UE may receive one or more RRC messages comprising SL configuration parameters of the SL resource pool and/or the unicast link (e.g., via PC5 link from a second UE or via downlink from a BS). In an example, one or more SL TCI states may refer to a first SL RS. For example, SL RRC configurations (e.g., SL-TCI-State) may indicate a plurality of TCI states (e.g., via SL-TCI-StateId) corresponding to a first SL RS (referenceSignal), e.g., a wide beam (S-SSB and/or SL CSI-RS). For example, each of the plurality of TCI states may indicate a spatial domain transmission/reception filter setting (e.g., RX filter and/or TX filter) that is quasi co-located (QCLed) with the first SL RS. The SL RRC configurations may comprise a parameter (e.g., SL-QCL-Info) indicating the first SL RS and a QCL type for a respective SL TCI state. For example, the QCL type may be typeA (based on Doppler shift, Doppler spread, average delay, and delay spread), typeB (based on Doppler shift and Doppler spread), typeC (based on Doppler shift, average delay), typeD (based on Spatial Rx parameter), or a combination thereof. For example, each SL TCI State may contain parameters for configuring a quasi co-location relationship between one or two sidelink reference signals and the DM-RS ports of the PSSCH, the DM-RS port of PSCCH or the SL CSI-RS port(s) of a SL CSI-RS resource. The quasi co-location relationship may be configured by the higher layer parameter QCL Type for the first SL RS in a first SL BWP and/or resource pool.

Each of the plurality of SL RS may be associated with a respective spatial filter of a wireless device. For example, a first wireless device may: determine to use a first TX spatial filter for transmitting, to a second wireless device, a first SL RS of the plurality of SL RSs; determine to use a second TX spatial filter for transmitting, to a second wireless device, a second SL RS of the plurality of SL RSs; and so on. For example, if a first SL RS and a second SL RS are associated with a same TX spatial filter, the first wireless device and/or the second wireless device may determine that the first SL RS is quasi-co located with the second SL RS. If a first SL RS and a second SL RS are linked to or associated with a same SL TCI or SL SRI, the first wireless device and/or the second wireless device may determine that the first SL RS is quasi-co located with the second SL RS.

For example, if a first SL RS and a second SL RS are associated with a same TX spatial filter, the first wireless device and/or the second wireless device may determine that the first SL RS is quasi-co located with the second SL RS. If a first SL TCI (or first SL SRI) and a second SL TCI (or second SL SRI) are linked to or associated with a same SL RS, the first wireless device and/or the second wireless device may determine that the first SL TCI is quasi-co located with the second SL TCI.

For example, a SL TCI may be referred to as or be interchangeably used with a SL TCI state. A SL TCI (or a configuration of the SL TCI) may comprise or is associated with a respective SL TCI identifier. The SL TCI identifier may be used to indicate a respective SL TCI. A SL SRI (or a configuration of the SL SRI) may comprise or is associated with a respective SL SRI identifier. The SL SRI identifier may be used to indicate a respective SL SRI. A SL RS (or a configuration of the SL RS) may comprise or is associated with a respective SL RS identifier. The SL RS identifier may be used to indicate a respective SL RS.

The RX/TX spatial filters and/or the corresponding SL RSs may be configured for (via/in) a respective unicast connection. For example, in mode 1, the UE may receive, from the BS, RRC message(s) comprising the SL configurations for a unicast link with a second UE. For example, in mode 2, the UE may receive from a second UE, or transmit to the second UE, PC5 link RRC message(s) comprising the SL configurations for the unicast link with the second UE. The SL configurations may indicate TCI states and/or SL RSs that are dedicated/specific to the respective unicast link. For example, the UE may have multiple unicast links in sidelink with one or more second UEs. The UE may determine and apply corresponding Rx/Tx spatial filters for transmission and receptions via/on/for each of these unicast links based on the respective configuration of the unicast link. For example, the PC5 unicast link may be between a first Layer-2 ID of the first UE and a first Layer-2 ID of the second UE.

During the beam sweeping in which a first wireless device transmits, to a second wireless device, a plurality of SL RSs, the second wireless device may determine a preferred SL beam or a preferred SL beam pair. For example, a (e.g., preferred) SL beam or a preferred SL beam pair may be represented by or identified by a respective SL TCI, SL SRI, or SL RS. For example, the second wireless device may determine a measurement quantity (e.g., L1 RSRP or RSRQ) of each of the plurality of SL RSs. The second wireless device may determine or select a preferred SL beam in response to the measurement quantity satisfying one or more conditions (e.g., RSRP value is higher than or equal to a RSRP threshold). For example, a preferred beam may be associated with a SL RS that has a L1 RSRP higher than the RSRP threshold.

During the beam sweeping, the second wireless device may determine/select its RX spatial filter corresponding to the (e.g., preferred) SL beam. The determined/selected preferred SL beam and the determined/selected RX spatial filter may be referred to as a (e.g., preferred) SL beam pair. The second wireless device may transmit, to the first wireless device, a signal or message (e.g., CSI report) indicating the selected (e.g., preferred) SL beam and/or a (e.g., preferred) SL beam pair. For example, the signal or message (e.g., CSI report) may comprise a field indicating a SL TCI, SL SRI, or SL RS identifier associated with the selected (e.g., preferred) SL beam and/or a (e.g., preferred) SL beam pair, e.g., as a way to indicate the selected (e.g., preferred) SL beam and/or a (e.g., preferred) SL beam pair.

A wireless device may transmit a plurality of SL RSs, as the beam sweeping, for an (e.g., initial) beam pairing procedure, a beam management (or maintenance) procedure, a beam failure detection/recovery procedure.

The (e.g., initial) beam pairing procedure may comprise a determination of beam pair that is used for a transmission via/using a unicast link between a first wireless device and a second wireless device. Before actual SL transmission, the first wireless device and the second wireless device may select a preferred TX beam (e.g., TX spatial filter or precoder) and a preferred RX beam (e.g., RX spatial filter), e.g., a beam pairing, for the SL transmission.

For example, the beam pairing procedure may comprise transmitting, by the first wireless device to the second wireless device, a plurality of SL RSs to select a beam used by the first wireless device to transmit a sidelink transmission to the second wireless device and/or to receive a sidelink transmission from the second wireless device. For example, the first wireless device may transmit the plurality of SL RSs using different beams or using different TX spatial filters (e.g., each of the plurality of SL RSs is associated with a respective beam of the different beams or with a respective TX spatial filter of the different TX spatial filters). The second wireless device may determine measurement quantity(-ies) measured on the plurality of SL RSs and transmit, to the first wireless device, a measurement report (e.g., CSI report). The measurement report may comprise one or more of the measurement quantity(-ies) of the plurality of SL RSs and/or an indication of one or more preferred/selected beams (or an index/identifier of a SL RS of the plurality of SL RSs). The first wireless device may select or determine, based on the measurement quantity(-ies) and/or the one or more preferred/selected beam, its TX beam and/or RX beam (that are associated with one of the plurality of SL RSs) for a sidelink transmission with the second wireless device.

For example, the beam pairing procedure may comprise transmitting, by the first wireless device to the second wireless device, a SL RS via (e.g., across) multiple symbols or slots for the second wireless device to sweep its RX beams to select a beam used by the second wireless device to transmit a sidelink transmission to the first wireless device and/or to receive a sidelink transmission from the first wireless device. For example, the first wireless device may transmit a SL RS using a same beam or using a same TX spatial filter via (e.g., across) multiple symbols or slots. The SL RS may be associated with (e.g., may correspond to) a preferred TX beam or RX beam that the first wireless device selects for transmitting a sidelink transmission to the first wireless device or for receiving a sidelink transmission from the second wireless device. While the first wireless device transmits the SL RS via the multiple symbols or multiple slots, the second wireless device may receive the SL RS using different RX beams (e.g., may perform a RX beam sweeping). For example, the second wireless device may determine measurement quantity(-ies) measured on the SL RS per each of RX beams and select one of the RX beams as the one to be used to transmit a sidelink transmission to the first wireless device and/or to receive a sidelink transmission from the first wireless device.

The beam pairing procedure may occur while the first wireless device and the second wireless device are establishing a unicast link (e.g., during a unicast link establishment procedure). The beam pairing procedure may occur after the first wireless device and the second wireless device complete establishing a unicast link (e.g., after completing a unicast link establishment procedure). The beam pairing procedure may comprise transmitting, by the first wireless device to the second wireless device, SL configuration parameters.

The beam management procedure may comprise transmission(s) of one or more SL RSs, a transmission(s) of measurement report(s) associated with the one or more SL RSs, and/or determination on whether to maintain or switch a current TX beam (and/or a current RX beam). For example, the beam management may comprise transmitting, by a first wireless device to a second wireless device, one or more SL RSs using one or more TX beams. For example, the beam management procedure may be for a link monitoring on a unicast link established between the first wireless device and the second wireless device. The first wireless device may transmit a message comprising configuration parameters indicating SL RSs used for the beam management procedure. The configuration parameters may comprise one or more parameters indicating a radio resource mapping of each of the SL RSs to respective RE(s), one or more reporting quantities (e.g., L1-RSRP, CQI, RI, PMI, or the like) measured by/based on each of the SL RSs and to be reported to the first wireless device, and/or the resource scheduling information (e.g., whether the SL RSs are periodic, aperiodic, or semi-persistent transmission). The second wireless device may determine measurement quantities according to the configuration parameters and transmit, to the first wireless device, a measurement report comprising one or more measurement quantities. The first wireless device and/or the second wireless device may switch their TX beam and/or RX beam used for the sidelink transmission between them to another TX beam and/or RX beam based on the measurement report.

The beam failure detection/recovery procedure may enable beamformed sidelink unicast link to quickly and effectively re-form a broken communication link, e.g., without performing the (e.g., initial) beam pairing procedure that may be time consuming. For example, the beam failure detection/recovery procedure may comprise at least one of a beam failure detection (BFD) and/or a candidate beam identification, or a beam failure recovery.

The BFD may be based on a measurement quantity of one or more first SL RSs. For example, a first wireless device may transmit, to a second wireless device, a message (e.g., SL RRC reconfiguration message) indicating the one or more first SL RSs, e.g., among a plurality of first SL RSs, as the ones for the BFD. The first wireless device may transmit to the second wireless device after transmitting the message, the one or more first SL RSs one or more times. The second wireless device may determine a measurement quantity of the received one or more first SL RSs, e.g., for each time the first wireless device transmits the one or more first SL RSs. For example, the second wireless device may determine a beam failure instance if the measurement quantity satisfies one or more BFD conditions. For example, the second wireless device may determine a beam failure instance (e.g., indicating that the BFD occurs) if an RSRP value (or the like) measured on the one or more first SL RSs is below (lower than) a BFD threshold. The second wireless device may determine BFD, e.g., if the beam failure instance occurs, e.g., consecutively, for N times (e.g., N≥1) within a time window.

The candidate beam identification may comprise: monitoring, by the second wireless device, one or more second SL RSs that the first wireless device transmits; and/or determining a candidate beam based on the one or more second SL RSs. For example, the first wireless device may transmit, to the second wireless device, a message (e.g., SL RRC reconfiguration message) indicating the one or more second SL RSs, e.g., among a plurality of second SL RSs, as the ones to monitor for the candidate beam identification. For example, the plurality of the first SL RSs may be same as the plurality of the second SL RSs. The second wireless device may determine a measurement quantity (e.g., RSRP) of each of the one or more second SL RSs. The second wireless device may determine a candidate beam (e.g., SL TCI, SL SRI, SL CSI RS) that is associated with a first SL RS of the one or more second SL RSs, e.g., if the measurement quantity (e.g., RSRP value) of the first SL RS of the one or more second SL RSs satisfies one or more second conditions (e.g., is higher than or equal to a RSRP threshold). The second wireless device may transmit a signal or message (e.g., SCI, MAC CE, and/or RRC message) comprising an identifier of the first SL RS, e.g., as a candidate beam or beam pair that the first wireless device and/or the second wireless device to switch to. For example, the identifier of the first SL RS may be an identifier of SL TCI, SL SRI associated with (or linked to) the first SL RS.

The beam failure recovery may be triggered when beam failure is detected and/or candidate beams are identified. For example, the first wireless device, that transmits (e.g., to the second wireless device) the one or more first SL RSs or one or more second SL RSs, may trigger the beam failure recovery. For example, the second wireless device, that receives (e.g., from the first wireless device) the one or more first SL RSs or one or more second SL RSs, may trigger the beam failure recovery. The beam failure recovery may comprise a transmission of a signal or message comprising the identifier of the first SL RS, e.g., as a candidate beam or beam pair that the first wireless device and/or the second wireless device to switch to.

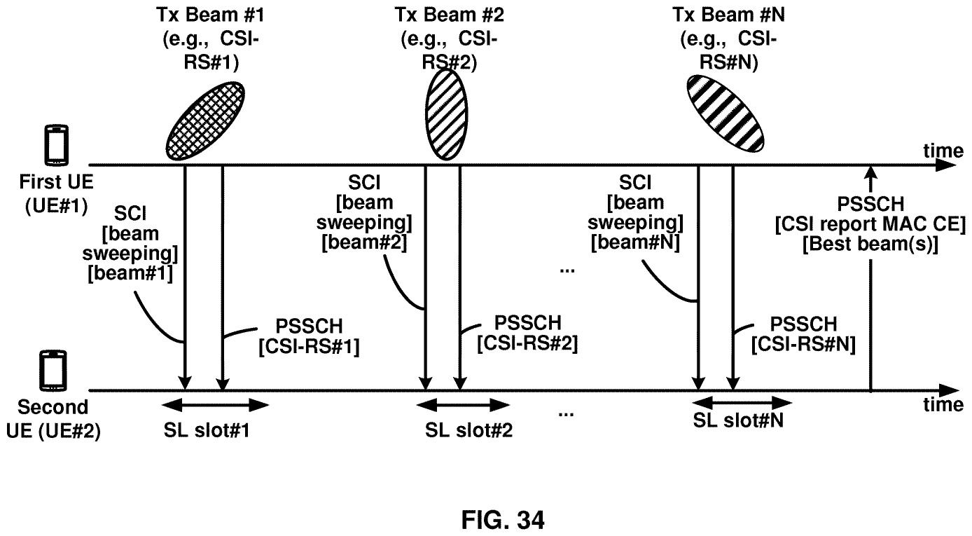

FIG. 34 shows an example of beam management comprising a beam sweeping procedure, e.g., for beam pairing, initial beam pairing, beam training, beam refinement/maintenance, beam failure recovery, and/or beam establishment purposes (these terms may be used interchangeably). In this example, a first UE (e.g., UE1, Tx UE with a source layer-2 ID #1) may transmit a plurality of SL RSs (e.g., SL CSI-RSs comprising SL CSI-RS #1 in slot #1, SL CSI-RS #2 in slot #2, . . . , and SL CSI-RS #N in slot #N) for beam sweeping/management to a second UE (e.g., UE2, Rx UE with a destination layer-2 ID #1). Beam pairing/training may comprise transmit (Tx) beam training(s) and/or receive (Rx) beam training(s). Beam pairing may refer to determination of the Tx beam(s) at the Tx UE and determination of the corresponding Rx beam(s) at the Rx UE. Based on beam correspondence assumption, the Rx beam(s) and Tx beam(s) at each UE may be identical/substantially similar (e.g., in terms of QCL setting and/or spatial filter settings/configurations).

Throughout this disclosure, a beam management and/or beam sweeping procedure (as the one shown in FIG. 32A and FIG. 32B and FIG. 34) may be part of a beam (pair) establishment and/or initial beam pairing (IBP) and/or beam training and/or beam refinement and/or beam failure recovery procedures. The example of FIG. 34 may illustrate a beam sweeping/pairing/training procedure for beam management including IBP, beam pair establishment, beam failure recovery, beam refinement, beam maintenance, etc.,

Referring to FIG. 34, the first UE (e.g., Tx UE, UE 1) may initiate a beam pairing procedure with a second UE (e.g., Rx UE, UE 2). The first UE may transmit a burst of SL RSs to the second UE using a plurality of beams in a plurality of time resources (symbols and/or slots). Throughput this disclosure, a burst of SL RS may refer to a plurality of SL RSs transmitted as a group/bundle of SL RSs using different Tx beams and/or in a TDM manner. FIG. 32A shows a burst of SL RS transmission using multiple different symbols of a slot (intra-slot TDMed). FIG. 32B shows a burst of SL RS transmission using multiple different sidelink slots (inter-slot TDM). In an example, one beam sweeping (Tx beam sweeping) may comprise transmission of one SL RS burst. The second UE receiving the SL RS burst, may use one (same) Rx beam to receive each of the SL RSs of the plurality of SL RSs of the burst, and determine a first (e.g., best) Tx beam associated with a first SL RS with a first (e.g., highest) RSRP. In an example, Rx beam sweeping may comprise multiple (e.g., repeated) transmission of the SL RS burst. For example, the first UE may transmit the SL RS burst M times (e.g., M repetition, each time the burst comprises N SL RSs/Tx beams). The repetition of the SL RS burst may help the second UE train the Rx beam. For example, the second UE may receive each SL RS burst using a certain/different Rx beam, and determine a first (e.g., best) Rx beam that results in a first (e.g., highest) RSRP. The UEs may use this process to determine a pair of the first Tx beam and the first Rx beam (a.k.a., beam pairing/training procedure).

The example of FIG. 34 shows an inter-slot (Tx) beam sweeping initiated by the first UE (UE 1). The first UE may transmit a burst of SL CSI-RSs to the second UE. The first UE may transmit a first SL RS (e.g., SL CSI-RS #1) to the second UE using a first Tx beam (e.g., Tx Beam #1) via a first SL RS resource in a first slot (e.g., SL slot #1). For example, the first UE may transmit a first SCI in the first slot comprising an indication of beam sweeping/pairing. The first SCI may indicate whether the beam sweeping/pairing is based on inter-slot (e.g., multi-slot) SL RS transmission (as in the example of FIG. 34 and FIG. 32B) or intra-slot (e.g., single-slot) SL RS transmission (as in the example of FIG. 32A). In an example, the first SCI may indicate a number of SL RSs that are used/transmitted for the beam sweeping/pairing (e.g., N in the example of FIG. 34). In an example, the number of SL RSs (or beams, N) for the beam sweeping/management procedure may be pre-defined or (pre-) configured (e.g., by RRC signaling). The first SCI may indicate a destination layer 2 ID associated with the second UE (e.g., unicast L2 ID or (default) broadcast L2 ID). The first SCI may indicate an index of the first SL RS (e.g., SL CSI-RS #1) and/or the first beam (e.g., Tx Beam #1). The first SCI may comprise a field indicating a parameter associated with the first SL RS and/or the first beam (e.g., a first TCI state). The first SCI may indicate resources for transmission of the first SL RS, e.g., the first PSSCH occasion in slot #1 comprising SL CSI-RS #1. The first SCI may indicate resources for transmission of a second SL RS, e.g., a second PSSCH occasion in slot #2 comprising SL CSI-RS #2. The first SCI may indicate resources for transmission of a Nth SL RS, e.g., a Nth PSSCH occasion in slot #N comprising SL CSI-RS #N.

The first UE may transmit, to the second UE, a second SL RS (e.g., SL CSI-RS #2) using a second Tx beam (e.g., Tx Beam #2) via a second SL RS resource in a second slot (e.g., SL slot #2). For example, the first UE may transmit a second SCI in the second slot comprising an indication of beam sweeping/pairing. The second SCI may indicate whether the beam sweeping/pairing is based on inter-slot (e.g., multi-slot) SL RS transmission (as in the example of FIG. 34 and FIG. 32B) or intra-slot (e.g., single-slot) SL RS transmission (as in the example of FIG. 32A). In an example, the second SCI may indicate a destination layer 2 ID associated with the second UE (e.g., unicast L2 ID or (default) broadcast L2 ID). The second SCI may indicate an index of the second SL RS (e.g., SL CSI-RS #2) and/or the second beam (e.g., Tx Beam #2). The second SCI may comprise a field indicating a parameter associated with the second SL RS and/or the second beam (e.g., a second TCI state). The second SCI may indicate resources for transmission of the second SL RS, e.g., the second PSSCH occasion in slot #2 comprising SL CSI-RS #2. The second SCI may indicate resources for transmission of a third SL RS, e.g., a third PSSCH occasion in slot #3 comprising SL CSI-RS #3. The second SCI may indicate resources for transmission of a Nth SL RS, e.g., a Nth PSSCH occasion in slot #N comprising SL CSI-RS #N.

The first UE may transmit, to the second UE, an Nth SL RS (e.g., SL CSI-RS #2) using an Nth Tx beam (e.g., Tx Beam #N) via an Nth SL RS resource in an Nth slot (e.g., SL slot #N). For example, the first UE may transmit an Nth SCI in the Nth slot comprising an indication of beam sweeping/pairing. The Nth SCI may indicate a destination layer 2 ID associated with the second UE (e.g., unicast L2 ID or (default) broadcast L2 ID). The Nth SCI may indicate an index of the Nth SL RS (e.g., SL CSI-RS #N) and/or the Nth beam (e.g., Tx Beam #N). The Nth SCI may comprise a field indicating a parameter associated with the Nth SL RS and/or the Nth beam (e.g., an Nth TCI state). The Nth SCI may indicate resources for transmission of the Nth SL RS, e.g., the Nth PSSCH occasion in slot #N comprising SL CSI-RS #N.

The second UE may determine at least one of the SL RS based on the RSRP measurement of the at least one SL RS. For example, the RSRP of the at least one SL RS may be above a threshold. For example, the at least one SL RS may have highest RSRP value(s) of the plurality of SL RSs. The second UE may determine at least one Tx beam (e.g., best beam) of the first UE, wherein each of the at least one Tx beam is associated with a respective SL RS of the at least one SL RS. The second UE may transmit a beam report to the first UE indicating the at least one Tx beam and/or the at least one SL RS. The second UE may transmit the beam report in an SL MAC-CE (e.g., beam report or SL CSI report MAC-CE) via a PSSCH. The second UE may transmit the beam report via one or more PSFCHs (e.g., one PSFCH occasion per reported beam). As shown in FIG. 34, the second UE may transmit the beam report after a last slot of the beam sweeping (e.g., the slot comprising the last SL RS of the SL RS beam, slot #N). In an example, the second UE may transmit the beam report after a time offset (e.g., N_Offset symbols and/or slots) from a last symbol of slot #N. the time offset may be needed for processing/PSFCH/PSSCH preparation. The first UE may receive the beam report and identify/determine the at least one (best) Tx beams. The second UE may determine at least one (best) Rx beam associated with the at least one (best) Tx beam (e.g., resulting in a highest RSRP). The second UE may determine/establish at least one beam pair comprising at least one Tx beam and at least one Rx beam.

In an example, a pair of UEs may have established one or more beam pairs (e.g., wide beams) using a first beam sweeping procedure. The pair of UEs may further perform a second beam sweeping procedure for beam refinement, e.g., to identify narrower beam pair(s). For example, the first beam sweeping procedure may comprise transmission of first SL RSs using first RS resource set(s) using first beams. The first beams may be wide beams, e.g., based on first spatial filter settings that results in wide angular coverage of the first SL RSs. For example, the second beam sweeping procedure may comprise transmission of second SL RSs second RS resource set(s) using narrower beams (compared to the first beams). The second beams may be narrow beams, e.g., based on second spatial filter settings that results in narrow angular coverage of the second SL RSs.

Beam establishment or beam pair establishment/training or initial beam pairing (IBP) may refer to an initial procedure of identifying a pair of beams between the Tx UE and the Rx UE. Throughout this disclosure the term initial beam pairing (IBP) may refer to the beam sweeping/training procedure between a pair of UEs to establish a pair of TX/RX beams, e.g., before any (valid) beam or beam pair is identified. For example, the pair of UEs may perform IBP after a beam failure and/or link failure is detected. For example, the pair of UEs may perform IBP when first establishing a PC5 unicast link. The IBP may be performed before, during, or after the establishment of a PC5 unicast link. Performing IBP before/during the unicast link establishment may increase the coverage and reliability for the communication of DCR and DCA messages, and thus, increase the rate of successful unicast link establishment.

In an embodiment, a pair of Tx UE (e.g., a first UE, UE1) and Rx UE (e.g., a second UE, UE2) may perform IBP after the establishment of a PC5 unicast link with each other. For example, the pair of UEs may use a first beam (e.g., an omnidirectional beam, or a default beam, or a beam selected randomly or by UE implementation) for transmission/reception of the link establishment messages (e.g., DCR, DCA, security messages, etc.).

In an example, after/during the establishment of the PC5 unicast link, one of the UEs (e.g., the first UE or the second UE) may transmit to the other UE, RRC configurations (e.g., via RRCReconfigurationSidelink message) for unicast communication via the established PC5 link. The RRC configurations may comprise sidelink CSI configurations for the PC5 unicast link. The sidelink CSI configurations may indicate symbol(s) of a slot comprising SL CSI-RS. The sidelink CSI configurations may comprise a parameter (e.g., sl-LatencyBoundCSI-Report) indicating a latency bound of SL CSI report. The RRC configurations may comprise sidelink beam management configurations for the PC5 unicast link. For example, the beam management configurations may comprise parameters indicating reference signals (RSs) and/or resources/resource sets (e.g., time slots and/or symbols and/or frequency resource blocks) for transmission/reception of the reference signals (e.g., S-SSB and/or SL CSI-RS) for beam sweeping and/or beam reports (e.g., CSI report). For example, the beam management configurations of the PC5 unicast link may comprise parameters indicating resources and parameters for beam pairing (e.g., IBP or beam refinement) after the PC5 link establishment between the first UE and the second UE.

The beam management configurations may indicate one or more slots (e.g., periodic or aperiodic slots) and/or one or more symbols per slot for transmission of a plurality of reference signals for beam sweeping. Referring to FIG. 32A, the first UE may transmit the plurality of SL RSs via/across a plurality of symbols of a SL slot (e.g., intra-slot beam sweeping). Referring to FIG. 32B, the first UE may transmit the plurality of SL RSs via/across a plurality of SL slots (e.g., inter-slot beam sweeping). The beam management configurations may comprise a repetition filed, which may be set to indicate a Tx-side beam sweeping or an Rx-side beam sweeping.

The beam sweeping example in FIG. 34 may occur after the PC5 link is established (e.g., for IBP, or beam refinement, or beam failure recovery). The beam management configurations (indicated by unicast RRC signaling) may comprise parameters indicating resources comprising one or more symbols of one or more slots for transmission of the plurality of SL RSs for beam sweeping.

In the example of FIG. 34, after PC5 link establishment, the first UE (UE #1) may transmit a first SCI in a first slot (e.g., SL solt #1), or a first symbol of a slot, indicating transmission of a first SL RS (e.g., SL CSI-RS) of a plurality of SL RSs. The first SCI may comprise a field indicating a source Layer-2 ID of the first UE associated with the established PC5 unicast link, and a destination Layer-2 ID of the second UE (UE #2) associated with the established PC5 unicast link. The first UE may transmit the first SL RS in the slot or the first slot (e.g., via beam #1 or using a first spatial filter). The second UE may determine that the first SL RS is transmitted for beam management of the said PC5 unicast link, e.g., based on the destination Layer-2 ID in the first SCI matching the second UE's first destination Layer-2 ID and/or an indication of beam sweeping or RS transmission in the first SCI. The first UE may transmit a second SCI in a second slot (e.g., SL solt #2), or a second symbol of the same slot, indicating transmission of a second SL RS (e.g., SL CSI-RS) of the plurality of SL RSs. The second SCI may comprise a field indicating the source Layer-2 ID of the first UE associated with the PC5 unicast link, and the destination Layer-2 ID of the second UE associated with the PC5 unicast link. The first UE may transmit the second SL RS in the slot or the second slot (e.g., via beam #2 or using a second spatial filter). The second UE may determine that the second SL RS is transmitted for beam management of the PC5 unicast link, e.g., based on the destination Layer-2 ID in the second SCI matching the second UE's first destination Layer-2 ID and/or an indication of beam sweeping or RS transmission in the second SCI. The first UE may transmit an Nth SCI in an Nth slot (e.g., SL slot #N), or a Nth symbol of the same slot, indicating transmission of an Nth SL RS (e.g., SL CSI-RS) of the plurality of SL RSs. The first UE may transmit the Nth SL RS in the slot or the Nth slot (e.g., via beam #N or using a Nth spatial filter). The second UE may receive the plurality of SL RSs in the slot or across the N slot, and perform measurement (e.g., RSRP measurement) of the plurality of SL RSs.

The second UE may transmit a measurement report (e.g., a SL CSI report or a beam management report) to the first UE, e.g., after receiving the plurality of SL RSs or after slot #N. The measurement report may indicate one or more beams/SL RSs of the plurality of SL RSs. The measurement report may indicate a RSRP of the one or more SL RSs of the plurality of SL RSs. The measurement report may indicate an index/ID of the one or more SL RSs of the plurality of SL RSs, e.g., the one or more SL RSs with highest RSRP.

The unicast RRC signaling may further comprise sidelink CSI configurations indicating symbol(s) of a slot comprising SL CSI-RS. The sidelink CSI configurations may comprise a parameter (e.g., sl-LatencyBoundCSI-Report) indicating a latency bound of SL CSI report.

In an example, after establishment of the PC5 unicast link by transmission of DCR and reception of DCA, the first UE may send the PC5 RRC message comprising configuration parameters for communication via the PC5 unicast link. The configuration parameters comprise a parameter indicating a value of the latency bound of SL CSI report.

In an example, referring to FIG. 29, the second UE may start a timer or a window (e.g., sl-CSI-ReportTimer), e.g., if (e.g., in response to and/or after) the second UE (UE #2) determines to transmit (e.g., transmits) the sidelink CSI report. For example, the second UE may receive a SCI from the first UE (UE #1) comprising a CSI request field indicating request of CSI report. The SCI may indicate a PSSCH multiplexed with SL CSI-RS. The SCI may trigger a SL CSI report from the second UE. The second UE may start the timer/window (e.g., sl-CSI-ReportTimer) in response to receiving the SCI indicating the CSI report request. The first UE may start a second timer or a second window (e.g., sl-CSI-ReportTimer) that is the same as the timer or the window that the second UE starts, e.g., if (e.g., in response to and/or after) e.g., the first UE transmits the SCI indicating the trigger of the SL CSI report. The second UE may transmit the sidelink CSI report before the timer expires and/or while the timer is running. The SL latency bound in FIG. 29 may be a value/duration for the timer. For example, the timer may run during a time duration indicated by the SL latency bound.

In an example, referring to FIG. 29, the second UE, e.g., configured with a resource allocation mode 1, receives, from a base station, a grant (e.g., SL grant (e.g., DCI 3_0) in FIG. 29) indicating a sidelink resource that is used for transmission of the SL CSI report to the first wireless device and/or that is located (e.g., occurs) within the SL latency bound that starts from a starting time of the timers. The second UE may transmit, to the base station, a scheduling request to receive the grant (e.g., SL grant in FIG. 29), e.g., if the second UE does not have an SL grant transmit the SL CSI report. The base station may transmit the grant (e.g., SL grant in FIG. 29) to the second wireless device, e.g., in response to and/or after receiving the scheduling request from the second UE. For example, the second UE, e.g., configured with a resource allocation mode 2, may select a sidelink resource that is used for transmission of the SL CSI report to the first UE and/or that is located within the SL latency bound that starts from a starting time of the timers.

In an example, referring to FIG. 29, the second UE may transmit to the first UE, the sidelink CSI report via the sidelink resource (indicated by the SL grant in FIG. 29 or selected by the second UE configured with resource allocation mode 2), e.g., before the timer expires, while the timer is running, and/or within the latency bound that starts from a starting time of the timer. For example, if the timer runs for the time duration indicated by the latency bound, the second UE may determine that the timer expires. The second wireless device may cancel the triggered sidelink CSI report (e.g., may cancel a transmission of the sidelink CSI report), e.g., if (e.g., the second UE determines that) the timer expires and/or if the second UE does not transmit the sidelink CSI report before/until the timer expires, while the timer is running, and/or within the latency bound that starts from a starting time of the timer.

Sidelink (SL) scheduling request (SR) may refer to an SR that UE transmits, to a BS and via Uu link, to request for an SL grant. The SL SR may be for UEs operating with the SL resource allocation mode 1.

The SL SR may be for requesting SL shared channel (SL-SCH) resource for one of following transmissions: new transmission when triggered by the SL buffer status reporting (BSR); SL channel state information (SL-CSI) reporting; and SL discontinuous reception (SL-DRX) Command indication. Further, the SL SR may be used for requesting SL-SCH resources for a transmission of SL beam report and/or SL BFR to another UE or to the BS.

The UE who transmits the SL SR may receive, from the BS, a DCI (e.g., DCI format 3_0/3_1) comprising a SL grant after or in response to transmitting the SL SR. The DCI may indicate one or more SL-SCH resources for the UE's transmission.

Scheduling Request (SR) may be used for requesting SL-SCH resources for new transmission when triggered by the Sidelink and/or the SL-CSI reporting and/or SL-DRX Command indication and/or SL beam reporting and/or SL BFR indication.

The MAC entity of the UE may be configured with SR configurations to perform the SR procedure. For a sidelink logical channel and/or for SL-CSI reporting and/or for SL-DRX Command indication, at most one PUCCH resource for SR may be configured per UL BWP.

A UE may receive one or more RRC messages (e.g., RRC reconfiguration message, RRC setup message, and/or RRC resume message) comprising configuration parameters of one or more serving cells (e.g., CellGroupConfig IE). The configuration parameters may be used to configure (add or modify) the UE with a serving cell of the one or more serving cells (e.g., ServingCellConfig for SpCellConfig and/or SCellConfig via CellGroupConfig IE), which may be the SpCell or an SCell of an MCG or SCG. The parameters may be UE specific and/or cell specific.

The configuration parameters of a cell (e.g., ServingCellConfig) may comprise one or more uplink BWP configurations indicating one or more UL BWPs of the cell. The one or more UL BWPs may comprise PUCCH resources for PUCCH transmissions via the cell. For example, the one or more uplink BWP configurations may comprise PUCCH configuration parameters (e.g., via pucch-ConfigCommon and/or pucch-Config). The PUCCH configuration parameters may indicate PUCCH resources (e.g., via PUCCH-Resource). For example, for each PUCCH resource, the PUCCH configuration parameters may indicate: a PUCCH resource identifier (e.g., via PUCCH-ResourceId); one or more frequency resources (e.g., via a startingPRB); frequency hopping configuration (e.g., intraSlotFrequencyHopping and/or secondHopPRB); and/or a PUCCH format (e.g., PUCCH format 0 or PUCCH format 1 or PUCCH format 2 or PUCCH format 3 or PUCCH format 4). For each PUCCH format, the PUCCH configuration parameters may indicate one or more slots and one or more symbols per slot, e.g., via a starting symbol index (startingSymbolIndex) and/or a number of symbols per slot (nrofSymbols).

The PUCCH configuration parameters may comprise one or more scheduling request (SR) resource configurations (e.g., SchedulingRequestResourceConfig). An SR resource configuration (e.g., SchedulingRequestResourceConfig IE) may determine physical layer resources on PUCCH where the UE may send the scheduling request (e.g., dedicated SR (D-SR)). The SR resource configuration may indicate: an SR resource identifier (e.g., via SchedulingRequestResourceId) to identify scheduling request resources on PUCCH; a corresponding SR ID as the ID of the SR configuration (e.g., SchedulingRequestConfig) that uses this SR resource; an SR periodicity and offset in number of symbols and/or slots; and/or a PUCCH resource ID of the PUCCH resource in which the UE shall send the corresponding scheduling request. The PUCCH resource may be configured in the same UL BWP and serving cell (via PUCCH-Resource in PUCCH-Config) as this SR resource configuration (SchedulingRequestResourceConfig). The network may configure a PUCCH resource of a first PUCCH format for SR (e.g., PUCCH-format0 or PUCCH-format1).

The configuration parameters of the one or more serving cells (CellGroupConfig IE) may be used to configure a master cell group (MCG) or secondary cell group (SCG) (e.g., MAC-CellGroupConfig via CellGroupConfig IE). A cell group may comprise of one MAC entity, a set of logical channels with associated RLC entities and of a primary cell (SpCell) and one or more secondary cells (SCells). The configuration parameters of the one or more serving cells of the cell group may comprise MAC configuration parameters applicable for the entire cell group. The MAC configuration parameters may comprise/indicate DRX configurations and/or BSR configurations and/or scheduling request (SR) configurations for the cell group.

The SR configurations may comprise a list of scheduling request (SR) configurations (e.g., schedulingRequestToAddModList via SchedulingRequestConfig) for one or more cells (e.g., a cell group). For each SR configuration of the SR configurations in the list, the SR configurations may indicate a respective SR identifier (e.g., SchedulingRequestId=0,1, . . . ,7) and/or an SR prohibit timer (e.g., sr-ProhibitTimer) and/or a maximum number of SR transmissions (e.g., sr-TransMax).

The SR ID may be used to modify a SR configuration and to indicate (e.g., in LogicalChannelConfig) the SR configuration to which a logical channel is mapped and to, and/or to indicate (e.g., in SchedulingRequestresourceConfig) the SR configuration for which a scheduling request resource is used.

A UE may receive one or more messages (e.g., SIB12 and/or RRC setup/resume/reconfigurations message) comprising sidelink configuration parameters (e.g., SL-ConfigCommonNR and/or SL-ConfigDedicatedNR).

The sidelink configurations may comprise one or more sidelink RLC bearer configurations (e.g., SL-RLC-BearerConfig) that specify the SL RLC bearer configuration information for NR sidelink communication. A SL RLC bearer configuration may indicate an index for the SL RLC bearer configuration (e.g., SL-RLC-BearerConfigIndex) and/or an index of a SL radio bearer (SL DRB) configuration, which is corresponding to the RLC bearer (e.g., sl-ServedRadioBearerconfiguration). The SL RLC bearer configuration may comprise a sidelink logical channel configuration (e.g., sl-MAC-LogicalChannelConfig) to configure MAC SL logical channel parameters. The sidelink logical channel configuration may indicate for the respective logical channel: a sidelink logical channel priority (sl-Priority); an ID of the sidelink logical channel group which the sidelink logical channel belongs to (e.g., sl-LogicalChannelGroup or LCG ID); and/or the scheduling request configuration applicable for this sidelink logical channel (e.g., via SR ID or SchedulingRequestId).

The UE may determine, for each logical channel, a corresponding SR configuration based on the SR ID indicated by the sidelink logical channel configuration of the respective logical channel. The sidelink configurations may comprise PHY, MAC, and RLC configuration for sidelink communications, indicating a scheduling request configuration applicable for Sidelink CSI Reporting MAC CE and Sidelink DRX Command MAC CE (e.g., via sl-CSI-SchedulingRequestId).

The UE may determine, for SL CSI reporting and/or SL DRX command, a corresponding SR configuration based on the SR ID indicated by the sidelink configurations.

The UE may use Scheduling Request (SR) for requesting SL-SCH resources for new transmission when triggered by the Sidelink BSR or the SL-CSI reporting or SL-DRX Command indication.

The SR configuration of the logical channel that triggered the Sidelink BSR may be considered as corresponding SR configuration for the triggered SR. The value of the priority of the triggered SR may correspond to the value of priority of the logical channel that triggered the SR. Each sidelink logical channel may be mapped to zero or one SR configuration, which may be configured by RRC.

If the SL-CSI reporting procedure is enabled by an RRC parameter, the SL-CSI reporting may be mapped to one SR configuration for all PC5-RRC connections of the UE. For example, the UE may be configured with one SR configuration to use for requesting resources for SL CSI reporting and/or SL DRX command indication to one or more destination UEs corresponding to one or more sidelink unicast links/communications. The SR configuration of the SL-CSI reporting triggered may be considered as corresponding SR configuration for the triggered SR. The value of the priority of the triggered SR triggered by SL-CSI reporting may correspond to the value of the priority of the Sidelink CSI Reporting MAC CE. The SR configuration of the SL-CSI reporting may be considered as corresponding SR configuration for the triggered SR of SL-DRX Command indication triggered. The value of the priority of the triggered SR triggered by SL-DRX Command indication may correspond to the value of the priority of the Sidelink DRX Command MAC CE.

All pending SR(s) triggered according to the Sidelink BSR procedure prior to the MAC PDU assembly may be cancelled and/or each respective SR prohibit timer (e.g., sr-ProhibitTimer) may be stopped when the MAC PDU is transmitted and this PDU includes an SL-BSR MAC CE which contains buffer status up to (and including) the last event that triggered a Sidelink BSR prior to the MAC PDU assembly.

All pending SR(s) triggered according to the Sidelink BSR procedure may be cancelled and/or each respective SR prohibit timer (e.g., sr-ProhibitTimer) may be stopped when the SL grant(s) can accommodate all pending data available for transmission in sidelink.

The pending SR triggered according to the SL-CSI reporting for a destination may be cancelled and/or each respective SR prohibit timer (e.g., sr-ProhibitTimer) may be stopped when the SL grant(s) can accommodate the Sidelink CSI Reporting MAC CE when the SL-CSI reporting that has been triggered but not cancelled or when the triggered SL-CSI reporting is cancelled due to latency non-fulfilment. The pending SR triggered according to the SL-DRX Command indication for a destination may be cancelled and each respective SR prohibit timer (e.g., sr-ProhibitTimer) may be stopped when the SL grant(s) can accommodate the Sidelink DRX Command MAC CE when the SL-DRX Command indication that has been triggered but not cancelled. All pending SR(s) triggered by either Sidelink BSR or Sidelink CSI report or Sidelink DRX Command indication may be cancelled, when RRC configures Sidelink resource allocation mode 2.

In an example, the UE may determine for a sidelink Buffer Status reporting procedure that at least one SL-BSR has been triggered and not cancelled. For example, a Regular SL-BSR may have been triggered. The UE may trigger a SR if the sidelink Buffer Status reporting procedure determines that at least one SL-BSR has been triggered and not cancelled and/or if there is no UL-SCH resource available for a new transmission. The UE may trigger a SR if a set of Subcarrier Spacing index values (e.g., in sl-AllowedSCS-List, if configured) for the logical channel that triggered the SL-BSR, does not include the Subcarrier Spacing index associated to the UL-SCH resources available for a new transmission. The UE may trigger a SR if sl-MaxPUSCH-Duration, if configured for the logical channel that triggered the SL-BSR, is smaller than the PUSCH transmission duration associated to the UL-SCH resources available for a new transmission.

The Sidelink Channel State Information (SL-CSI) reporting procedure may be used to provide a peer UE with sidelink channel state information. The MAC entity of the UE may maintain a CSI report timer (e.g., sl-CSI-ReportTimer) for each pair of the Source Layer-2 ID and the Destination Layer-2 ID corresponding to a PC5-RRC connection. sl-CSI-ReportTimer is used for an SL-CSI reporting UE to follow the latency requirement signalled from a CSI triggering UE. The value of sl-CSI-ReportTimer is the same as the latency requirement of the SL-CSI reporting in sl-LatencyBoundCSI-Report configured by RRC. The MAC entity of the UE may, for each pair of the Source Layer-2 ID and the Destination Layer-2 ID corresponding to a PC5-RRC connection which has been established by upper layers: start the CSI report timer if the SL-CSI reporting has been triggered by an SCI and not cancelled and/or if the sl-CSI-ReportTimer for the triggered SL-CSI reporting is not running. The UE may cancel the triggered SL-CSI reporting if the sl-CSI-ReportTimer for the triggered SL-CSI reporting expires.

The UE may instruct the Multiplexing and Assembly procedure to generate a Sidelink CSI Reporting MAC CE, e.g., if the MAC entity of the UE has SL resources allocated for new transmission and/or the SL-SCH resources can accommodate the SL-CSI reporting MAC CE and its subheader as a result of logical channel prioritization. The UE may stop the CSI report timer (sl-CSI-ReportTimer) for the triggered SL-CSI reporting. The UE may cancel the triggered SL-CSI reporting. The UE may trigger a SR if the SL-CSI reporting has been triggered by an SCI and not cancelled and/or if the MAC entity of the UE has been configured with Sidelink resource allocation mode 1.

The UE transmitting SL-SCH Data may keep aligned with its intended UE receiving the SL-SCH Data regarding the SL DRX Active time. The MAC entity of the UE may, for each pair of the Source Layer-2 ID and the Destination Layer-2 ID corresponding to each PC5-RRC connection which has been established by upper layers, instruct the Multiplexing and Assembly procedure to generate a Sidelink DRX Command MAC CE, e.g., if the SL DRX Command indication has been triggered by the UE and/or if the MAC entity has SL resources allocated for new transmission and/or the SL-SCH resources can accommodate the SL DRX Command MAC CE and its subheader as a result of logical channel prioritization. The UE may cancel the triggered SL DRX Command indication. The UE may trigger a SR if the SL DRX Command indication has been triggered by the UE and/or if the MAC entity has been configured with Sidelink resource allocation mode 1.

The BS may determine a grant for the UE in response to receiving the SR from the UE. The BS may transmit a DCI comprising the grant to the UE in response to or after receiving the SR. For example, the UE may receive a DCI (e.g., DCI format 3_0) from the BS comprising a SL grant, e.g., after or in response to transmitting a SR. For example, the UE may transmit the SR using a SR configuration corresponding to SL CSI reporting and/or SL DRX command indication and/or SL BSR and/or SL beam reporting and/or SL BFR indication. The SL grant may indicate one or more PSSCH resources (time and frequency resource for PSSCH transmission).

The UE may transmit a MAC CE using the one or more PSSCH resources indicated by the SL grant or the DCI. For example, the UE may generate and/or transmit a SL CSI report MAC CE, using the SL grant, to a destination UE. For example, the UE may generate and/or transmit a SL DRX command MAC CE, using the SL grant, to a destination UE. For example, the UE may generate and/or transmit a SL beam report MAC CE, using the SL grant, to a destination UE. For example, the UE may generate and/or transmit a SL BFR MAC CE, using the SL grant, to a destination UE. For example, the UE may generate and/or transmit, using the SL grant, a MAC PDU comprising data from one or more SL logical channels to a destination UE.

In existing technologies, sidelink transmissions and/or receptions may be beam-formed (e.g., directional), using spatial domain transmit/receive filters. For sidelink beam management, transmit (TX) beam(s) training and/or receive (RX) beam(s) training may be performed. For example, a UE may identify spatial related information (e.g., SL TCI, QCL, beam ID, etc.) for sidelink communication on a sidelink unicast link. The UE may perform sidelink beam measurement and reporting (e.g., periodically, semi-persistently, and/or aperiodically). For example, a UE may indicate SL beam(s) and/or beam switching. For example, a UE may detect and report a beam failure.

A pair of UE (a first UE and a second UE) may perform beam-formed sidelink communications with each other. For example, the pair of UE may have a PC5 unicast link configured with sidelink beam management. The pair of UE may perform beam pairing (e.g., initial beam pairing) to determine a pair of beams (a first TX beam of the first UE and a first RX beam of the second UE) for the sidelink communication with each other. For example, the pair of beam may result in a high/highest RSRP. After initial beam pairing, SL beam refinement (e.g., switching to narrower beams) may be performed to adapt to changing conditions or data rate requirements.

The first UE may have M narrow beams (a1, a2, . . . , aM) available for transmission within its selected panel and the second UE may have N narrow beams (b1, b2, . . . , bN) available for reception within its selected panel. In order to determine the best narrow beam combination (a′, b′) out of M x N possible combinations, the UEs may perform measurements on reference signals (RS) transmitted/received using each of the available narrow beam pairs. For example, the first UE may transmit SL CSI-RS sequentially on each of its M narrow beams (a1, a2, . . . , aM), while the second UE measures RSRP on each of its N narrow beams (b1, b2, . . . , bN). Such beam refinement may require up to M x N SL CSI-RS to be transmitted/measured.

A UE may have a TX/RX beam correspondence capability, e.g., the UE is able to determine a TX beam for [SL] transmission based on the UE's [SL] measurement on one or more RX beams. In this case, the first UE may configure SL CSI-RS resources for transmission (e.g., within a single slot) of a first burst (r1, r2, . . . , rN) of SL CSI-RS using a fixed, wide TX beam (e.g., the widest attainable beam on the appropriate panel). This first SL CSI-RS burst (r1, r2, . . . , rN) is used for RX beam sweeping at the second UE to determine a preferred RX beam (b′) among the second UE's RX beams (b1, b2, . . . , bN). In a subsequent step, UE B may transmit a second (single-slot) SL CSI-RS burst (s1, s2, . . . , sM) back to the first UE using the preferred RX beam (b′) as a preferred TX beam (i.e., exploiting TX/RX beam correspondence). This second SL CSI-RS burst (s1, s2, . . . , sM) is used for RX beam sweeping at the first UE to determine a preferred RX beam (a′) among UE A's RX beams (a1, a2, . . . , aM), which is then used as preferred TX beam by the first UE (again exploiting TX/RX beam correspondence).

As a result of relative motion between the SL UEs, UE rotation or changes in the surrounding environment (e.g., an object obstructing the LOS, a strong reflector (dis) appearing, etc.), the best beam pair at a given time may no longer be best at a later time. Thus, SL beams need to be tracked and maintained over time. In order to maintain the optimal beam pair in a dynamic environment (e.g., V2X), periodic SL CSI-RS may be configured with a periodicity that is sufficiently short (e.g., 100 ms) to deal with the expected rate of change. However, performing beam measurements too frequently may incur significant overhead and power consumption. An alternative (or complementary) strategy is to trigger beam measurements on demand (aperiodically), e.g., based on a condition being fulfilled. For example, having established an initial beam pair (a′, b′), the pair of UEs may monitor the beam quality over time (e.g., based on SL CSI-RS), and only trigger measurements for other beams in case the beam quality (e.g., RSRP) degrades beyond a threshold.

A pair of UEs (UE1 and UE2) in a unicast link, may select UE1's transmit beam and UE2's corresponding receive beam (e.g., based on RS/beam sweeping at UE1 and/or UE2), e.g., for PSCCH/PSSCH transmission/reception and PSFCH transmission/reception. A UE may transmit SL CSI-RS for beam maintenance (e.g., beam sweeping). The SL CSI-RS may be standalone SL CSI-RS or non-standalone SL CSI-RS. The SL CSI-RS transmission may be periodic and/or semi-persistent SL CSI-RS transmissions. SL CSI-RS transmissions may be with or without repetition on transmit beams. The non-standalone sidelink CSI-RS transmissions may use the same or different transmit beam as accompanying data. The UE may use multiple transmit beams for non-standalone sidelink CSI-RS transmission in the same slot. The same or different transmit beams may be used in the same slot of standalone sidelink CSI-RS transmissions.

A UE may transmit a sidelink beam report (e.g., [enhanced] CSI report). The beam report may comprise one or more information fields indicating one or more of the following: Beam indication (e.g., CSI-RS resource index (CRI)); L1-RSRP; and L1-SINR. In an example, a UE may perform beam maintenance without any beam reporting. The container(s) of sidelink beam reporting for beam maintenance may be a SL PHY layer signal (e.g., PSFCH, SCI) and/or a SL MAC CE and/or a PC5-RRC signaling over Uu link (e.g., UCI).

For beam reporting using PSFCH in beam maintenance, there may be an association rule between PSFCH for beam reporting and sidelink CSI-RS (either standalone or non-standalone). PSFCH may carry multiple beam reporting bits (e.g., using a new PSFCH format and/or using PSFCH format 0 by exploring the relationship with frequency and/or code domain resources). PSFCH may carry one beam reporting bit. Beam reporting and sidelink HARQ ACK may be reported together, e.g., in a same or different PSFCH.

For beam reporting using sidelink MAC CE in beam maintenance, sidelink CSI reporting window may be reused for the association between sidelink beam reporting and sidelink CSI-RS resources. Beam reporting using sidelink MAC CE may be periodic, aperiodic and/or semi-persistent. A UE may be incapable of simultaneous transmitting or receiving PSCCH/PSSCH/PSFCH using different beams.

In NR Uu, QCL Type-D is defined as the spatial RX parameter to indicate beams. Beam indication of PDSCH and PDCCH is achieved by indicating a TCI (Transmission Configuration Indication) state, which contains/indicates RS IDs (e.g., SSB or CSI-RS ID) and the associated QCL type. UEs can be indicated to switch their RX beam according to the beam indication from the gNB.

Beam indication in SL, e.g., for beam switching by TX UE indication, may be designed based on the Uu TCI framework by simply indicating the S-SSB index and/or SL CSI-RS resource ID for the beam indication by applying QCL Type-D. SL TCI states may be configured by PC5-RRC and/or MAC-CE, and then indicated by using the SCI or MAC-CE as a beam indication container. Considering the necessary beam switching time requirement and the PSCCH processing time, PSCCH and associated PSSCH may have the same TCI state.

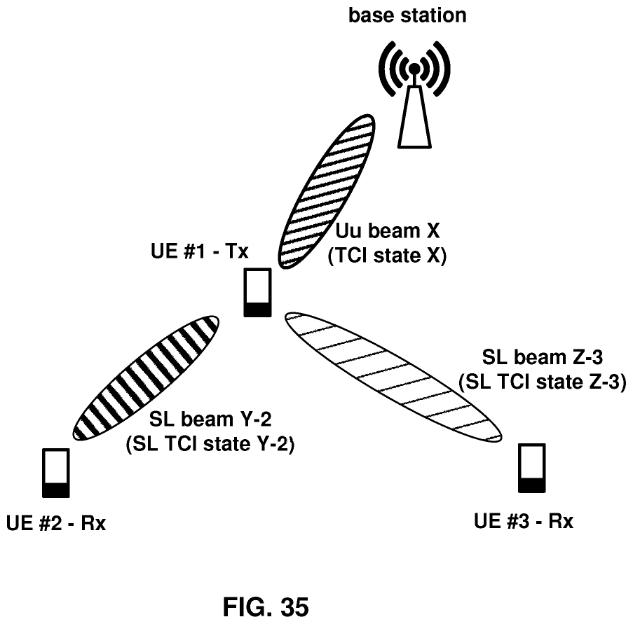

FIG. 35 shows an example of beam indication in Uu and sidelink. The base station may indicate to the first UE (UE #1) Uu beam X for DL and/or UL communications. For example, Uu beam X may be associated with a first DL RS (e.g., SSB or CSI-RS). For example, the BS may transmit configuration parameters indicating TCI state X to correspond to the first DL RS. Throughout this disclosure, Uu beam X and TCI state X may be used interchangeably. For example, for a DL reception scheduled/configured with TCI state X, UE may receive the DL reception using Uu beam X. For example, UE may use a same spatial domain reception (RX) filter for receiving the DL RS and the DL reception, wherein both the DL RS and the DL reception are associated with (mapped to, indicated by) TCI state X. For example, for a UL transmission scheduled/configured with TCI state X, UE may transmit the UL transmission using Uu beam X. For example, UE may use a same spatial domain filter for transmitting the UL transmission and receiving the DL RS, wherein both the DL RS and the UL transmission are associated with (mapped to, indicated by) TCI state X. For example, based on beam correspondence, the UE may use the same spatial domain filter for TX beam X and RX beam X, wherein both TX beam X and RX beam X are associated with the same DL RS.

The unified TCI framework achieves reduction in beam management latency and overhead and a single TCI state indication can be applied to DL (PDCCH/PDSCH) and UL (PUSCH/PUCCH/SRS). A simplified QCL/TCI framework may be enough for SL FR2.

The sidelink beam indication may be sent by transmitter UE or receiver UE.

When receiver UE (e.g., the UE receiving SL CSI-SRs transmitted by the other UE) selects transmitter UE's transmit beam, it notifies transmitter UE about the selected transmit beam (e.g., a SL CSI-RS). In this case, receiver UE sends sidelink beam indication to transmitter UE. The content of the sidelink beam indication may be a first sidelink TCI state (associated with the selected SL CSI-RS). The transmitter UE may apply the first SL TCI state to its transmissions (e.g., PSCCH/PSSCH transmissions) to the receiver UE. This implies the beam of PSCCH/PSSCH transmission is QCL-ed with the beam of sidelink CSI-RS transmission. Subsequently, the beam of PSCCH/PSSCH reception is aligned with the beam of sidelink CSI-RS reception.

When transmitter UE (the UE transmitting SL CSI-RSs) selects its transmit beam based on the reported sidelink RSRP measurements, the transmitter UE may indicate its selected transmit beam to receiver UE so that the associated receive beam is applied at receiver UE accordingly.

In the example of FIG. 34, once beam sweeping is performed and/or beam report is transmitted/received, the first UE (or the second UE) may configure the sidelink TCI state configurations for the PC5 unicast link between the first UE and the second UE. The first UE (or the second UE) may transmit to the second UE (or the first UE) a PC5 RRC message comprising the sidelink TCI state configurations. The SL TCI state configurations may associate one or more SL reference signals (e.g., SL CSI-RS) with a corresponding quasi-colocation (QCL) type. The SL TCI state configurations may associate one or more SL reference signals (e.g., SL CSI-RS) of the corresponding PC5 unicast link with a corresponding quasi-colocation (QCL) type for the SL transmission/receptions on the respective PC5 unicast link.

The contents of sidelink TCI state configuration may include at least sidelink TCI state ID, and QCL-related information. The QCL-related information may include sidelink CSI-RS resource index and QCL type. QCL type-D may be supported for sidelink beam maintenance. Here, the QCL reference signal is the root reference signal used for beam management.

In NR Uu downlink beam management, the transmit beam is determined by gNB, based on UE's reporting. This transmit beam decision is indicated to UE, e.g., via MAC CE for PDCCH (or CORESET) transmit beam or DCI for PDSCH transmit beam. The TCI/QCL framework is used for the beam indication. The beam indication in sidelink may be carried by sidelink MAC CE, and the indicated transmit beam may be applies to both PSCCH and PSSCH.

The receiver UE or the transmitter UE may select the sidelink beam pair. The selected sidelink beam pair may be indicated to the peer UE. Both transmitter UE and receiver UE need to synchronize on the timing of applying the new sidelink beam pair. The sidelink beam indication may be sent via MAC CE over PSSCH. The ACK for the sidelink beam indication may be used as a reference time to determine the activation timing of indicated beam pair. Specifically, both transmitter UE and receiver UE start to apply the new beam pair a certain time duration after the ACK for sidelink beam switching indication. The indicated beam is valid until a new beam indication is transmitted.

For beam indication in sidelink beam maintenance, sidelink TCI state may be configured. Sidelink TCI state may at least include/indicate sidelink TCI state ID, sidelink CSI-RS resource and/or Tx/Rx spatial filter related information. SL TCI state may indicate QCL types. PSCCH and associated PSSCH may have the same TCI state. The beam indication may be via sidelink CSI-RS resource. Beam indication container may be a SCI, and/or a sidelink MAC CE and/or PC5-RRC. A UE may apply an activation time of indicated beam. Beam indication may be on Uu interface in mode 1.

Each Sidelink TCI-State may be defined as parameters for configuring a quasi co-location relationship between sidelink CSI-RS and the DM-RS ports of the PSSCH, the DM-RS port of PSCCH or the CSI-RS port(s) of a SL CSI-RS resource.

As shown in the example of FIG. 35, the first UE (UE #1) may have two sidelink PC5 unicast links with two different UEs, e.g., the second UE (UE #2) and the third UE (UE #3).

The first UE and the second UE may have a first PC5 unicast link. The first UE (or the second UE) may transmit a first PC5 RRC message to the second UE (or the first UE) comprising first configuration parameters of the first PC5 unicast link. The first configuration parameters of the first PC5 unicast link may comprise SL CSI-RS configuration parameters, indicating resources for transmission/reception of first SL CSI-RSs and/or beam measurement and beam report (e.g., SL CSI report) for the first PC5 unicast link. The first configuration parameters of the first PC5 unicast link may comprise first SL TCI state configurations indicating first SL TCI states associated with QCL information based on the first SL CSI-RSs. The first UE and the second UE may perform beam paring by sending the first SL CSI-RSs based on the first configuration parameters of the first PC5 unicast link. The first UE and the second UE may determine a first SL beam (e.g., beam pair) Y−2 associated with a first SL CSI-RS of the first SL CSI-RSs, e.g., having a highest RSRP among the first SL CSI-RSs. The first UE (or the second UE) may determine a first SL TCI state Y−2 associated with the first SL beam (beam pair) Y−2 for SL communications via the first PC5 unicast link. The first UE (or the second UE) may transmit a control signal to the second UE (or the first UE) indicating the first TCI state Y−2 for SL communications via the first PC5 unicast link. The first UE and the third UE may have a second PC5 unicast link. The first UE (or the third UE) may transmit a second PC5 RRC message to the third UE (or the first UE) comprising second configuration parameters of the second PC5 unicast link. The second configuration parameters of the second PC5 unicast link may comprise SL CSI-RS configuration parameters, indicating resources for transmission/reception of second SL CSI-RSs and/or beam measurement and beam report (e.g., SL CSI report) for the second PC5 unicast link. The second configuration parameters of the second PC5 unicast link may comprise second SL TCI state configurations indicating second SL TCI states associated with QCL information based on the second SL CSI-RSs. The first UE and the third UE may perform beam paring by sending the second SL CSI-RSs based on the second configuration parameters of the second PC5 unicast link. The first UE and the third UE may determine a second SL beam (e.g., beam pair) Z−3 associated with a second SL CSI-RS of the second SL CSI-RSs, e.g., having a highest RSRP among the second SL CSI-RSs. The first UE (or the third UE) may determine a second SL TCI state Z−3 associated with the second SL beam (beam pair) Z−3 for SL communications via the second PC5 unicast link. The first UE (or the third UE) may transmit a control signal to the third UE (or the first UE) indicating the second TCI state Z−3 for SL communications via the second PC5 unicast link.

In existing technologies, sidelink mode 2 resource allocation assumes omni-directional TX/RX antenna, and thus the impact of beam management is not considered. If directional antenna is used, the sensing results including both decoded SCI and S-RSRP measurement may be greatly impacted by the RX beam used by the UE. The performance of mode 2 resource allocation may be greatly impacted by the beam management.

Mode 1 and mode 2 resource allocation schemes are essential features to avoid collisions, maintain QoS and in general, cater to the advanced use cases in NR SL. In SL FR2, existing procedures may not work with the introduction of beams. For example, sensing-based resource selection can be different since both TX and RX UEs use directional beams, which may lead to directional sensing results and resource sets. Therefore, mode 1 and/or mode 2 resource allocation schemes may be enhanced in SL FR2. Beam-based sidelink resource allocation may be employed in sidelink (e.g., in FR2).

For sensing based resource allocation in mode 2, the sensing results are used to predict the interference status in the candidate resource. When directional beam is used in FR2, the sensing result may be used to predict the interference in future reserved resource if the sensing RX beam is correlated to the intended transmit beam. For example, if the sensing RX beam can cover or have the same spatial relationship as the intended TX beam, the sensing results may represent the potential interference in reserved resource. If the sensing RX beam is independent of the intended TX beam, it is difficult to say that the sensing results can be used to predict the interference in the future reserved resource. Therefore, when directional beam is used, different sensing beam may be used in resource selection given different intended TX beam for the data transmission. For a candidate resource in a candidate slot of the resource selection window, the candidate resource can be selected only if the sensing beam in the corresponding set of sensing slots can cover the intended TX beam. Given a candidate slot and the intended TX beam, a set of sensing slot may be defined within which a SL reservation reserves a resource in the candidate slot, and the sensing RX beam shall have a predefined relationship with the intended TX beam.

A UE may determine spatial TX filter that can be used based on spatial RX filter used for sensing related to SL grant generation. A SL grant is generated before the UE performs the LCP procedure. If the spatial TX filter supported in the generated SL grant does not cover the spatial TX filter of the LCH data, the UE may not transmit the corresponding LCH data. Therefore, the UE may filter LCH data that can use the spatial TX filter covered by the selected sidelink grant and select the highest priority destination among them. Otherwise, if the UE has LCH data that cannot use the spatial TX filter covered by the selected sidelink grant for all data in the logical channels, the UE may perform the sidelink grant generation procedure again by performing different RX spatial filter-based sensing.

When considering sidelink networks operating in the FR2 frequency range in particular, there are potential operational differences between mode 1 and mode 2 in areas besides resource allocation. For example, mode 1 operations can present advantages over mode 2 in areas such as initial beam pairing and beam maintenance. In these circumstances, the gNB may be able to orchestrate the beam management procedures, reusing concepts from NR Uu. In NR Uu, there are mechanisms and procedures in place for beam management between gNBs and UEs. Although the sidelink is a link between two UEs, there may be mechanisms from NR Uu that mode 1 operations could reuse if the gNB assists in beam management between in-range UEs. Furthermore, the gNB could assist in the beam pairing operation by informing one UE that another UE wants to pair with it i.e., the gNB acts as an intermediary. The responsibilities of beam pairing coordination and beam maintenance do not have to fall solely on the UEs themselves.

Regarding resource allocation in SL FR2 networks, where beam selection is a key factor, the gNB is responsible for resource allocation in mode 1 operations. However, in mode 2, where UEs autonomously select resources, resource contention can involve UEs that are outside of one another's coverage range. Within the FR2 frequency range, the directivity of beams can cause challenges from a resource allocation standpoint in mode 2 situations. Furthermore, spatial reuse, where multiple pairs of devices can communicate simultaneously, is a possibility with FR2's use of directional links. Since gNBs have a comprehensive view of link connections among the in-range UEs in mode 1 operations, spatial reuse coordination may be advantageous in mode 1 operations over mode 2 operations where UEs are outside of gNB coverage range. Mode 2 networks provide a degree of agility and flexibility that may not be possible for mode 1. Given the mobility of UEs/vehicles in V2X scenarios, connections to gNBs may be lost at certain times, or networks in general may be in locations where cellular infrastructure is not present. Furthermore, the centralized resource allocation approach in mode 1 may imply delays for individual nodes since the gNB manages sidelink resource allocation, and certain areas of a cell may present more complex resource allocation challenges than other areas. In mode 2, UEs control their own resource allocation processes and therefore may gain access to sub-channels sooner than in mode 1, where they have to wait for sidelink resource coordination and direction from the gNB.

In mode 1, gNB is the center scheduler for resource allocation. The gNB may schedule proper resources including transmit beams for different TX UE's transmissions to a same RX UE. For mode 1, beam management may be performed by the network or by the UE, or a combination of both. For example, which entity decides when to transmit reference signals for beam measurements, and which entity decides on the beams to use. These operations may be done by the gNB and/or by a SL UE. For example, having beam decisions taken by the network, may allow the network to schedule overlapping UEs that have non-interfering spatial beams, however it increases beam indication and application latency. gNB may perform the PC5 beam selection and indicate the selected beam to TX UE, then TX UE indicates the beam to RX UE. For mode1 resource allocation, gNB may be aware of the beam level resource state in PC5 interface and support PC5 beam indication in DCI.

In mode 1, the base station may determine a TX beam for a sidelink transmission. For example, the TX UE may report beam related measurement result to the base station (BS). The BS may determine the beam paired to each destination UE. This option may be used for UE using mode 1 resource allocation. When scheduling the SL grant, the BS may indicate the associated SL beam. If the UE uses mode 2 in RRC_CONNECTED, the transmission resource is selected by UE. So, the BS may not determine the TX beam. But the TX resource pool is provided by the BS. The BS may consider the selected beam to decide the TX resource pool. So, the TX UE may report the selected TX beam in mode 2.

After beam-pairing, each destination may be paired with a different TX beam. In mode 1, scheduled SL grant may be associated with a specific SL beam. After acquiring SL grant, TX UE may put the data from the destination UE with matched beam into the SL grant. For example, the resource allocation from gNB may be accompanied with transmit beam information.

A BS may schedule proper resources including transmit beams for different TX UE's transmissions, e.g., to a same RX UE or different RX UEs.

The beam report may convey the CSI-RS resource indicator (CRI) and/or the L1-RSRP measurement. The L1-SINR may be further included in the beam report. The beam measurement report may include 4 pairs of CRI and L1-RSRP using differential reporting, where the CRI and L1-RSRP of strongest beam is reported, and differential reporting is used for remaining 3 beams. In mode 1, where the resource allocation is made by the network, it may be beneficial for network to receive the beam measurement report. Therefore, L1/PHY control signaling (UCI) and/or MAC CE signaling on the Uu interface may be used for beam measurement report.

The UE may receive RRC messages comprising configuration parameters indicating TCI states. The UE may receive PDCCH and/or PDSCH comprising MAC CE that activate TCI state codepoints. The UE may receive L1 control (DCI) that indicate a TCI state codepoint of the activated TCI state codepoints.

The transmitting UE (Tx UE) may transmit a beam reference signal (CSI-RS or PSSCH/PSCCH DMRS) as per the configured configurations and expect a feedback of beam indication parameters from the receiving UE (Rx UE) to select the best beam(s). The beam indication may be performed at least over a MAC-CE signaling, SCI and/or a feedback channel (PSFCH). It may also be indicated on UCI for the in-coverage UEs (mode-1 configured UEs). For example, in sidelink beam management for in-coverage UEs (more 1), the uplink control information (UCI) can be used to report the beam. The BS may allocate resources to the Rx UE in mode-1 resource allocation for the SL beam management report. In an example, the BS may allocate resources to the Tx UE in mode-1 resource allocation for the SL beam management report. For example, the Tx UE may forward to beam report that it receives from the Rx UE to the BS via the allocated resources.

In sidelink beam management, the BS may use MAC-CE and/or DCI over Uu link in mode-1 configuration to indicate the new TCI state to receiver UE and/or the transmitter UE.

For beam maintenance for SL UEs operating in mode 1, the BS may assist for beam maintenance and help to coordinate beams among SL UEs. SL UEs may benefit from scheduling of non-interfering beams by the BS, which reduces signaling efforts among SL UEs via PC5. For this, UCI signaling over Uu as a container format for beam reporting may be used.

Regarding the contents of sidelink beam reporting, if a receiver UE makes a single sidelink beam reporting after receiving all sidelink CSI-RS for beam measurements, the contents of sidelink beam reporting may be some or all sidelink CSI-RS resource index(s) and their corresponding L1-RSRP measurements. For example, a receiver UE may report the L1-RSRP measurements of one or more sidelink transmit beams whose L1-RSRP measurements are larger than a threshold. In this way, a transmitter UE may select a transmit beam based on sidelink beam reporting, e.g., from among the one or more sidelink transmit beams whose L1-RSRP measurements at the Rx UE are reported to be larger than a threshold. Subsequently, the transmitter UE may indicate its selected transmit beam to the receiver UE.

Additionally or alternatively, the contents of sidelink beam reporting may be the sidelink CSI-RS resource index of the transmit beam with the strongest L1-RSRP measurement. In this way, a receiver UE effectively makes the sidelink beam selection, based on its sidelink beam measurements. The Tx UE may use the transmit beam indicated by the Rx UE in the beam report for following SL transmissions to the Rx UE. The contents of sidelink beam reporting may be sidelink CSI-RS resource index(s), with or without the corresponding L1-RSRP measurement results.

The sidelink beam reporting may be carried by sidelink MAC CE, e.g., to avoid the design of a new SCI format. The payload of sidelink beam reporting may be a few bits. For example, a sidelink CSI-RS resource index may be a few bits, depending on sidelink CSI-RS configurations, and its corresponding L1-RSRP measurement may be of 7 bits.

As a container for beam reporting, SL MAC-CE may be used such that CRI and L1-RSRP of multiple beams are carried on. On the other hand, PSFCH carries only 1 bit. To enable multi-bit reporting by a PSFCH, either new PSFCH format or new resource selection based on the reporting contents may be used.

SL beam measurement report to the base station over Uu link may be beneficial in scenarios where the UE is in Uu coverage (e.g., mode 1). For in-coverage case, SL transmission occurs only on UL slots. On UL slots, there may be uplink in the same cell or in neighboring cells scheduled by BSs. The BSs may control the interference from SL transmissions to UL receptions. In addition, for in-coverage case, BS may be able to bypass data transfer from/to Uu link to/from SL unicast link whenever the BS thinks it is useful. The BS may be able to compare which link is appropriate for a UE to transfer data, and then indicate switching between Uu link and SL unicast-link whenever necessary.

Beam-level link quality may be known by BS in in-coverage SL operation for better usage of licensed spectrum. For Uu, beam reporting for the current serving cell or for different serving cells is supported. Enhancing Uu beam reporting such that it can incorporate the beam reporting of SL unicast-link enables the BS to get the channel qualities of both Uu link and SL links for a UE and then to make a necessary decision on FR2 operation. The BS may observe that SL beam(s) of a UE causes strong interference to neighbor cell(s) or to the other UEs in the same cell. BS may want to have a certain controllability of SL beam(s) of a UE. There can be cases where all SL beams of a SL unicast-link have low qualities while those UEs have beams for Uu link with sufficiently high quality. Since beam(s) for Uu link can be alternative path(s) for data transfer for SL unicast communication in in-coverage scenario, it may be beneficial to enable SL beam failure indication via Uu link to the BS. BS may initiate Uu communication with the UE to bypass the SL unicast communication and/or may reconfigure some radio parameters for the SL unicast-link such that the SL unicast-link is getting robust.

For example, in addition to basic SL beam management aspects, BS-involvement for SL beam management may be enabled/supported. For example, for a UE in the coverage of the BS, SL beam reporting to the BS via Uu link and/or SL beam failure indication via Uu link to gNB and/or SL beam indication/configuration by the BS may be supported and/or configured/enabled by the network.

In case of Mode 1 resource allocation operation, the UE may send SR and/or SL-BSR to the BS for requesting SL grants. Based on the received SR and SL-BSRs, the BS may schedule a dynamic SL grant or a configured grant to the UE. After that, the UE may select the destination and the logical channels associated with the destination based on the LCP procedure. In such way, the BS may have no direct knowledge on the destination and the LCHs which the UE has selected for the SL data transmission using the SL grant. This may achieve a good balance between the extent of the BS control and the UE autonomous actions.

Regarding beam maintenance and BFR procedure, the UE may not forward the received CSI reports from the peer UEs to the BS. How to determine a proper TX beam or RX beam may be left for the UE's decision. This may simplify the BS operational complexity in case of Mode 1 RA.

The resource allocation for SL-FR2 may be under gNB's control in mode-1. Due to the mobility of TX UE and/or RX UE, the beam direction may change rapidly. Furthermore, if the to-be-used beam is chosen by the BS, the extra latency would be introduced due to the related control information delivery over Uu. Therefore, the to-be-used SL beam in mode-1 may be determined by UE.

To enable spatial resource multiplexing, i.e., the SL grant allocated for different UEs can be shared when the beams used by such different UEs are not overlapped, the BS may need to know the spatial information of SL beams. The BS may then allocate shared SL grants for different UEs using non-overlapped SL beams. To enable spatial resource multiplexing in mode-1, the spatial information of SL beams may be reported to the BS by UE.

A Tx UE may report beam related measurement result to the BS. The BS may determine the beam paired to each destination UE. This option may be used for UE using mode 1 resource allocation. When scheduling the SL grant, the BS may indicate the associated SL beam. If the UE uses mode 2 in RRC_CONNECTED, the transmission resource is selected by UE. So, the BS may not need to determine the tx beam. But the tx resource pool is provided by the BS. The BS may consider the selected beam to decide the tx resource pool. So, tx UE may report the selected tx beam to the BS in mode 2.

After beam-pairing, each destination may be paired with a different beam. In mode 1, scheduled SL grant may be associated with specific SL beam. After acquiring SL grant, TX UE may only put the data from the destination UE with matched beam into the SL grant.

A UE may use/generate a MAC CE based on a Uu MAC-CE format for beam switching indication from/to gNB. A UE may use/generate a MAC CE based on a SL MAC-CE format for beam switching indication from peer UE. A UE may use/generate a MAC CE based on a SL MAC-CE format for new SL CSI/Beam reporting from peer UE.

The BS may perform the unicast link (PC5) beam selection and indicate the selected beam to TX UE, then TX UE may indicate the beam to RX UE. For mode 1 resource allocation, the BS may be aware of the beam level resource state in PC5 interface and support PC5 beam indication in DCI.

In an example, a received message comprising SR configurations may indicate that a SR configuration is associated with one or more respective SL RSs and/or SL TCI states and/or SL SRIs and/or SL beams. In an example, a SR configuration may be for a proximity service communication 5 (PC5) link between a first wireless device and a second wireless device. For example, the first UE may use a first SR configuration to request a resource for transmission of a first SL RS to the second UE, wherein the first SR configuration is associated with the first SL RS.

In the existing technologies, SL UE may transmit SL beam report/indication to the BS to enable the BS to allocate spatial/directional sidelink grants in mode 1. For example, the BS may indicate the Tx beam and/or the Rx beam for the transmission/reception via the allocated SL grant, based on the beam report. The BS may efficiently allocate resources while avoiding spatial domain interference, maximizing frequency reuse, and managing UL and SL coexistence in same/neighboring bands. In the existing technologies, when the SL UE has no PSSCH resource available for a SL transmission, it transmits an SR to the network, which (implicitly, through the SR resource/configuration used for the SR) indicates that the scheduling request is for either a SL logical channel or SL CSI report or SL DRX command indication or SL beam report or SL BFR.

The implementation of the existing technologies may result in the SL grant provided by the BS not being applicable for SL transmission to the destination UE of the logical channel with data that triggered SR. The implementation of the existing technologies may result in the SL grant provided by the BS not being applicable for SL transmission to the destination UE of the SL CSI report and/or SL DRX command and/or SL beam report and/or SL BFR that triggered SR. Based on the existing technologies, the SR may not indicate the direction in which a SL resource is needed.

In an example, the BS may receive SL beam report for a destination of the wireless device, and determine a beam/direction corresponding to the destination, however, the beam information may be outdated and/or not valid anymore (e.g., due to Tx UE and/or Rx UE mobility) when SR is triggered. There is a need to indicate the up-to-date beam/direction for the requested SL resource when SR is transmitted to the BS.

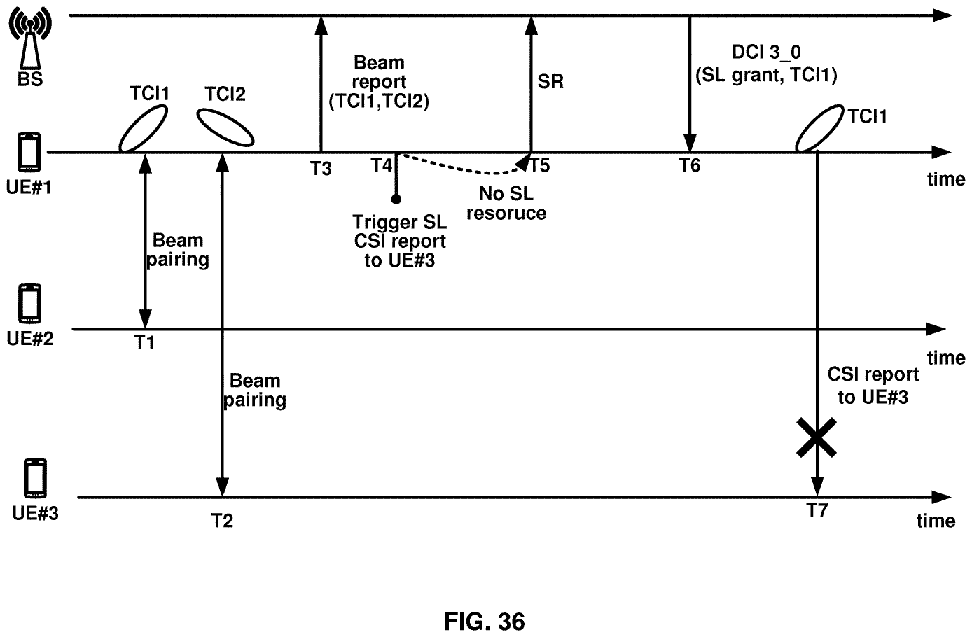

FIG. 36 illustrates an example of scheduling request configuration for sidelink operations. A first UE (UE #1) may be in coverage of a base station (BS), e.g., operating in mode 1. The first UE may have a first PC5 unicast link with a second UE (UE #2, e.g., a second destination corresponding to a first L1/L2 Destination ID). The first UE may have a second PC5 unicast link with a third UE (UE #3, e.g., a third destination corresponding to a second L1/L2 Destination ID).

As shown in FIG. 36, the first UE may perform a first beam pairing procedure for/on the first PC5 unicast link with the second UE at time T1. For example, the first UE may transmit SL RSs (e.g., beam sweeping) to the second UE, and the second UE may measure the SL RSs and transmit a beam report to the first UE. The beam report may indicate a first beam/SL RS among the SL RSs of the first UE as a candidate/best beam for sidelink transmission/reception on the first PC5 unicast link. For example, the first UE may determine a first TCI state (TCI1) associated with the first beam/SL RS for transmission to and/or reception from the second UE. The first UE may perform a second beam pairing procedure for/on the second PC5 unicast link with the third UE at time T2. For example, the first UE may transmit SL RSs (e.g., beam sweeping) to the third UE, and the third UE may measure the SL RSs and transmit a beam report to the first UE. The beam report may indicate a second beam/SL RS among the SL RSs of the first UE as a candidate/best beam for sidelink transmission/reception on the second PC5 unicast link. For example, the first UE may determine a second TCI state (TCI2) associated with the second beam/SL RS for transmission to and/or reception from the third UE. The first UE may transmit a beam report to the base station at time T3. The beam report (e.g., via a UCI and/or a MAC CE) may indicate the first TCI state as the TCI state for/corresponding to communication with the first destination (UE #2) and the second TCI state as the TCI state for/corresponding to communication with the second destination (UE #3).

As shown in FIG. 36, the first UE may determine that a SL transmission to the third UE (e.g., the second destination, UE #3) is triggered at time T4. The SL transmission may comprise a SL CSI report and/or a SL BFR and/or a SL DRX command and/or a SL beam report and/or a SL beam switching command. The SL transmission may comprise data of a logical channel associated with the third UE (the second destination). The first Ue may determine no SL resource is available that can accommodate the SL transmission and/or its MAC subheader. The first UE may trigger SR and transmit a SR to the base station at time T5.

As shown in FIG. 36, the first UE may receive a DCI form the BS (e.g., DCI format 3_0 or 3_1 or 3_2, etc.) at time T6. The DCI may indicate a SL grant comprising a SL resource (e.g., PSSCH transmission resource) for a SL transmission of the first UE. The DCI and/or the SL grant may also indicate a TCI state, e.g., the first TCI state (TCI1) for the SL transmission. The first UE may use the SL resource indicated by the DCI/SL grant to transmit the SL transmission (e.g., the SL CSI report) to the third UE at time T7. The first UE may follow the indicated TCI state for the SL transmission using the granted SL resource (TCI1). However, the SL transmission may fail, since the third UE is not associated with the first TCI state, but the second TCI state (TCI2). For example, the spatial domain gain of the transmission using a Tx beam/filter that is configured based on a first SL RS associated with the first TCI state may not be enough at the third UE for a successful reception of the SL transmission. Therefore, the existing SR mechanism may not help with a allocation of beam-based resources in sidelink, and may result in increased waste of SL resources and/or interference among SL UEs.

Embodiments of the present disclosure are related to an approach for beam-specific SR configuration for sidelink operations. These and other features of the present disclosure are described further below.

In an example embodiment, for a first SL logical channel, a plurality of SR configurations may be configured. Each SR configuration of the plurality of SR configurations may be associated with one or more respective [SL] TCI states (or beams, or SL CSI-RSs) of the UE.

In an example embodiment, the UE may trigger SR, to request sidelink resources (e.g., PSSCH/PSCCH resources) for a sidelink transmission comprising data of a first SL logical channel, based on a first SR configuration of the plurality of SR configurations associated with the first SL logical channel, wherein the first SR configuration is mapped to or configured for a first [SL] TCI state of the SL transmission or the UE. The sidelink transmission may be based on the first [SL] TCI state. The first logical channel may be associated with the first [SL] TCI state, e.g., through the destination UE (e.g., based on the destination UE's SL beam report). The sidelink transmission may comprise a reference signal (e.g., DMRS) that is associated (e.g., QCLed) with a first RS (e.g., SL CSI-RS) indicated by the first [SL] TCI state. The sidelink transmission may be to a destination/second UE that is configured/associated with a first TCI state. For example, the UE may determine the first TCI state and/or a first SL RS for the transmission to the destination UE. The destination UE of the SL logical channel may be associated with the first TCI state, e.g., based on beam measurement and/or a received beam report from the destination UE.

In an example embodiment, for a first SL CSI report and/or a first SL DRX command and/or a first SL beam report and/or a first SL BFR report and/or a first SL beam switching command, a plurality of SR configurations may be configured. Each SR configuration of the plurality of SR configurations may be associated with one or more respective [SL] TCI states (or beams, or SL CSI-RSs) of the UE.

In an example embodiment, the UE may trigger SR, to request sidelink resources (e.g., PSCCH/PSSCH resources) for a sidelink transmission. The SL transmission may comprise SL CSI report and/or SL DRX command and/or SL beam report and/or SL BFR and/or SL beam switching command. The UE may trigger the SR based on a first SR configuration of the plurality of SR configurations associated with the SL transmission, wherein the first SR configuration is mapped to or configured for a first TCI state of the SL transmission or the UE. The sidelink transmission may be based on the first TCI state. The first SL CSI report and/or a first SL DRX command and/or a first SL beam report and/or a first SL BFR report and/or a first SL beam switching command may be associated with the first [SL] TCI state, e.g., through the destination UE (e.g., based on the destination UE's SL beam report). The sidelink transmission may comprise a reference signal (e.g., DMRS) that is associated (e.g., QCLed) with a first RS (e.g., SL CSI-RS) indicated by the first TCI state. The sidelink transmission may be to a destination/second UE that is configured with a first TCI state. For example, the UE may determine the first TCI state and/or a first SL RS for the transmission to the destination UE. The destination UE of the SL transmission may be associated with the first TCI state, e.g., based on beam measurement and/or a received beam report from the destination UE.

In an example embodiment, the UE may determine a TCI state of a destination UE (or a logical channel or the SL CSI report etc.) based on beam measurement and/or a beam report received from the destination UE. The beam report may be received no earlier than a period (e.g., a pre-configured or pre-defined threshold duration) from the triggering of the SR.

Example embodiments of the present disclosure may provide enhancement for beam-based (e.g., directional) sidelink resource allocation in mode 1. Embodiments enable the network to determine SL TCI state or SL reference signal of a UE indicating the beam/direction in which the UE is requesting a SL resource. Based on the embodiment, the network may provide SL resources (e.g., PSSCH transmission resources) with a SL TCI state (or beam indication) for transmitting a SL logical channel data and/or SL CSI report and/or SL DRX command and/or SL BFR and/or SL beam report and/or SL beam switching command which the UE may effectively use for successful beam-formed transmission using a Tx beam associated with the indicated TCI state to the corresponding destination. Embodiments prevent resource allocation with a beam indication (e.g., Tx beam or TCI state or SL RS) that is different from a beam (e.g., Tx beam or TCI state or SL RS) associated with the intended destination, which results in high likelihood of failed SL transmission.

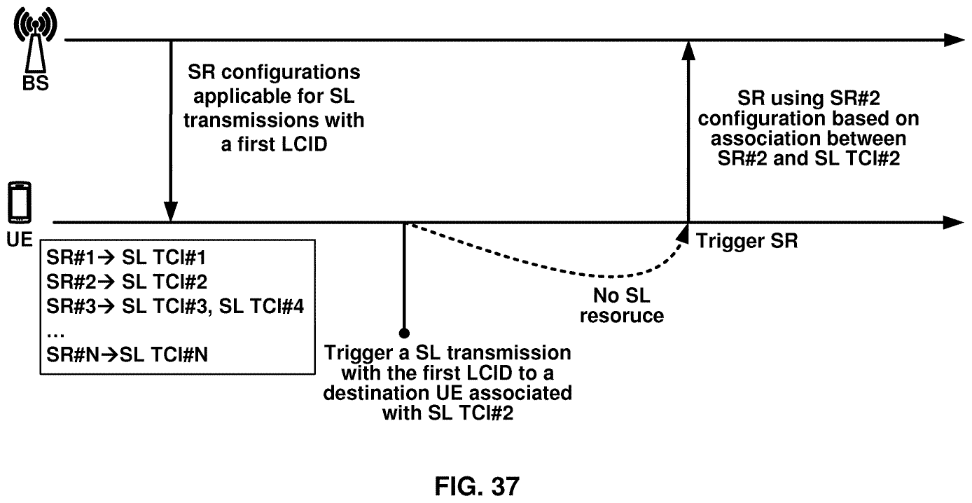

FIG. 37 illustrates an example of beam-specific scheduling request configuration for sidelink operations as per an aspect of an embodiment of the present disclosure.

In the embodiment of FIG. 37, a UE may receive a message (e.g., RRC reconfiguration/setup/resume message and/or SIB/SIB12) indicating SR configurations applicable for SL transmissions. The UE may receive the message from the BS. The UE may receive the message from another UE. The message may comprise SL configuration parameters (e.g., via SL-ConfigDedicatedNR and/or SL-ConfigCommonNR) indicating the SR configurations applicable for the SL transmissions.

In an embodiment, the SL configurations may comprise first parameters (e.g., sl-CSI-SchedulingRequestList) indicating a first list/plurality of SR configurations (e.g., sl-CSI-SchedulingRequestId) for first SL transmissions. In an embodiment, the first SL transmissions may be associated with one or more first logical channel IDs (LCIDs). In an embodiment, the first SL transmissions may comprise Sidelink CSI Reporting MAC CE (e.g., LCID index 62) and/or Sidelink DRX Command MAC CE (e.g., LCID index 61) and/or SL beam report MAC CE and/or SL BFR MAC CE and/or SL beam switching MAC CE. In an example, the one or more first LCIDs may be predefined or pre-configured or configured by RRC.

In an embodiment, the SL configurations may comprise first parameters indicating a first list of SR configurations applicable for sidelink CSI reporting MAC CE (associated with LCID index 62). In an embodiment, the SL configurations may comprise second parameters indicating a second list of SR configurations applicable for sidelink DRX command MAC CE (associated with LCID index 61). In an embodiment, the SL configurations may comprise third parameters indicating a third list of SR configurations applicable for sidelink beam reporting MAC CE (associated with a third LCID index). In an embodiment, the SL configurations may comprise fourth parameters indicating a fourth list of SR configurations applicable for sidelink BFR MAC CE (associated with a fourth LCID index). In an embodiment, the SL configurations may comprise fifth parameters indicating a fifth list of SR configurations applicable for sidelink beam switching command MAC CE (associated with a fifth LCID index). In an embodiment, one or more of the first list and the second list and the third list and the fourth list and the fifth list of SR configurations may be the same, e.g., indicated by same/common configuration parameters. In an embodiment, the SL configurations may comprise second parameters (e.g., sl-SchedulingRequestList) indicating a second list/plurality of SR configurations (e.g., sl-SchedulingRequestId) for second SL transmissions. In an embodiment, the second SL transmissions may be associated with one or more second logical channel IDs (LCID). In an embodiment, the second SL transmissions may comprise data of a SL logical channel associated with the one or more second LCIDs (e.g., LCID=0, 1, . . . , 19). In an example, the one or more second LCIDs may be predefined or pre-configured or configured by RRC.

Each SR configuration in the first or second list/plurality of SR configurations may be indicated/identified with a respective SR identifier (e.g., SchedulingRequestld indicated by sl-CSI-SchedulingRequestld and/or sl-BFR-SchedulingRequestld and/or sl-SchedulingRequestld, etc.).

In the example of FIG. 37, the SR configurations applicable for SL transmissions associated with the first LCID may comprise a plurality of SR configurations. Each SR configuration of the plurality of SR configurations may be identified with a respective SR ID, e.g., SR #1, SR #2, SR #3, . . . , and SR #N. In the example of FIG. 37, the plurality of SR configurations for the first LCID comprises N SR configurations (SR #1, SR #2, SR #3, . . . , and SR #N).

In an embodiment, each SR configuration in the first or second list/plurality of SR configurations may be associated with (e.g., applicable for) one or more respective TCI states (e.g., SL TCI states) of the UE. For example, the one or more TCI states may indicate one or more SL RSs (e.g., SL CSI RSs) of the UE. For example, the UE may transmit the one or more SL RSs to one or more destination UEs, e.g., for one or more PC5 unicast links. For example, the one or more TCI states may be applicable/configured for the one or more PC5 unicast links. For example, the UE may configure common SL TCI states and/or common SL RSs for the one or more destination UEs (the one or more PC5 unicast links). In an embodiment, each SR configuration in the first or second list/plurality of SR configurations may be associated with (e.g., applicable for) one or more SL reference signals (RSs).

In an embodiment, the SL configuration parameters may indicate a plurality of TCI states (e.g., SL TCI states) corresponding to the SR configurations applicable for SL transmissions associated with the first LCID. For example, the SR configurations applicable for SL transmissions associated with the first LCID may indicate the plurality of TCI states (e.g., SL TCI states and/or UL/DL/unified TCI states). For example, for each SR configuration of the plurality of SR configurations, the configuration parameters may indicate one or more corresponding TCI states (e.g., SL TCI states). For example, the UE may determine, based on the configuration parameters, a mapping between the plurality of SR configurations and the plurality of TCI states. The mapping may be one-to-one (1:1) and/or one-to-many (1:M) and/or many-to-one (M:1). For example, a first SR configuration may be mapped to one or more first SL TCI states; a second SR configuration may be mapped to one or more second SL TCI states, and so on, wherein the one or more first SL TCI states and the one or more second TCI states may be disjoint (e.g., not the same). In an example, the one or more first SL TCI states and the one or more second TCI states may be the same.

In an embodiment, the SL configuration parameters may indicate a plurality of reference signals (e.g., SL CSI-RSs) corresponding to the SR configurations applicable for SL transmissions associated with the first LCID. For example, the SR configurations applicable for SL transmissions associated with the first LCID may indicate the plurality of SL RSs (e.g., SL CSI-RSs and/or S-SSBs and/or SL SRIs). For example, for each SR configuration of the plurality of SR configurations, the configuration parameters may indicate one or more corresponding SL RSs (e.g., SL CSI-RSs). For example, the UE may determine, based on the configuration parameters, a mapping between the plurality of SR configurations and the plurality of SL RSs. The mapping may be one-to-one (1:1) and/or one-to-many (1:M) and/or many-to-one (M:1). For example, a first SR configuration may be mapped to one or more first SL RSs; a second SR configuration may be mapped to one or more second SL RSs, and so on, wherein the one or more first SL RSs and the one or more second SL RSs may be disjoint (e.g., not the same). In an example, the one or more first SL RSs and the one or more second RSs may be the same.

In an embodiment, the plurality of SL TCI states and/or the plurality of SL RSs configured for the SR configurations of a sidelink transmission (e.g., a SL logical channel or a SL MAC CE) may be associated with a destination of the sidelink transmission. For example, the UE may transmit a SL RRC message to the destination UE, comprising SL configuration parameters of a PC5 unicast link between the UE and the destination UE. The SL configuration parameters may comprise RS or beam configurations (e.g. CSI-RS configurations) indicating resources and parameters for transmission/reception of the SL RSs. The SL configuration parameters may comprise physical channel configurations (e.g. PSCCH/PSSCH configurations) indicating SL TCI states for SL transmissions/receptions between the UE and the destination UE. The SL TCI states may indicate that SL transmissions/receptions are QCLed with one or more SL RS of the SL RSs.

Referring to FIG. 37, the SR configuration parameters may indicate a mapping between SR configurations and SL TCI states and/or SL RSs. For example, the SR configuration parameters may indicate that the first SR configuration, identified by a first SR ID (e.g., SR #1) is associated with (applicable for) a first SL TCI state (SL TCI #1). For example, the SR configuration parameters may indicate that the second SR configuration, identified by a second SR ID (e.g., SR #2) is associated with (applicable for) a second SL TCI state (SL TCI #2). For example, the SR configuration parameters may indicate that the third SR configuration, identified by a third SR ID (e.g., SR #3) is associated with (applicable for) a third SL TCI state (SL TCI #3) and/or a fourth SL TCI state (SL TCI #4), and so on.

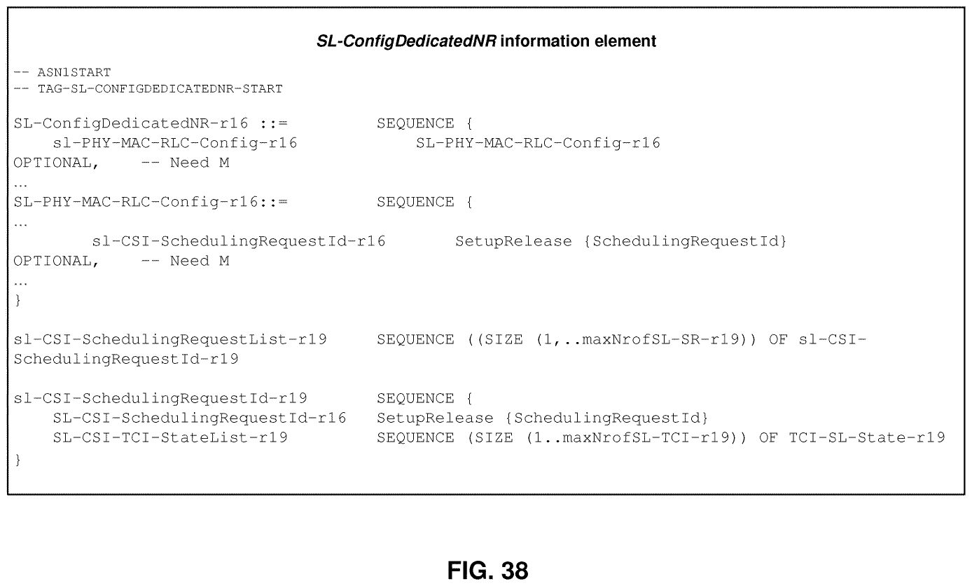

FIG. 38 illustrates an example of scheduling request configuration parameters for beam-formed sidelink transmissions as per an aspect of an embodiment of the present disclosure. As shown in this figure, the sidelink configurations may comprise a parameter (sl-CSI-SchedulingRequestList) indicating a list/plurality of SR configurations (sl-CSI-SchedulingRequestId) for a first SL transmission (e.g., SL CSI reporting MAC CE and/or SL BFR MAC CE and/or SL DRX command MAC CE and/or SL beam reporting MAC CE and/or SL beam switching command MAC CE, etc.). For each SR configuration of the list/plurality of SR configurations, the sidelink configurations comprise: a first parameter (SchedulingRequestId) indicating the ID of the respective SR configuration (SR ID); and a second parameter (SL-CSI-TCI-StateList) indicating one or more SL TCI states (TCI-SL-State) associated with the respective SR confirmation.

As shown in FIG. 38, the sidelink configuration parameters may indicate, for a sidelink transmission (e.g., a SL LCH and/or a SL MAC CE), a table/list of TCI-based SR configurations indicating {a first SR configuration ID (SchedulingRequestId); and one or more first SL TCI states (TCI-SL-State)}. Each row of the list/table may indicate a SR configuration ID and one or more SL TCI states associated with the respective SR configuration ID. For example, the SR configuration indicated by the SR configuration ID may be applicable to the one or more respective SL TCI states. In an embodiment, the SR configuration may be applicable for requesting resources for the sidelink transmission based on the one or more respective SL TCI states. For example, a RS (e.g., DMRS) of the sidelink transmission may be QCLed with a SL RS indicated by the one or more respective SL TCI states.

In an example, the sidelink configuration parameters may indicate, for a sidelink transmission (e.g., a SL LCH and/or a SL MAC CE), a table/list of RS-based SR configurations indicating {a first SR configuration ID (SchedulingRequestId); and one or more first SL RSs (e.g., SL-CSI-RS)}. Each row of the list/table may indicate a SR configuration ID and one or more SL RSs associated with the respective SR configuration ID. For example, the SR configuration indicated by the SR configuration ID may be applicable to the one or more respective SL RSs. In an embodiment, the SR configuration may be applicable for requesting resources for the sidelink transmission based on the one or more respective SL RSs. For example, a RS (e.g., DMRS) of the sidelink transmission may be QCLed with the one or more respective SL RSs.

Referring to FIG. 37, the UE may determine that a SL transmission associated with the first SL LCID is triggered or is to be transmitted. For example, the UE may determine to transmit a MAC PDU (SL-SCH) comprising the SL transmission (e.g., MAC subPDU) and a (corresponding) MAC subheader (e.g., SL-SCH MAC subheader), wherein the corresponding MAC subheader indicates the LCID of the SL transmission (MAC subPDU).

The MAC PDU may consist of one SL-SCH subheader and one or more MAC subPDUs. A first MAC subPDU of the one or more MAC subPDUs may consist of a MAC subheader and a MAC SDU; or a MAC subheader and a MAC CE. Each MAC subheader (e.g., except SL-SCH subheader) may correspond to either a MAC SDU, a MAC CE, or padding. A MAC subheader (e.g., except for fixed-sized MAC CE and padding) may consist of the four header fields R/F/LCID/L (with 8-bit L field or 16-bit L field). A MAC subheader for fixed-sized MAC CE and padding may consist of the two header fields R/LCID.

The Logical Channel ID field identifies the logical channel instance of the corresponding MAC SDU or the type of the corresponding MAC CE within the scope of one Source Layer-2 ID and Destination Layer-2 ID pair for SL-SCH. There is one LCID field per MAC subheader (e.g., except for SL-SCH subheader). The size of the LCID field may be 6 bits. For example, for a MAC SDU (for SL-SCH) comprising data of SL logical channel, the LCID index/value is given by the identity of the logical channel (e.g., 0 to 19). For example, for a SL MAC CE the LCID index/value may be pre-defined or pre-configured (e.g., 20 to 63).

In the example of FIG. 37, the UE may trigger a SL CSI reporting to a destination UE. The UE may determine to transmit a SL CSI report MAC CE to the destination UE. For example, the UE may determine to transmit a MAC PDU (SL-SCH) comprising the SL CSI reporting MAC CE and a MAC subheader indicating a first LCID value of/for the Sidelink CSI Reporting (e.g., 62).

In the example of FIG. 37, the UE may trigger a SL DRX command indication to a destination UE. The UE may determine to transmit a SL DRX command MAC CE to the destination UE. For example, the UE may determine to transmit a MAC PDU (SL-SCH) comprising the SL DRX command MAC CE and a MAC subheader indicating a first LCID value of/for the Sidelink DRX command (e.g., 61).

In the example of FIG. 37, the UE may trigger a SL beam reporting to a destination UE. The UE may determine to transmit a SL beam report MAC CE to the destination UE. For example, the UE may determine to transmit a MAC PDU (SL-SCH) comprising the SL beam reporting MAC CE and a MAC subheader indicating a first LCID value of/for the Sidelink beam Reporting (e.g., 55 or 54 or 53, or 20-55).

In the example of FIG. 37, the UE may trigger a SL BFR reporting to a destination UE. The UE may determine to transmit a SL BFR report MAC CE to the destination UE. For example, the UE may determine to transmit a MAC PDU (SL-SCH) comprising the SL BFR reporting MAC CE and a MAC subheader indicating a first LCID value of/for the Sidelink BFR Reporting (e.g., 55 or 54 or 53, or 20-55).

In the example of FIG. 37, the UE may trigger a SL beam switching command to a destination UE. The UE may determine to transmit a SL beam switching command MAC CE to the destination UE. For example, the UE may determine to transmit a MAC PDU (SL-SCH) comprising the SL beam switching command MAC CE and a MAC subheader indicating a first LCID value of/for the Sidelink beam switching command (e.g., 55 or 54 or 53, or 20-55).

The UE may trigger (e.g., determine to transmit a TB/MAC PDU comprising) a SL MAC CE or SL MAC SDU to a destination UE. The SL MAC CE or the SL MAC SDU (e.g., the SL transmission) may be associated with the first LCID. For example, a respective subheader of the SL MAC CE or the SL MAC SDU in the TB/MAC PDU comprises a LCID field indicating a value of the first LCID. The first LCID may identify a logical channel instance of the corresponding MAC SDU or a type of the corresponding MAC CE, e.g., within the scope of a Source Layer-2 ID and Destination Layer-2 ID pair for SL-SCH. For example, the SL-SCH subheader of the TB/MAC PDU may indicate the destination ID (e.g., Destination Layer-2 ID) of the destination UE.

In an embodiment, the SL transmission (e.g., the SL MAC CE or the SL MAC SDU) may be associated with a TCI state. For example, the destination UE of the SL transmission may be associated with the TCI state, e.g., a SL TCI state. The destination UE may be associated with a SL RS, e.g., a SL CSI RS. In the example of FIG. 37, the SL transmission is associated with the second SL TCI state (SL TCI #2).

In an embodiment, the UE may determine no resource (e.g., SL resource, PSSCH resource) is available for the SL transmission. For example, the UE may determine that the UE does not have a SL resource, e.g., allocated for new transmission. For example, the UE may determine that the SL-SCH resources cannot accommodate the SL transmission (e.g., the SL MAC CE and/or the SL MAC SDU) and/or its MAC subheader, e.g., as a result of logical channel prioritization (LCP). For example, the UE may be configured with sidelink resource allocation mode 1. In response to the determining, the UE may trigger a SR, as shown in FIG. 37.

In an embodiment, the UE may determine that SL BSR is triggered based on a first SL logical channel. The UE may trigger a SL BSR. The UE may determine that no resource (e.g., SL resource (e.g., UL resource, PUSCH resource) is available for the SL BSR transmission. For example, the UE may determine that the UE does not have an UL resource, e.g., allocated for new transmission. For example, the UE may determine that the UL-SCH resources cannot accommodate the SL BSR transmission and/or its MAC subheader, e.g., as a result of logical channel prioritization (LCP). For example, the UE may be configured with sidelink resource allocation mode 1. In response to the determining, the UE may trigger a SR, as shown in FIG. 37.

In an embodiment, the UE may transmit the SR using a first SR configuration. For example, the UE may transmit the SR information bit(s) via a PUCCH resource associated/configured for the first SR configuration. The first SR configuration may be identified with a first SR ID. For example, the UE may transmit a PUCCH transmission (or a PUSCH transmission overlapping with the PUCCH transmission) comprising the SR. For example, the UE may transmit a UCI (on a PUCCH or PUSCH transmission), the UCI comprising the SR information bit(s). In an embodiment, the UE may transmit the UCI using/on a SR resource. The SR resource may comprise a PUCCH transmission occasion (resource). The SR resource or the PUCCH resource may be associated with (e.g., configured for) the first SR configuration. For example, configuration parameters of the first SR configuration may indicate the SR resource and/or the PUCCH resource.

In an embodiment, the UE may select/determine the first SR configuration for the SR transmission from among the plurality/list of SR configurations configured for (associated with) the SL transmission (e.g., the SL MAC CE and/or the SL MAC SDU). For example, the UE may select/determine the first SR configuration based on the LCID of the SL transmission (e.g., the SL MAC CE and/or the SL MAC SDU). For example, the first SR configuration may be applicable for SL transmissions (associated) with a first LCID (LCID of the sidelink transmission). For example, the first SR configuration may be applicable for the SL MAC CE that triggered the SR (e.g., SL CSI reporting MAC CE and/or SL DRX command MAC CE and/or SL BFR MAC CE and/or SL beam reporting MAC CE and/or SL beam switching command MAC CE, etc.). For example, the first SR configuration may be applicable for the first logical channel that triggered the SR or the BSR.

In an embodiment, the UE may select/determine/use the first SR configuration for the SR transmission based on the TCI state (SL TCI state) of the SL transmission (e.g., the SL MAC CE and/or the SL MAC SDU). In an embodiment, the UE may select/determine the first SR configuration for the SR transmission based on the SL RS associated with the SL transmission (e.g., the SL CSI RS or the S-SSB). For example, the first SR configuration may be configured/applicable for SL transmissions (associated) with the first (SL) TCI state. For example, the first SR configuration may be configured/applicable for SL transmissions associated (or QCLed) with the first SL RS (e.g., the first SL CSI-RS). For example, the SL configuration parameters may indicate the association/mapping between the first SR configuration and the first SL TCI state and/or the first SL RS.

In an embodiment, the UE may select/determine/use the first SR configuration for the SR transmission from among the plurality/list of SR configurations configured for (associated with) the SL transmission (e.g., the SL MAC CE and/or the SL MAC SDU).

In an embodiment, the UE may select/determine the first SR configuration based on: the LCID of the SL transmission; and the (SL) TCI state or the SL RS associated with the SL transmission.

In an embodiment, the UE may select/determine/use the first SR configuration based on: the logical channel (e.g., the logical channel instance of the corresponding MAC SDU) that triggered the SR; and the (SL) TCI state or the SL RS associated with the destination UE of the logical channel.

In an embodiment, the UE may select/determine/use the first SR configuration based on: the type of the corresponding MAC CE that triggered the SR; and the (SL) TCI state or the SL RS associated with the destination UE of the logical channel.

In the example of FIG. 37, the UE selects/determines/uses the second SR configuration (SR #2) for the SR transmission based on the association/mapping between the second SR configuration and the second SL TCI state. The SL configurations may indicate the association/mapping between the second SR configuration and the second SL TCI state. The second SR configuration may be associated with (e.g., configured or applicable for) SL transmissions with the first LCID and the second SL TCI state (or a second SL RS/SL CSI-RS indicated by the second TI state).

In an embodiment, the first SR configuration may be configured/applicable for the SL MAC CE that triggered the SR (e.g., SL CSI reporting MAC CE and/or SL DRX command MAC CE and/or SL BFR MAC CE and/or SL beam reporting MAC CE and/or SL beam switching command MAC CE, etc.) and the TCI state of the destination of the MAC CE. For example, the first SR configuration may be configured/applicable for the logical channel that triggered the SR or the BSR and the TCI state of the destination of the logical channel.

In an embodiment, the UE may determine a first TCI state and/or a first SL RS of the destination of the SL transmission (e.g., the SL logical channel and/or the SL MAC CE) that triggered the SR. for example, the first TCI state may indicate the first SL RS. For example, the UE may determine a first TCI state (SL TCI state) and/or a first SL RS (e.g., SL CSI-RS) associated with the destination UE (e.g., the UE having the Destination L2 ID associated with the SL transmission).

In an embodiment, the UE may receive a plurality of SL RSs, comprising the first SL RS, from the destination UE. The UE may perform measurements (e.g., RSRP and/or SINR measurements) on a plurality of SL RSs. The UE may select/determine, based on the measurements, one or more first SL RS of the plurality of SL RSs for SL communication with the destination UE. The one or more SL RSs may comprise the first SL RS. For example, RSRP of the one or more first SL RSs may be above a threshold.

For example, RSRP of the one or more first SL RSs may be higher than the rest of the SL RSs of the plurality of SL RSs. The UE may select the first SL RS among the one or more first SL RSs for SL communications with the destination UE. The UE may transmit a beam indication to the destination UE indicating the first SL RS for SL communications. In an embodiment, the UE may send a beam report to the destination UE. The beam report may indicate the one or more first SL RSs and/or the RSRP of the one or more first SL RSs. The destination UE may select the first SL RS among the one or more first SL RSs. The destination UE may transmit a beam indication to the UE indicating the first SL RS for SL communications.

In an embodiment, the UE may transmit a plurality of SL RSs, comprising the first SL RS, to the destination UE. The destination UE may perform measurements (e.g., RSRP and/or SINR measurements) on a plurality of SL RSs. The destination UE may select/determine, based on the measurements, one or more first SL RS of the plurality of SL RSs for SL communication with the destination UE. The one or more SL RSs may comprise the first SL RS. For example, RSRP of the one or more first SL RSs may be above a threshold. For example, RSRP of the one or more first SL RSs may be higher than the rest of the SL RSs of the plurality of SL RSs. The destination UE may select the first SL RS among the one or more first SL RSs for SL communications with the UE. The destination UE may transmit a beam indication to the UE indicating the first SL RS for SL communications. In an embodiment, the destination UE may send a beam report to the UE. The beam report may indicate the one or more first SL RSs. The UE may select the first SL RS among the one or more first SL RSs. The UE may transmit a beam indication to the destination UE indicating the first SL RS for SL communications.

In an embodiment, the UE may select/determine the first SR configuration based on the first SL TCI state or the first SL RS associated with the SL transmission. The UE may determine the first SL TCI state or the first SL RS associated with the destination UE of the SL transmission based on a SL beam measurement and/or SL beam report. For example, the UE may receive the SL beam report from the destination UE. For example, the UE may transmit the SL beam report to the destination UE. For example, the UE may perform SL beam measurements. The SL beam measurement and/or SL beam report may indicate the first SL RS and/or the first SL TCI state (to be used) for SL communications between the UE and the destination UE.

In an embodiment, the UE may select/determine a first SR configuration, for a SR corresponding to a sidelink transmission, based on a beam report indicating a first SL RS and/or a first SL TCI state for SL communications with a destination UE of the sidelink transmission. In an embodiment, the UE may select/determine the first SR configuration, for the sidelink transmission, if the beam report is received or transmitted in a time window/interval before the triggering of the SR.

A duration of the time window/interval may be predefined/preconfigured.

In an embodiment, if a last beam report is received from or transmitted to the destination UE before a duration of the time window/interval from the triggering of the SR, the UE may do one or more of the following: transmitting the SR based on a default (e.g., non-beam-specific) SR configuration; transmitting the SR based on a second SR configuration that is associated with a default TCI state of the destination UE; transmitting the SR based on a selected (e.g., randomly selected) SR configuration.

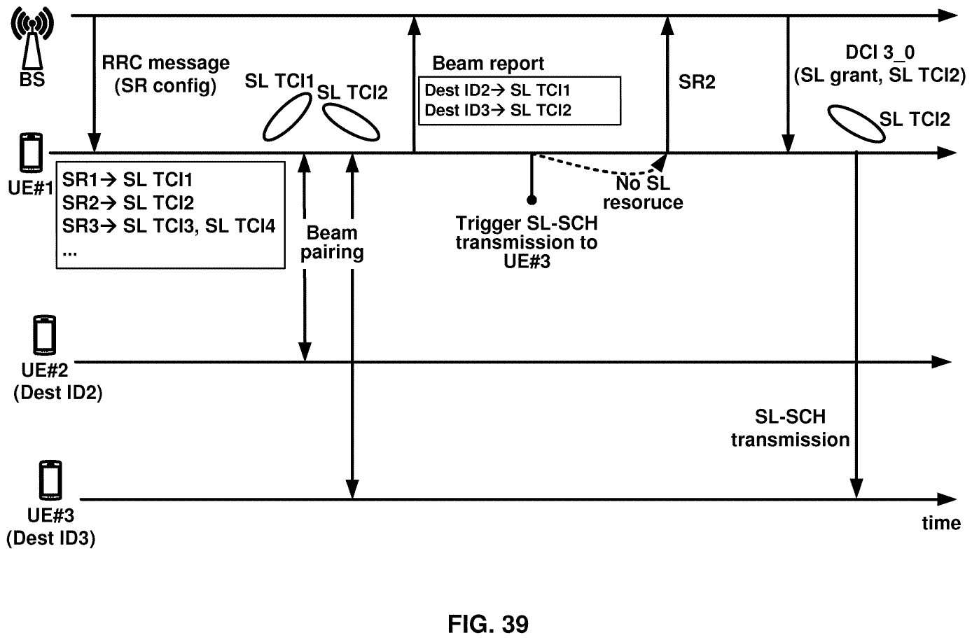

FIG. 39 illustrates an example of beam-specific scheduling request for sidelink operations as per an aspect of an embodiment of the present disclosure. As shown in the figure, a first UE (e.g., Tx UE, UE #1) may receive via a message (e.g., an RRC message or a SIB) SR configuration parameters. The SR configuration parameters may indicate beam-specific SR configuration, wherein each SR configuration of the SR configurations is applicable for (e.g., mapped to or associated with or configured for) one or more respective SL TCI states (or SL CSI RSs). The first UE may have a first PC5 unicast link with a second UE (UE #2, Rx UE), and/or a second PC5 unicast link with a third UE (UE #3, Rx UE). The first UE may perform beam pairing procedure(s) with the second UE and/or the third UE. The first UE may determine, based on the beam pairing procedure, a first SL TCI state (SL TCI1) and/or a corresponding first SL RS for the first PC5 unicast link or for the second UE. The first UE may determine, based on the beam pairing procedure, a second SL TCI state (SL TCI2) and/or a corresponding second SL RS for the second PC5 unicast link or for the third UE. The UE may transmit a beam report on a PUSCH or PUCCH transmission to the base station. The bean report may indicate the determined SL TCI states or SL RSs for respective destination UEs; e.g., the first SL TCI state for the second destination/UE (Dest ID2->SL TCI1), and/or the second SL TCI state for the third destination/UE (Dest ID3->SL TCI2).

In the example of FIG. 39, the first UE may trigger a SL-SCH transmission (e.g., a SL MAC SDU comprising a logical channel data and/or a SL MAC CE) to the third destination/UE. In response to determining no SL resource is available and/or can accommodate the SL-SCH transmission, the first UE may trigger a SR.

In an embodiment, the first UE may transmit the SR, e.g., a UCI comprising information bit(s) of the SR. The first UE may transmit the SR using the second SR configuration (e.g., on a SR/PUCCH resource configured for or indicated by the second SR configuration). In an embodiment, the UE may determine to transmit the SR using the second SR configuration (SR2) based on the SL-SCH transmission (and/or the destination of the SL-SCH transmission; UE #3) being associated with a SL CI state that is mapped to the second SR configuration. For example, the UE may determine the second SR configuration based on the second SR configuration being applicable/configured for a second SL TCI state (and/or a second SL RS/CSI-RS), wherein the SL-SCH transmission and/or the third destination/UE (UE #3) is associated with the second SL TCI state (and/or the second SL RS/CSI-RS).

Referring to FIG. 39, upon/after/in response to receiving the SR via the SR resources of the second SR configuration, the base station may transmit a DCI (e.g., DCI format 3_0) to the first UE. The DCI may comprise a SL grant. The DCI/SL grant may indicate a sidelink resource (e.g., a PSSCH transmission resource). The DCI/SL grant may comprise a field indicating the second SL TCI state for a SL transmission using the indicated/allocated sidelink resource.

The first UE may receive the DCI and may determine the SL resource. The first UE may generate a TB/MAC PDU comprising the SL-SCH transmission (the SL MAC CE and/or SL MAC SDU). The first UE may transmit the TB/MAC PDU comprising the SL-SCH transmission using the granted SL resource and based on the indicated SL TCI state (SL TCI2) or the corresponding SL RS (e.g., a SL CSI-RS #2 indicated by SL TCI2) to the third UE.

Embodiments enable beam-specific SR transmission and grant allocation for sidelink operation in mode 1, which results in successful beam-formed SL transmissions.

Referring to FIG. 38, a UE may receive one or more RRC messages (e.g., RRC reconfiguration message or SIB12) comprising SL configurations (e.g., SL-ConfigDedicatedNR). The SL configurations may comprise parameters (e.g., sl-CSI-SchedulingRequestList and/or sl-SchedulingRequestList) indicating a list/plurality of SR configurations (e.g., sl-CSI-SchedulingRequestld and/or sl-SchedulingRequestId) (applicable) for a first SL logical channel or a first type of SL MAC CE. For each SR configuration in the list, the parameters may indicate, via a first parameter (e.g., SL-CSI-SchedulingRequestId), a respective SR configuration ID (e.g., SchedulingRequestId). For each SR configuration in the list, the parameters may indicate, via a second parameter (e.g., SL-CSI-TCI-StateList or SL-CSI-RS-List), a list/table/plurality of SL TCI states (e.g., TCI-SL-State) or SL RSs (e.g., SL CSI RSs, SL-CSI-RS-ID).

In an embodiment, if the first parameter (e.g., SL-CSI-SchedulingRequestId) is present, it indicates the scheduling request configuration applicable for Sidelink CSI Reporting MAC CE and/or Sidelink DRX Command MAC CE and/or sidelink BFR MAC CE and/or sidelink beam report MAC CE and/or sidelink beam switching command MAC CE.

In an embodiment, if the second parameter (e.g., SL-CSI-TCI-StateList or SL-CSI-RS-List) is present, it indicates the sidelink TCI state(s) and/or the sidelink CSI RS(s) for which the corresponding scheduling request configuration is applicable.

In an embodiment, if the second parameter (e.g., SL-CSI-TCI-StateList or SL-CSI-RS-List) is present, it indicates the sidelink TCI state(s) and/or the sidelink CSI RS(s) associated with the sidelink MAC CE (e.g., Sidelink CSI Reporting MAC CE and/or Sidelink DRX Command MAC CE and/or sidelink BFR MAC CE and/or sidelink beam report MAC CE and/or sidelink beam switching command MAC CE) for which the corresponding scheduling request configuration is applicable.

In an embodiment, if the second parameter (e.g., SL-CSI-TCI-StateList or SL-CSI-RS-List) is present, it indicates the sidelink TCI state(s) and/or the sidelink CSI RS(s) associated with the destination of the sidelink MAC CE (e.g., Sidelink CSI Reporting MAC CE and/or Sidelink DRX Command MAC CE and/or sidelink BFR MAC CE and/or sidelink beam report MAC CE and/or sidelink beam switching command MAC CE) for which the corresponding scheduling request configuration is applicable.

In an embodiment, if the first parameter (e.g., SL-SchedulingRequestId) is present, it indicates the scheduling request configuration applicable for the corresponding Sidelink logical channel.

In an embodiment, if the second parameter (e.g., SL-TCI-StateList or SL-CSI-RS-List) is present, it indicates the sidelink TCI state(s) and/or the sidelink CSI RS(s) for which the corresponding scheduling request configuration is applicable.

In an embodiment, if the second parameter (e.g., SL-TCI-StateList or SL-CSI-RS-List) is present, it indicates the sidelink TCI state(s) and/or the sidelink CSI RS(s) associated with the sidelink logical channel for which the corresponding scheduling request configuration is applicable.

In an embodiment, if the second parameter (e.g., SL-TCI-StateList or SL-CSI-RS-List) is present, it indicates the sidelink TCI state(s) and/or the sidelink CSI RS(s) associated with the destination of the sidelink logical channel for which the corresponding scheduling request configuration is applicable.

In an embodiment, the SR configuration of the logical channel and the TCI state corresponding to the destination of the logical channel that triggered the Sidelink BSR is considered as corresponding SR configuration for the triggered SR.

In an embodiment, the SR configuration of the logical channel and the SL CSI-RS corresponding to the destination of the logical channel that triggered the Sidelink BSR is considered as corresponding SR configuration for the triggered SR.

In an embodiment, each sidelink logical channel may be mapped to zero or M SR configuration, which is configured by RRC, where M is the size/length of SL TCI states configured by RRC for the respective sidelink logical channel (e.g., SIZE (1 . . . maxNrofSL-TCI). In an embodiment, each sidelink logical channel may be mapped to zero or up to M_max SR configuration, which is configured by RRC, where M_max is the total number of SL TCI states (e.g., maxNrofSL-TCI).

In an embodiment, if the SL-CSI reporting procedure is enabled by RRC, the SL-CSI reporting is mapped to M SR configuration for all PC5-RRC connections, where M is the size/length of SL TCI states configured by RRC for the respective sidelink logical channel (e.g., SIZE (1 . . . maxNrofSL-TCI)).

In an embodiment, the SR configuration of the SL-CSI reporting and the corresponding SL TCI state triggered is considered as corresponding SR configuration for the triggered SR. In an embodiment, the SR configuration of the SL-CSI reporting associated with the corresponding SL TCI state triggered is considered as corresponding SR configuration for the triggered SR.

In an embodiment, the SR configuration of the SL-CSI reporting and the corresponding SL CSI-RS triggered is considered as corresponding SR configuration for the triggered SR. In an embodiment, the SR configuration of the SL-CSI reporting associated with the corresponding SL CSI-RS triggered is considered as corresponding SR configuration for the triggered SR.

In an embodiment, the SR configuration of the SL-CSI reporting and the corresponding SL TCI state is considered as corresponding SR configuration for the triggered SR of SL-DRX Command indication. In an embodiment, the SR configuration of the SL-CSI reporting associated with the corresponding SL TCI state is considered as corresponding SR configuration for the triggered SR of SL-DRX Command indication.

In an embodiment, the SR configuration of the SL-CSI reporting and the corresponding SL CSI-RS is considered as corresponding SR configuration for the triggered SR of SL-DRX Command indication. In an embodiment, the SR configuration of the SL-CSI reporting associated with the corresponding SL CSI-RS is considered as corresponding SR configuration for the triggered SR of SL-DRX Command indication.

In an embodiment, the SR configuration of the SL-CSI reporting and the corresponding SL TCI state is considered as corresponding SR configuration for the triggered SR of SL-beam report. In an embodiment, the SR configuration of the SL-CSI reporting associated with the corresponding SL TCI state is considered as corresponding SR configuration for the triggered SR of SL-beam report.

In an embodiment, the SR configuration of the SL-CSI reporting and the corresponding SL CSI-RS is considered as corresponding SR configuration for the triggered SR of SL-beam report. In an embodiment, the SR configuration of the SL-CSI reporting associated with the corresponding SL CSI-RS is considered as corresponding SR configuration for the triggered SR of SL-beam report.

In an embodiment, the SR configuration of the SL-CSI reporting and the corresponding SL TCI state is considered as corresponding SR configuration for the triggered SR of SL-BFR indication. In an embodiment, the SR configuration of the SL-CSI reporting associated with the corresponding SL TCI state is considered as corresponding SR configuration for the triggered SR of SL-BFR indication.

In an embodiment, the SR configuration of the SL-CSI reporting and the corresponding SL CSI-RS is considered as corresponding SR configuration for the triggered SR of SL-BFR indication. In an embodiment, the SR configuration of the SL-CSI reporting associated with the corresponding SL CSI-RS is considered as corresponding SR configuration for the triggered SR of SL-BFR indication.

In an embodiment, the SR configuration of the SL-CSI reporting and the corresponding SL TCI state is considered as corresponding SR configuration for the triggered SR of SL-beam switching Command indication. In an embodiment, the SR configuration of the SL-CSI reporting associated with the corresponding SL TCI state is considered as corresponding SR configuration for the triggered SR of SL-beam switching Command indication.

In an embodiment, the SR configuration of the SL-CSI reporting and the corresponding SL CSI-RS is considered as corresponding SR configuration for the triggered SR of SL-beam switching Command indication. In an embodiment, the SR configuration of the SL-CSI reporting associated with the corresponding SL CSI-RS is considered as corresponding SR configuration for the triggered SR of SL-beam switching Command indication.

In an embodiment, for a sidelink logical channel and/or for SL-CSI reporting and/or for SL-DRX Command indication and/or for SL beam reporting and/or for SL BFR indication and/or for SL beam switching command indication, at most M PUCCH resource for SR is configured per UL BWP, where M is the size/length of SL TCI states configured by RRC for the respective sidelink logical channel (e.g., SIZE (1 . . . maxNrofSL-TCI)).

A wireless device may receive one or more radio resource control (RRC) messages comprising a plurality of scheduling request (SR) configurations. The SR configurations may be applicable for sidelink transmissions with a first logical channel identifier. Each SR configuration, of the plurality of SR configurations, may be associated with one or more respective sidelink transmission configuration indicator (TCI) states. The wireless device may trigger an SR for a first sidelink transmission. The first sidelink transmission may be (associated) with the first logical channel identifier. The first sidelink transmission may be associated with a first sidelink TCI state. The wireless device may, based on a first SR configuration, of the plurality of SR configurations, being associated with the first sidelink TCI state, transmit the SR using the first SR configuration.

A wireless device may receive a plurality of scheduling request (SR) configurations for sidelink transmissions with a first logical channel identifier (LCID), wherein each SR configuration, of the plurality of SR configurations, is associated with one or more respective sidelink transmission configuration indicator (TCI) states. The wireless device may transmit, based on a first SR configuration, of the plurality of SR configurations, being associated with a first sidelink TCI state of a first sidelink transmission with the first LCID, an SR for the first sidelink transmission using the first SR configuration.

The sidelink transmissions may comprise data of a first sidelink logical channel identified with the first LCID. The first LCID may identify a sidelink logical channel instance of the first sidelink logical channel. The first SR configuration may be associated with the first sidelink logical channel and the first sidelink TCI state.

The wireless device may trigger a sidelink buffer status reporting (BSR) for the data of the first logical channel. The wireless device may determine no uplink shared channel resource is available for transmitting the sidelink BSR. The wireless device may trigger the SR in response to the determining. The wireless device may determine/select the first SR configuration, from the plurality of SR configurations, of the first sidelink logical channel and the first TCI state, as a corresponding SR configuration for the SR.

The first sidelink logical channel may belong to a destination wireless device associated with the first sidelink TCI state. The wireless device may receive, from the destination wireless device, a sidelink beam report for unicast sidelink communications with the wireless device, indicating: the first sidelink TCI state and/or a first sidelink reference signal associated with the first sidelink TCI state. The wireless device may determine, for unicast sidelink communications with the destination wireless device and based on a reference signal received power measurement: the first sidelink TCI state and/or a first sidelink reference signal associated with the first sidelink TCI state.

The sidelink transmissions may comprise a first sidelink medium access control control element (MAC CE) identified with the first LCID. The first LCID may identify a type of the first sidelink MAC CE. The first SR configuration may be associated with the first sidelink MAC CE and the first sidelink TCI state. The first sidelink MAC CE may be a sidelink channel state information (CSI) reporting MAC CE.

The wireless device may trigger a sidelink CSI reporting to a destination wireless device associated with the first sidelink TCI state. The first sidelink MAC CE may be a sidelink discontinuous reception (DRX) command MAC CE. The wireless device may trigger a sidelink DRX command indication to a destination wireless device associated with the first sidelink TCI state.

The first sidelink MAC CE may be a sidelink beam reporting MAC CE. The wireless device may trigger a sidelink beam reporting to a destination wireless device associated with the first sidelink TCI state.

The first sidelink MAC CE may be a sidelink beam failure recovery (BFR) MAC CE. The wireless device may trigger a sidelink BFR reporting to a destination wireless device associated with the first sidelink TCI state.

The wireless device may determine that the wireless device has no sidelink shared channel resource for transmitting the first sidelink MAC CE. The wireless device may trigger the SR in response to the determining. The wireless device may determine/select the first SR configuration, of the first sidelink MAC CE and the first TCI state, as a corresponding SR configuration for the SR.

The first sidelink transmission may be for a destination wireless device associated with the first sidelink TCI state. The wireless device may receive, from the destination wireless device, a sidelink beam report for unicast sidelink communications with the wireless device, indicating: the first sidelink TCI state and/or a first sidelink reference signal associated with the first sidelink TCI state. The wireless device may determine, for unicast sidelink communications with the destination wireless device and based on a reference signal received power measurement: the first sidelink TCI state; and/or a first sidelink reference signal associated with the first sidelink TCI state.

Each of the one or more respective TCI states may indicate a respective sidelink reference signal of the wireless device.

The wireless device may receive one or more radio resource control (RRC) messages comprising the plurality of SR configurations. The one or more RRC messages may comprise a first RRC reconfiguration message, from network, indicating a cell group of the wireless device. The first RRC reconfiguration message may comprise the plurality of SR configurations for the cell group. Each SR configuration, of the plurality of SR configurations, may be identified by a respective SR identifier. Each SR configuration, of the plurality of SR configurations, may indicate one or more respective PUCCH resources. The wireless device may transmit the SR via/in a first PUCCH resource indicated by the first SR configuration.

The wireless device may receive sidelink communication configurations comprising sidelink configuration parameters for sidelink communication of the wireless device. The wireless device may receive, from a base station or a second wireless device, one or more radio resource control (RRC) messages comprising the sidelink communication configurations. The wireless device may receive, from a base station or a second wireless device, a system information block (SIB) comprising the sidelink communication configurations. The sidelink configuration parameters may comprise sidelink logical channel configuration parameters of a first logical channel identified by the first logical channel identifier. The sidelink configuration parameters may indicate a list of SR identifiers. Each SR identifier, of the SR identifiers, may identify a respective SR configuration of the plurality of SR configurations. The sidelink configuration parameters may indicate, for each SR identifier of the SR identifiers, the one or more respective sidelink TCI states. The sidelink configuration parameters may indicate a mapping between each SR configuration, of the plurality of SR configurations, and the one or more respective sidelink TCI states. The sidelink configuration parameters may comprise TCI state configuration parameters indicating a plurality of sidelink TCI states, comprising the first sidelink TCI state, for sidelink communications of the wireless device. Each sidelink TCI state, of the plurality of sidelink TCI states, may indicate a sidelink reference signal of the wireless device.

Each SR configuration, of the plurality of SR configurations, may be applicable for sidelink shared channel transmissions associated with one or more respective TCI states. The first sidelink TCI state may indicate one or more sidelink reference signals for communication with a destination wireless device of the first sidelink transmission.

The wireless device may trigger the SR based on the first SR configuration. The wireless device may transmit the first SR to a base station. The wireless device may receive, from the base station, a sidelink grant indicating: a sidelink shared channel resource and/or the first sidelink TCI state. The wireless device may transmit, to a destination wireless device and via the sidelink shared channel resource, the first sidelink transmission based on the first sidelink TCI state.

The wireless device may receive a radio resource control (RRC) message comprising a plurality of scheduling request (SR) configurations, wherein each SR configuration, of the plurality of SR configurations, is associated with one or more respective sidelink reference signals of the wireless device. The wireless device may trigger a first SR, corresponding to a first SR configuration of the plurality of SR configurations, for a first physical sidelink shared channel (PSSCH) transmission to a destination wireless device, wherein: a first sidelink reference signal is used for sidelink transmission to the destination wireless device and/or the first SR configuration is associated with the first sidelink reference signal. The wireless device may transmit the first SR to a base station. The wireless device may receive, from the base station, a sidelink grant indicating: a PSSCH resource and/or the first sidelink reference signal. The wireless device may transmit, to the destination wireless device and via the PSSCH resource, the first PSSCH transmission based on the first sidelink reference signal.

The wireless device may transmit, for requesting a resource for a sidelink transmission, a first SR corresponding to a first logical channel identifier based on: the sidelink transmission being associated with the first logical channel identifier; the sidelink transmission being associated with a first TCI state of one or more TCI states; and/or the first SR being associated with the first TCI.

The wireless device may receive a plurality of scheduling request (SR) configurations for a first sidelink logical channel, wherein each SR configuration, of the plurality of SR configurations, is associated with one or more respective sidelink transmission configuration indicator (TCI) states. The wireless device may transmit, based on a first SR configuration, of the plurality of SR configurations, being associated with a first sidelink TCI state of a destination wireless device of the first sidelink logical channel, an SR using the first SR configuration.

The wireless device may receive a plurality of scheduling request (SR) configurations for a first sidelink medium access control control element (MAC CE), wherein each SR configuration, of the plurality of SR configurations, is associated with one or more respective sidelink transmission configuration indicator (TCI) states. The wireless device may transmit based on a first SR configuration, of the plurality of SR configurations, being associated with a first sidelink TCI state of a destination wireless device of the first sidelink MAC CE, an SR using the first SR configuration.

In some aspects, the techniques described herein relate to a method including: receiving, by a wireless device, one or more radio resource control (RRC) messages including a plurality of scheduling request (SR) configurations applicable for sidelink transmissions including data from a first logical channel, wherein each SR configuration, of the plurality of SR configurations, is associated with one or more respective sidelink transmission configuration indicator (TCI) states; triggering an SR for a first sidelink transmission, including the data from the first logical channel, wherein the first sidelink transmission is associated with a first sidelink TCI state; and based on a first SR configuration, of the plurality of SR configurations, being associated with the first sidelink TCI state, transmitting the SR using the first SR configuration.

In some aspects, the techniques described herein relate to a method including: transmitting, by a wireless device, a scheduling request (SR) for a sidelink transmission that is based on a first sidelink reference signal, wherein a first SR configuration is used for the transmitting in response to the first SR configuration being associated with the first sidelink reference signal.

In some aspects, the techniques described herein relate to a method, wherein the first SR configuration is applicable for sidelink transmissions associated with the first sidelink reference signal.

In some aspects, the techniques described herein relate to a method, wherein the first SR configuration is applicable for sidelink transmissions associated with a first sidelink transmission configuration indicator (TCI) state that indicates the first sidelink reference signal.

In some aspects, the techniques described herein relate to a method, wherein the sidelink transmission is based on a first sidelink transmission configuration indicator (TCI) state that indicates the first sidelink reference signal.

In some aspects, the techniques described herein relate to a method, further including selecting the first SR configuration from a plurality of SR configurations.

In some aspects, the techniques described herein relate to a method, wherein the selecting is in response to the first SR configuration being associated with the first sidelink reference signal among a plurality of sidelink reference signals.

In some aspects, the techniques described herein relate to a method, wherein each SR configuration, of the plurality of SR configurations, is associated with one or more respective sidelink reference signals of a plurality of sidelink reference signals.

In some aspects, the techniques described herein relate to a method, wherein the selecting is in response to the first SR configuration being associated with a first sidelink transmission configuration indicator (TCI) state, among a plurality of sidelink TCI states, that indicates the first sidelink reference signal.

In some aspects, the techniques described herein relate to a method, wherein each SR configuration, of the plurality of SR configurations, is associated with one or more respective sidelink TCI states of the plurality of sidelink TCI states.

In some aspects, the techniques described herein relate to a method, wherein the plurality of SR configurations are associated with a first logical channel.

In some aspects, the techniques described herein relate to a method, further including receiving one or more radio resource control (RRC) messages indicating a plurality of scheduling request (SR) configurations including the first SR configuration.

In some aspects, the techniques described herein relate to a method, wherein the plurality of SR configurations are associated with a first logical channel.

In some aspects, the techniques described herein relate to a method, wherein the plurality of SR configurations are applicable for sidelink transmissions including data from a first logical channel.

In some aspects, the techniques described herein relate to a method, wherein the first logical channel is identified by a first logical channel identifier (LCID).

In some aspects, the techniques described herein relate to a method, wherein the first LCID identifies a sidelink logical channel instance of the first logical channel.

In some aspects, the techniques described herein relate to a method, wherein each SR configuration, of the plurality of SR configurations, is associated with one or more respective sidelink reference signals.

In some aspects, the techniques described herein relate to a method, wherein the sidelink transmission includes data from the first logical channel.

In some aspects, the techniques described herein relate to a method, wherein using the first SR configuration for the transmitting is further in response to the first SR configuration being associated with the first logical channel.

In some aspects, the techniques described herein relate to a method, further including triggering a sidelink buffer status reporting (BSR) for data of the first logical channel.

In some aspects, the techniques described herein relate to a method, further including determining no uplink shared channel resource is available for transmitting the sidelink BSR.

In some aspects, the techniques described herein relate to a method, further including triggering the SR in response to the determining.

In some aspects, the techniques described herein relate to a method, further including determining the first SR configuration as a corresponding SR configuration for the SR.

In some aspects, the techniques described herein relate to a method, wherein the first logical channel belongs to a destination wireless device associated with the first sidelink reference signal.

In some aspects, the techniques described herein relate to a method, further including receiving a sidelink beam report for unicast sidelink communications with the wireless device, indicating: a first sidelink TCI state associated with the first sidelink reference signal; or the first sidelink reference signal.

In some aspects, the techniques described herein relate to a method, wherein the receiving is from a destination wireless device.

In some aspects, the techniques described herein relate to a method, further including determining, for unicast sidelink communications with a destination wireless device and based on a reference signal received power measurement: a first sidelink TCI state associated with the first sidelink reference signal; or the first sidelink reference signal.

In some aspects, the techniques described herein relate to a method, wherein the sidelink transmission includes a first sidelink medium access control control element (MAC CE) identified with a first logical channel identifier (LCID).

In some aspects, the techniques described herein relate to a method, wherein the first LCID identifies a type of the first sidelink MAC CE.

In some aspects, the techniques described herein relate to a method, wherein the first SR configuration is used for the transmitting in response to the first SR configuration being associated with the first sidelink MAC CE.

In some aspects, the techniques described herein relate to a method, wherein the first sidelink MAC CE is a sidelink channel state information (CSI) reporting MAC CE.

In some aspects, the techniques described herein relate to a method, further including triggering a sidelink channel state information (CSI) reporting to a destination wireless device associated with the first sidelink reference signal.

In some aspects, the techniques described herein relate to a method, wherein the first sidelink MAC CE is a sidelink discontinuous reception (DRX) command MAC CE.

In some aspects, the techniques described herein relate to a method, further including triggering a sidelink DRX command indication to a destination wireless device associated with the first sidelink reference signal.

In some aspects, the techniques described herein relate to a method, wherein the first sidelink MAC CE is a sidelink beam reporting MAC CE.

In some aspects, the techniques described herein relate to a method, further including triggering a sidelink beam reporting to a destination wireless device associated with the first sidelink reference signal.

In some aspects, the techniques described herein relate to a method, wherein the first sidelink MAC CE is a sidelink beam failure recovery (BFR) MAC CE.

In some aspects, the techniques described herein relate to a method, further including triggering a sidelink BFR reporting to a destination wireless device associated with the first sidelink reference signal.

In some aspects, the techniques described herein relate to a method, further including determining that the wireless device has no sidelink shared channel resource for transmitting the first sidelink MAC CE.

In some aspects, the techniques described herein relate to a method, further including triggering the SR in response to the determining that the wireless device has no sidelink shared channel resource for transmitting the first sidelink MAC CE.

In some aspects, the techniques described herein relate to a method, further including determining the first SR configuration, as a corresponding SR configuration for the SR.

In some aspects, the techniques described herein relate to a method, wherein the sidelink transmission is for a destination wireless device associated with the first sidelink reference signal.

In some aspects, the techniques described herein relate to a method, further including receiving one or more radio resource control (RRC) messages including configuration parameters indicating a plurality of SR configurations including the first SR configuration.

In some aspects, the techniques described herein relate to a method, wherein the one or more RRC messages include a first RRC reconfiguration message, from network, indicating a cell group of the wireless device.

In some aspects, the techniques described herein relate to a method, wherein the first RRC reconfiguration message includes the plurality of SR configurations for the cell group.

In some aspects, the techniques described herein relate to a method, wherein each SR configuration, of the plurality of SR configurations, is identified by a respective SR identifier.

In some aspects, the techniques described herein relate to a method, wherein each SR configuration, of the plurality of SR configurations, indicates one or more respective PUCCH resources.

In some aspects, the techniques described herein relate to a method, further including transmitting the SR via a first PUCCH resource indicated by the first SR configuration.

In some aspects, the techniques described herein relate to a method, further including receiving sidelink communication configurations including sidelink configuration parameters for sidelink communication of the wireless device.

In some aspects, the techniques described herein relate to a method, further including receiving, from a base station or a second wireless device, one or more radio resource control (RRC) messages including the sidelink communication configurations.

In some aspects, the techniques described herein relate to a method, further including receiving, from a base station or a second wireless device, a system information block (SIB) including the sidelink communication configurations.

In some aspects, the techniques described herein relate to a method, wherein the sidelink configuration parameters include sidelink logical channel configuration parameters of a first logical channel identified by a first logical channel identifier.

In some aspects, the techniques described herein relate to a method, wherein the sidelink configuration parameters indicate a list of SR identifiers.

In some aspects, the techniques described herein relate to a method, wherein each SR identifier, of the SR identifiers, identifies a respective SR configuration of a plurality of SR configurations.

In some aspects, the techniques described herein relate to a method, wherein the sidelink configuration parameters indicate, for each SR identifier of the SR identifiers, one or more respective sidelink TCI states from a plurality of sidelink TCI states.

In some aspects, the techniques described herein relate to a method, wherein each sidelink TCI state, of the plurality of sidelink TCI states, indicates a respective sidelink reference signal of a plurality of sidelink reference signals.

In some aspects, the techniques described herein relate to a method, wherein the sidelink configuration parameters indicate a mapping between each SR configuration, of the plurality of SR configurations, and the one or more respective sidelink TCI states.

In some aspects, the techniques described herein relate to a method, wherein the sidelink configuration parameters include TCI state configuration parameters indicating a plurality of sidelink TCI states, including a first sidelink TCI state associated with the first sidelink reference signal, for sidelink communications of the wireless device.

In some aspects, the techniques described herein relate to a method, wherein each SR configuration, of the plurality of SR configurations, is applicable for sidelink shared channel transmissions associated with one or more respective TCI states.

In some aspects, the techniques described herein relate to a method, further including triggering the SR based on the first SR configuration.

In some aspects, the techniques described herein relate to a method, further including transmitting the SR to a base station.

In some aspects, the techniques described herein relate to a method, further including receiving, from a base station, a sidelink grant indicating: a sidelink shared channel resource; and a first sidelink TCI state associated with the first sidelink reference signal.

In some aspects, the techniques described herein relate to a method, further including transmitting, to a destination wireless device and via the sidelink shared channel resource, the sidelink transmission based on the first sidelink TCI state.

In some aspects, the techniques described herein relate to a method including: transmitting, by base station to a wireless device, one or more radio resource control (RRC) messages including a plurality of scheduling request (SR) configurations applicable for sidelink transmissions including data from a first logical channel, wherein each SR configuration, of the plurality of SR configurations, is associated with one or more respective sidelink transmission configuration indicator (TCI) states; and based on a first SR configuration, of the plurality of SR configurations, being associated with the first sidelink TCI state, receiving an SR for a first sidelink transmission, including the data from the first logical channel, wherein: the first sidelink transmission is associated with the first sidelink TCI state; and the SR is transmitted using the first SR configuration.

In some aspects, the techniques described herein relate to a method including: transmitting, by a base station and to a wireless device, a first scheduling request (SR) configuration to be used for receiving, from the wireless device, an SR for a first sidelink transmission that is based on a first sidelink reference signal, wherein the first SR configuration is associated with the first sidelink reference signal.

In some aspects, the techniques described herein relate to a method, wherein the first SR configuration is applicable for sidelink transmissions associated with the first sidelink reference signal.

In some aspects, the techniques described herein relate to a method, wherein the first SR configuration is applicable for sidelink transmissions associated with a first sidelink transmission configuration indicator (TCI) state that indicates the first sidelink reference signal.

In some aspects, the techniques described herein relate to a method, wherein the sidelink transmission is based on a first sidelink transmission configuration indicator (TCI) state that indicates the first sidelink reference signal.

In some aspects, the techniques described herein relate to a method, further including selecting the first SR configuration from a plurality of SR configurations.

In some aspects, the techniques described herein relate to a method, wherein the selecting is in response to the first SR configuration being associated with the first sidelink reference signal among a plurality of sidelink reference signals.

In some aspects, the techniques described herein relate to a method, wherein each SR configuration, of the plurality of SR configurations, is associated with one or more respective sidelink reference signals of a plurality of sidelink reference signals.

In some aspects, the techniques described herein relate to a method, wherein the selecting is in response to the first SR configuration being associated with a first sidelink transmission configuration indicator (TCI) state, among a plurality of sidelink TCI states, that indicates the first sidelink reference signal.

In some aspects, the techniques described herein relate to a method, wherein each SR configuration, of the plurality of SR configurations, is associated with one or more respective sidelink TCI states of the plurality of sidelink TCI states.

In some aspects, the techniques described herein relate to a method, wherein the plurality of SR configurations are associated with a first logical channel.

In some aspects, the techniques described herein relate to a method, further including transmitting one or more radio resource control (RRC) messages indicating a plurality of scheduling request (SR) configurations including the first SR configuration.

In some aspects, the techniques described herein relate to a method, wherein the plurality of SR configurations are associated with a first logical channel.

In some aspects, the techniques described herein relate to a method, wherein the plurality of SR configurations are applicable for sidelink transmissions including data from a first logical channel.

In some aspects, the techniques described herein relate to a method, wherein the first logical channel is identified by a first logical channel identifier (LCID).

In some aspects, the techniques described herein relate to a method, wherein the first LCID identifies a sidelink logical channel instance of the first logical channel.

In some aspects, the techniques described herein relate to a method, wherein each SR configuration, of the plurality of SR configurations, is associated with one or more respective sidelink reference signals.

In some aspects, the techniques described herein relate to a method, wherein the sidelink transmission includes data from the first logical channel.

In some aspects, the techniques described herein relate to a method, wherein using the first SR configuration for the transmitting is further in response to the first SR configuration being associated with the first logical channel.

In some aspects, the techniques described herein relate to a method, further including receiving a sidelink buffer status reporting (BSR) for data of the first logical channel.

In some aspects, the techniques described herein relate to a method, further including determining no uplink shared channel resource is available for receiving the sidelink BSR.

In some aspects, the techniques described herein relate to a method, further including receiving the SR based on the determining.

In some aspects, the techniques described herein relate to a method, further including determining the first SR configuration as a corresponding SR configuration for the SR.

In some aspects, the techniques described herein relate to a method, wherein the first logical channel belongs to a destination wireless device associated with the first sidelink reference signal. In some aspects, the techniques described herein relate to a method, wherein the sidelink transmission includes a first sidelink medium access control control element (MAC CE) identified with a first logical channel identifier (LCID).

In some aspects, the techniques described herein relate to a method, wherein the first LCID identifies a type of the first sidelink MAC CE.

In some aspects, the techniques described herein relate to a method, wherein the first SR configuration is used for the receiving in response to the first SR configuration being associated with the first sidelink MAC CE.

In some aspects, the techniques described herein relate to a method, wherein the first sidelink MAC CE is a sidelink channel state information (CSI) reporting MAC CE.

In some aspects, the techniques described herein relate to a method, further including triggering a sidelink channel state information (CSI) reporting to a destination wireless device associated with the first sidelink reference signal.

In some aspects, the techniques described herein relate to a method, wherein the first sidelink MAC CE is a sidelink discontinuous reception (DRX) command MAC CE.

In some aspects, the techniques described herein relate to a method, further including triggering a sidelink DRX command indication to a destination wireless device associated with the first sidelink reference signal.

In some aspects, the techniques described herein relate to a method, wherein the first sidelink MAC CE is a sidelink beam reporting MAC CE.

In some aspects, the techniques described herein relate to a method, further including triggering a sidelink beam reporting to a destination wireless device associated with the first sidelink reference signal.

In some aspects, the techniques described herein relate to a method, wherein the first sidelink MAC CE is a sidelink beam failure recovery (BFR) MAC CE.

In some aspects, the techniques described herein relate to a method, further including triggering a sidelink BFR reporting to a destination wireless device associated with the first sidelink reference signal.

In some aspects, the techniques described herein relate to a method, further including determining that the wireless device has no sidelink shared channel resource for transmitting the first sidelink MAC CE.

In some aspects, the techniques described herein relate to a method, further including triggering the SR in response to the determining that the wireless device has no sidelink shared channel resource for transmitting the first sidelink MAC CE.

In some aspects, the techniques described herein relate to a method, further including determining the first SR configuration, as a corresponding SR configuration for the SR.

In some aspects, the techniques described herein relate to a method, wherein the sidelink transmission is for a destination wireless device associated with the first sidelink reference signal.

In some aspects, the techniques described herein relate to a method, further including transmitting one or more radio resource control (RRC) messages including configuration parameters indicating a plurality of SR configurations including the first SR configuration.

In some aspects, the techniques described herein relate to a method, wherein the one or more RRC messages include a first RRC reconfiguration message, from network, indicating a cell group of the wireless device.

In some aspects, the techniques described herein relate to a method, wherein the first RRC reconfiguration message includes the plurality of SR configurations for the cell group.

In some aspects, the techniques described herein relate to a method, wherein each SR configuration, of the plurality of SR configurations, is identified by a respective SR identifier.

In some aspects, the techniques described herein relate to a method, wherein each SR configuration, of the plurality of SR configurations, indicates one or more respective PUCCH resources.

In some aspects, the techniques described herein relate to a method, further including receiving the SR via a first PUCCH resource indicated by the first SR configuration.

In some aspects, the techniques described herein relate to a method, further including transmitting sidelink communication configurations including sidelink configuration parameters for sidelink communication of the wireless device.

In some aspects, the techniques described herein relate to a method, further including transmitting one or more radio resource control (RRC) messages including the sidelink communication configurations.

In some aspects, the techniques described herein relate to a method, further including transmitting a system information block (SIB) including the sidelink communication configurations.

In some aspects, the techniques described herein relate to a method, wherein the sidelink configuration parameters include sidelink logical channel configuration parameters of a first logical channel identified by a first logical channel identifier.

In some aspects, the techniques described herein relate to a method, wherein the sidelink configuration parameters indicate a list of SR identifiers.

In some aspects, the techniques described herein relate to a method, wherein each SR identifier, of the SR identifiers, identifies a respective SR configuration of a plurality of SR configurations.

In some aspects, the techniques described herein relate to a method, wherein the sidelink configuration parameters indicate, for each SR identifier of the SR identifiers, one or more respective sidelink TCI states from a plurality of sidelink TCI states.

In some aspects, the techniques described herein relate to a method, wherein each sidelink TCI state, of the plurality of sidelink TCI states, indicates a respective sidelink reference signal of a plurality of sidelink reference signals.

In some aspects, the techniques described herein relate to a method, wherein the sidelink configuration parameters indicate a mapping between each SR configuration, of the plurality of SR configurations, and the one or more respective sidelink TCI states.

In some aspects, the techniques described herein relate to a method, wherein the sidelink configuration parameters include TCI state configuration parameters indicating a plurality of sidelink TCI states, including a first sidelink TCI state associated with the first sidelink reference signal, for sidelink communications of the wireless device.

In some aspects, the techniques described herein relate to a method, wherein each SR configuration, of the plurality of SR configurations, is applicable for sidelink shared channel transmissions associated with one or more respective TCI states.

In some aspects, the techniques described herein relate to a method, further including triggering the SR based on the first SR configuration.

In some aspects, the techniques described herein relate to a method, further including receiving the SR from the wireless device.

In some aspects, the techniques described herein relate to a method, further including transmitting, to the wireless device, a sidelink grant indicating: a sidelink shared channel resource; and a first sidelink TCI state associated with the first sidelink reference signal.

In some aspects, the techniques described herein relate to an apparatus including: one or more processors; and memory storing instructions that, when executed by the one or more processors, cause the apparatus to perform any of the methods disclosed herein.

In some aspects, the techniques described herein relate to a non-transitory computer-readable medium including instructions that, when executed by one or more processors of an apparatus, cause the apparatus to perform any of the methods disclosed herein.

Clause 1. A method comprising: receiving, by a wireless device, one or more radio resource control (RRC) messages comprising a plurality of scheduling request (SR) configurations applicable for sidelink transmissions comprising data from a first logical channel, wherein each SR configuration, of the plurality of SR configurations, is associated with one or more respective sidelink transmission configuration indicator (TCI) states; triggering an SR for a first sidelink transmission, comprising the data from the first logical channel, wherein the first sidelink transmission is associated with a first sidelink TCI state; and based on a first SR configuration, of the plurality of SR configurations, being associated with the first sidelink TCI state, transmitting the SR using the first SR configuration.

Clause 2. A method comprising: transmitting, by a wireless device, a scheduling request (SR) for a sidelink transmission that is based on a first sidelink reference signal, wherein a first SR configuration is used for the transmitting in response to the first SR configuration being associated with the first sidelink reference signal.

Clause 3. The method of clause 2, wherein the first SR configuration is applicable for sidelink transmissions associated with the first sidelink reference signal.

Clause 4. The method of any one of clauses 2-3, wherein the first SR configuration is applicable for sidelink transmissions associated with a first sidelink transmission configuration indicator (TCI) state that indicates the first sidelink reference signal.

Clause 5. The method of any one of clauses 2-4, wherein the sidelink transmission is based on a first sidelink transmission configuration indicator (TCI) state that indicates the first sidelink reference signal.

Clause 6. The method of any one of clauses 2-5, further comprising selecting the first SR configuration from a plurality of SR configurations.

Clause 7. The method of clause 6, wherein the selecting is in response to the first SR configuration being associated with the first sidelink reference signal among a plurality of sidelink reference signals.

Clause 8. The method of any one of clauses 6-7, wherein each SR configuration, of the plurality of SR configurations, is associated with one or more respective sidelink reference signals of a plurality of sidelink reference signals.

Clause 9. The method of clause 6, wherein the selecting is in response to the first SR configuration being associated with a first sidelink transmission configuration indicator (TCI) state, among a plurality of sidelink TCI states, that indicates the first sidelink reference signal.

Clause 10. The method of clause 9, wherein each SR configuration, of the plurality of SR configurations, is associated with one or more respective sidelink TCI states of the plurality of sidelink TCI states.

Clause 11. The method of any one of clauses 6-10, wherein the plurality of SR configurations are associated with a first logical channel.

Clause 12. The method of any one of clauses 2-11, further comprising receiving one or more radio resource control (RRC) messages indicating a plurality of scheduling request (SR) configurations comprising the first SR configuration.

Clause 13. The method of clause 12, wherein the plurality of SR configurations are associated with a first logical channel.

Clause 14. The method of any one of clauses 12-13, wherein the plurality of SR configurations are applicable for sidelink transmissions comprising data from a first logical channel.

Clause 15. The method of clause 14, wherein the first logical channel is identified by a first logical channel identifier (LCID).

Clause 16. The method of clause 15, wherein the first LCID identifies a sidelink logical channel instance of the first logical channel.

Clause 17. The method of any one of clauses 12-16, wherein each SR configuration, of the plurality of SR configurations, is associated with one or more respective sidelink reference signals.

Clause 18. The method of any one of clauses 2-17, wherein the sidelink transmission comprises data from the first logical channel.

Clause 19. The method of any one of clauses 2-18, wherein using the first SR configuration for the transmitting is further in response to the first SR configuration being associated with the first logical channel.

Clause 20. The method of any one of clauses 1-19, further comprising triggering a sidelink buffer status reporting (BSR) for data of the first logical channel.

Clause 21. The method of clause 20, further comprising determining no uplink shared channel resource is available for transmitting the sidelink BSR.

Clause 22. The method of clause 21, further comprising triggering the SR in response to the determining.

Clause 23. The method of any one of clauses 1-22, further comprising determining the first SR configuration as a corresponding SR configuration for the SR.

Clause 24. The method of any one of clauses 11-23, wherein the first logical channel belongs to a destination wireless device associated with the first sidelink reference signal.

Clause 25. The method of any one of clauses 1-24, further comprising receiving a sidelink beam report for unicast sidelink communications with the wireless device, indicating: a first sidelink TCI state associated with the first sidelink reference signal; or the first sidelink reference signal.

Clause 26. The method of clause 25, wherein the receiving is from a destination wireless device.

Clause 27. The method of any one of clauses 1-26, further comprising determining, for unicast sidelink communications with a destination wireless device and based on a reference signal received power measurement: a first sidelink TCI state associated with the first sidelink reference signal; or the first sidelink reference signal.

Clause 28. The method of any one of clauses 1-27, wherein the sidelink transmission comprises a first sidelink medium access control control element (MAC CE) identified with a first logical channel identifier (LCID).

Clause 29. The method of clause 28, wherein the first LCID identifies a type of the first sidelink MAC CE.

Clause 30. The method of any one of clauses 28-29, wherein the first SR configuration is used for the transmitting in response to the first SR configuration being associated with the first sidelink MAC CE.

Clause 31. The method of any one of clauses 28-30, wherein the first sidelink MAC CE is a sidelink channel state information (CSI) reporting MAC CE.

Clause 32. The method of any one of clauses 1-31, further comprising triggering a sidelink channel state information (CSI) reporting to a destination wireless device associated with the first sidelink reference signal.

Clause 33. The method of any one of clauses 28-30, wherein the first sidelink MAC CE is a sidelink discontinuous reception (DRX) command MAC CE.

Clause 34. The method of any one of clauses 1-33, further comprising triggering a sidelink DRX command indication to a destination wireless device associated with the first sidelink reference signal.

Clause 35. The method of any one of clauses 28-30, wherein the first sidelink MAC CE is a sidelink beam reporting MAC CE.

Clause 36. The method of any one of clauses 1-35, further comprising triggering a sidelink beam reporting to a destination wireless device associated with the first sidelink reference signal.

Clause 37. The method of any one of clauses 28-30, wherein the first sidelink MAC CE is a sidelink beam failure recovery (BFR) MAC CE.

Clause 38. The method of any one of clauses 1-37, further comprising triggering a sidelink BFR reporting to a destination wireless device associated with the first sidelink reference signal.

Clause 39. The method of any one of clauses 28-30, further comprising determining that the wireless device has no sidelink shared channel resource for transmitting the first sidelink MAC CE.

Clause 40. The method of clause 39, further comprising triggering the SR in response to the determining that the wireless device has no sidelink shared channel resource for transmitting the first sidelink MAC CE.

Clause 41. The method of any one of clauses 1-40, further comprising determining the first SR configuration, as a corresponding SR configuration for the SR.

Clause 42. The method of any one of clauses 1-41, wherein the sidelink transmission is for a destination wireless device associated with the first sidelink reference signal.

Clause 43. The method of any one of clauses 1-42, further comprising receiving one or more radio resource control (RRC) messages comprising configuration parameters indicating a plurality of SR configurations comprising the first SR configuration.

Clause 44. The method of clause 43, wherein the one or more RRC messages comprise a first RRC reconfiguration message, from network, indicating a cell group of the wireless device.

Clause 45. The method of clause 44, wherein the first RRC reconfiguration message comprises the plurality of SR configurations for the cell group.

Clause 46. The method of any one of clauses 43-45, wherein each SR configuration, of the plurality of SR configurations, is identified by a respective SR identifier.

Clause 47. The method of any one of clauses 43-46, wherein each SR configuration, of the plurality of SR configurations, indicates one or more respective PUCCH resources.

Clause 48. The method of any one of clauses 1-47, further comprising transmitting the SR via a first PUCCH resource indicated by the first SR configuration.

Clause 49. The method of any one of clauses 1-48, further comprising receiving sidelink communication configurations comprising sidelink configuration parameters for sidelink communication of the wireless device.

Clause 50. The method of clause 49, further comprising receiving, from a base station or a second wireless device, one or more radio resource control (RRC) messages comprising the sidelink communication configurations.

Clause 51. The method of clause 49, further comprising receiving, from a base station or a second wireless device, a system information block (SIB) comprising the sidelink communication configurations.

Clause 52. The method of any one of clauses 49-51, wherein the sidelink configuration parameters comprise sidelink logical channel configuration parameters of a first logical channel identified by a first logical channel identifier.

Clause 53. The method of any one of clauses 49-52, wherein the sidelink configuration parameters indicate a list of SR identifiers.

Clause 54. The method of clause 53, wherein each SR identifier, of the SR identifiers, identifies a respective SR configuration of a plurality of SR configurations.

Clause 55. The method of any one of clauses 53-54, wherein the sidelink configuration parameters indicate, for each SR identifier of the SR identifiers, one or more respective sidelink TCI states from a plurality of sidelink TCI states.

Clause 56. The method of clause 55, wherein each sidelink TCI state, of the plurality of sidelink TCI states, indicates a respective sidelink reference signal of a plurality of sidelink reference signals.

Clause 57. The method of any one of clauses 55-56, wherein the sidelink configuration parameters indicate a mapping between each SR configuration, of the plurality of SR configurations, and the one or more respective sidelink TCI states.

Clause 58. The method of any one of clauses 49-57, wherein the sidelink configuration parameters comprise TCI state configuration parameters indicating a plurality of sidelink TCI states, comprising a first sidelink TCI state associated with the first sidelink reference signal, for sidelink communications of the wireless device.

Clause 59. The method of any one of clauses 6-58, wherein each SR configuration, of the plurality of SR configurations, is applicable for sidelink shared channel transmissions associated with one or more respective TCI states.

Clause 60. The method of any one of clauses 1-59, further comprising triggering the SR based on the first SR configuration.

Clause 61. The method of any one of clauses 1-60, further comprising transmitting the SR to a base station.

Clause 62. The method of any one of clauses 1-61, further comprising receiving, from a base station, a sidelink grant indicating: a sidelink shared channel resource; and a first sidelink TCI state associated with the first sidelink reference signal.

Clause 63. The method of any one of clauses 1-62, further comprising transmitting, to a destination wireless device and via the sidelink shared channel resource, the sidelink transmission based on the first sidelink TCI state.

Clause 64. A method comprising: transmitting, by base station to a wireless device, one or more radio resource control (RRC) messages comprising a plurality of scheduling request (SR) configurations applicable for sidelink transmissions comprising data from a first logical channel, wherein each SR configuration, of the plurality of SR configurations, is associated with one or more respective sidelink transmission configuration indicator (TCI) states; and based on a first SR configuration, of the plurality of SR configurations, being associated with the first sidelink TCI state, receiving an SR for a first sidelink transmission, comprising the data from the first logical channel, wherein: the first sidelink transmission is associated with the first sidelink TCI state; and the SR is transmitted using the first SR configuration.

Clause 65. A method comprising: transmitting, by a base station and to a wireless device, a first scheduling request (SR) configuration to be used for receiving, from the wireless device, an SR for a first sidelink transmission that is based on a first sidelink reference signal, wherein the first SR configuration is associated with the first sidelink reference signal.

Clause 66. The method of clause 65, wherein the first SR configuration is applicable for sidelink transmissions associated with the first sidelink reference signal.

Clause 67. The method of any one of clauses 65-66, wherein the first SR configuration is applicable for sidelink transmissions associated with a first sidelink transmission configuration indicator (TCI) state that indicates the first sidelink reference signal.

Clause 68. The method of any one of clauses 65-67, wherein the sidelink transmission is based on a first sidelink transmission configuration indicator (TCI) state that indicates the first sidelink reference signal.

Clause 69. The method of any one of clauses 65-68, further comprising selecting the first SR configuration from a plurality of SR configurations.

Clause 70. The method of clause 69, wherein the selecting is in response to the first SR configuration being associated with the first sidelink reference signal among a plurality of sidelink reference signals.

Clause 71. The method of any one of clauses 69-70, wherein each SR configuration, of the plurality of SR configurations, is associated with one or more respective sidelink reference signals of a plurality of sidelink reference signals.

Clause 72. The method of clause 69, wherein the selecting is in response to the first SR configuration being associated with a first sidelink transmission configuration indicator (TCI) state, among a plurality of sidelink TCI states, that indicates the first sidelink reference signal.

Clause 73. The method of clause 72, wherein each SR configuration, of the plurality of SR configurations, is associated with one or more respective sidelink TCI states of the plurality of sidelink TCI states.

Clause 74. The method of any one of clauses 69-70, wherein the plurality of SR configurations are associated with a first logical channel.

Clause 75. The method of any one of clauses 65-74, further comprising transmitting one or more radio resource control (RRC) messages indicating a plurality of scheduling request (SR) configurations comprising the first SR configuration.

Clause 76. The method of clause 75, wherein the plurality of SR configurations are associated with a first logical channel.

Clause 77. The method of any one of clauses 75-76, wherein the plurality of SR configurations are applicable for sidelink transmissions comprising data from a first logical channel.

Clause 78. The method of clause 77, wherein the first logical channel is identified by a first logical channel identifier (LCID).

Clause 79. The method of clause 78, wherein the first LCID identifies a sidelink logical channel instance of the first logical channel.

Clause 80. The method of any one of clauses 75-79, wherein each SR configuration, of the plurality of SR configurations, is associated with one or more respective sidelink reference signals.

Clause 81. The method of any one of clauses 75-80, wherein the sidelink transmission comprises data from the first logical channel.

Clause 82. The method of any one of clauses 75-81, wherein using the first SR configuration for the transmitting is further in response to the first SR configuration being associated with the first logical channel.

Clause 83. The method of any one of clauses 65-82, further comprising receiving a sidelink buffer status reporting (BSR) for data of the first logical channel.

Clause 84. The method of clause 83, further comprising determining no uplink shared channel resource is available for receiving the sidelink BSR.

Clause 85. The method of clause 84, further comprising receiving the SR based on the determining.

Clause 86. The method of any one of clauses 65-85, further comprising determining the first SR configuration as a corresponding SR configuration for the SR.

Clause 87. The method of any one of clauses 76-86, wherein the first logical channel belongs to a destination wireless device associated with the first sidelink reference signal.

Clause 88. The method of any one of clauses 64-87, wherein the sidelink transmission comprises a first sidelink medium access control control element (MAC CE) identified with a first logical channel identifier (LCID).

Clause 89. The method of clause 88, wherein the first LCID identifies a type of the first sidelink MAC CE.

Clause 90. The method of any one of clauses 88-89, wherein the first SR configuration is used for the receiving in response to the first SR configuration being associated with the first sidelink MAC CE.

Clause 91. The method of any one of clauses 88-90, wherein the first sidelink MAC CE is a sidelink channel state information (CSI) reporting MAC CE.

Clause 92. The method of any one of clauses 64-91, further comprising triggering a sidelink channel state information (CSI) reporting to a destination wireless device associated with the first sidelink reference signal.

Clause 93. The method of any one of clauses 88-90, wherein the first sidelink MAC CE is a sidelink discontinuous reception (DRX) command MAC CE.

Clause 94. The method of any one of clauses 64-93, further comprising triggering a sidelink DRX command indication to a destination wireless device associated with the first sidelink reference signal.

Clause 95. The method of any one of clauses 88-90, wherein the first sidelink MAC CE is a sidelink beam reporting MAC CE.

Clause 96. The method of any one of clauses 64-95, further comprising triggering a sidelink beam reporting to a destination wireless device associated with the first sidelink reference signal.

Clause 97. The method of any one of clauses 88-90, wherein the first sidelink MAC CE is a sidelink beam failure recovery (BFR) MAC CE.

Clause 98. The method of any one of clauses 64-97, further comprising triggering a sidelink BFR reporting to a destination wireless device associated with the first sidelink reference signal.

Clause 99. The method of any one of clauses 88-90, further comprising determining that the wireless device has no sidelink shared channel resource for transmitting the first sidelink MAC CE.

Clause 100. The method of clause 99, further comprising triggering the SR in response to the determining that the wireless device has no sidelink shared channel resource for transmitting the first sidelink MAC CE.

Clause 101. The method of any one of clauses 65-100, further comprising determining the first SR configuration, as a corresponding SR configuration for the SR.

Clause 102. The method of any one of clauses 65-101, wherein the sidelink transmission is for a destination wireless device associated with the first sidelink reference signal.

Clause 103. The method of any one of clauses 65-102, further comprising transmitting one or more radio resource control (RRC) messages comprising configuration parameters indicating a plurality of SR configurations comprising the first SR configuration.

Clause 104. The method of clause 103, wherein the one or more RRC messages comprise a first RRC reconfiguration message, from network, indicating a cell group of the wireless device.

Clause 105. The method of clause 104, wherein the first RRC reconfiguration message comprises the plurality of SR configurations for the cell group.

Clause 106. The method of any one of clauses 103-105, wherein each SR configuration, of the plurality of SR configurations, is identified by a respective SR identifier.

Clause 107. The method of any one of clauses 103-106, wherein each SR configuration, of the plurality of SR configurations, indicates one or more respective PUCCH resources.

Clause 108. The method of any one of clauses 64-107, further comprising receiving the SR via a first PUCCH resource indicated by the first SR configuration.

Clause 109. The method of any one of clauses 64-108, further comprising transmitting sidelink communication configurations comprising sidelink configuration parameters for sidelink communication of the wireless device.

Clause 110. The method of clause 109, further comprising transmitting one or more radio resource control (RRC) messages comprising the sidelink communication configurations.

Clause 111. The method of clause 109, further comprising transmitting a system information block (SIB) comprising the sidelink communication configurations.

Clause 112. The method of any one of clauses 109-111, wherein the sidelink configuration parameters comprise sidelink logical channel configuration parameters of a first logical channel identified by a first logical channel identifier.

Clause 113. The method of any one of clauses 109-112, wherein the sidelink configuration parameters indicate a list of SR identifiers.

Clause 114. The method of clause 113, wherein each SR identifier, of the SR identifiers, identifies a respective SR configuration of a plurality of SR configurations.

Clause 115. The method of any one of clauses 113-114, wherein the sidelink configuration parameters indicate, for each SR identifier of the SR identifiers, one or more respective sidelink TCI states from a plurality of sidelink TCI states.

Clause 116. The method of clause 115, wherein each sidelink TCI state, of the plurality of sidelink TCI states, indicates a respective sidelink reference signal of a plurality of sidelink reference signals.

Clause 117. The method of any one of clauses 115-116, wherein the sidelink configuration parameters indicate a mapping between each SR configuration, of the plurality of SR configurations, and the one or more respective sidelink TCI states.

Clause 118. The method of any one of clauses 109-117, wherein the sidelink configuration parameters comprise TCI state configuration parameters indicating a plurality of sidelink TCI states, comprising a first sidelink TCI state associated with the first sidelink reference signal, for sidelink communications of the wireless device.

Clause 119. The method of any one of clauses 69-118, wherein each SR configuration, of the plurality of SR configurations, is applicable for sidelink shared channel transmissions associated with one or more respective TCI states.

Clause 120. The method of any one of clauses 64-119, further comprising triggering the SR based on the first SR configuration.

Clause 121. The method of any one of clauses 64-120, further comprising receiving the SR from the wireless device.

Clause 122. The method of any one of clauses 64-121, further comprising transmitting, to the wireless device, a sidelink grant indicating: a sidelink shared channel resource; and a first sidelink TCI state associated with the first sidelink reference signal.

Clause 123. An apparatus (e.g., wireless device or base station) comprising: one or more processors; and memory storing instructions that, when executed by the one or more processors, cause the apparatus to perform the method of any one of clauses 1-122.

Clause 124. A non-transitory computer-readable medium comprising instructions that, when executed by one or more processors of an apparatus (e.g., wireless device or base station), cause the apparatus to perform the method of any one of clauses 1-122.

What is claimed is:

1. A wireless device comprising:
one or more processors; and
memory storing instructions that, when executed by the one or more processors, cause the wireless device to:
receive, from a base station, one or more radio resource control (RRC) messages comprising configuration parameters indicating:
a first scheduling request (SR) configuration applicable for requesting sidelink (SL) resources for SL transmissions comprising SL reference signals (RSs);
an SL resource pool for transmission of SL data and SL RSs; and
SL RS resources for transmission of SL RSs in slots of the SL resource pool, wherein each of the SL RS resources comprises one or more symbols of a slot;
trigger, based on an SL transmission comprising an SL RS, an SR using the first SR configuration;
transmit, to the base station, the SR via a physical uplink control channel (PUCCH) resource indicated by the first SR configuration;
receive, from the base station and after the transmitting the SR, downlink control information (DCI) indicating an SL resource in a first slot of the SL resource pool; and
transmit to a second wireless device and via the SL resource:
SL data;
SL control information (SCI) indicating an SL RS resource, of the SL RS resources, in the first slot; and
the SL RS, wherein the transmitting the SL RS is via one or more first symbols, of the first slot, indicated by the SL RS resource.

2. The wireless device of claim 1, wherein the one or more RRC messages comprise an RRC reconfiguration message.

3. The wireless device of claim 1, wherein:
the DCI comprises fields corresponding to the SL resource,
the fields indicating:
an index of the SL resource pool;
a frequency resource assignment of the SL resource; and
a time resource assignment of the SL resource; and
the fields comprise a time gap field with a value indicating a slot offset between a slot of the DCI and the first slot.

4. The wireless device of claim 3, wherein the instructions further cause the wireless device to:
determine, based on the fields and for the SL resource, a physical SL shared channel (PSSCH) duration; and
transmit the SL data via the PSSCH duration.

5. The wireless device of claim 4, wherein the fields further comprise a first field with a value indicating the one or more first symbols.

6. The wireless device of claim 1, wherein:
the one or more RRC messages indicate a plurality of SR configurations, comprising the first SR configuration;
each SR configuration, of the plurality of SR configurations, is associated with a respective logical channel identifier (LCID); and
the first SR configuration is associated with a first LCID.

7. The wireless device of claim 6, wherein triggering the SR using the first SR configuration, among the plurality of SR configurations, is further based on the SL transmission, comprising the SL RS, being associated with the first LCID.

8. A method comprising:
receiving, by a wireless device and from a base station, one or more radio resource control (RRC) messages comprising configuration parameters indicating:
a first scheduling request (SR) configuration applicable for requesting sidelink (SL) resources for SL transmissions comprising SL reference signals (RSs);
an SL resource pool for transmission of SL data and SL RSs; and
SL RS resources for transmission of SL RSs in slots of the SL resource pool, wherein each of the SL RS resources comprises one or more symbols of a slot;
triggering, based on an SL transmission comprising an SL RS, an SR using the first SR configuration;
transmitting, to the base station, the SR via a physical uplink control channel (PUCCH) resource indicated by the first SR configuration;
receiving, from the base station and after the transmitting the SR, downlink control information (DCI) indicating an SL resource in a first slot of the SL resource pool; and
transmitting to a second wireless device and via the SL resource:
SL data;
SL control information (SCI) indicating an SL RS resource, of the SL RS resources, in the first slot; and
the SL RS, wherein the transmitting the SL RS is via one or more first symbols, of the first slot, indicated by the SL RS resource.

9. The method of claim 8, wherein the one or more RRC messages comprise an RRC reconfiguration message.

10. The method of claim 8, wherein:
the DCI comprises fields corresponding to the SL resource,
the fields indicating:
an index of the SL resource pool;
a frequency resource assignment of the SL resource; and
a time resource assignment of the SL resource; and
the fields comprise a time gap field with a value indicating a slot offset between a slot of the DCI and the first slot.

11. The method of claim 10, further comprising:
determining, based on the fields and for the SL resource, a physical SL shared channel (PSSCH) duration; and
transmitting the SL data via the PSSCH duration.

12. The method of claim 11, wherein the fields further comprise a first field with a value indicating the one or more first symbols.

13. The method of claim 8, wherein:
the one or more RRC messages indicate a plurality of SR configurations, comprising the first SR configuration;
each SR configuration, of the plurality of SR configurations, is associated with a respective logical channel identifier (LCID); and
the first SR configuration is associated with a first LCID.

14. The method of claim 13, wherein the triggering the SR using the first SR configuration, among the plurality of SR configurations, is further based on the SL transmission, comprising the SL RS, being associated with the first LCID.

15. A non-transitory computer-readable medium comprising instructions that, when executed by one or more processors of a wireless device, cause the wireless device to:
receive, from a base station, one or more radio resource control (RRC) messages comprising configuration parameters indicating:
a first scheduling request (SR) configuration applicable for requesting sidelink (SL) resources for SL transmissions comprising SL reference signals (RSs);
an SL resource pool for transmission of SL data and SL RSs; and
SL RS resources for transmission of SL RSs in slots of the SL resource pool, wherein each of the SL RS resources comprises one or more symbols of a slot;
trigger, based on an SL transmission comprising an SL RS, an SR using the first SR configuration;
transmit, to the base station, the SR via a physical uplink control channel (PUCCH) resource indicated by the first SR configuration;
receive, from the base station and after the transmitting the SR, downlink control information (DCI) indicating an SL resource in a first slot of the SL resource pool; and
transmit to a second wireless device and via the SL resource:
SL data;
SL control information (SCI) indicating an SL RS resource, of the SL RS resources, in the first slot; and
the SL RS, wherein the transmitting the SL RS is via one or more first symbols, of the first slot, indicated by the SL RS resource.

16. The non-transitory computer-readable medium of claim 15, wherein the one or more RRC messages comprise an RRC reconfiguration message.

17. The non-transitory computer-readable medium of claim 15, wherein:
the DCI comprises fields corresponding to the SL resource,
the fields indicating:
an index of the SL resource pool;
a frequency resource assignment of the SL resource; and
a time resource assignment of the SL resource; and
the fields comprise a time gap field with a value indicating a slot offset between a slot of the DCI and the first slot.

18. The non-transitory computer-readable medium of claim 17, wherein the instructions further cause the wireless device to:
determine, based on the fields and for the SL resource, a physical SL shared channel (PSSCH) duration; and
transmit the SL data via the PSSCH duration.

19. The non-transitory computer-readable medium of claim 18, wherein the fields further comprise a first field with a value indicating the one or more first symbols.

20. The non-transitory computer-readable medium of claim 15, wherein:
the one or more RRC messages indicate a plurality of SR configurations, comprising the first SR configuration;
each SR configuration, of the plurality of SR configurations, is associated with a respective logical channel identifier (LCID); and
the first SR configuration is associated with a first LCID.
